(19) United States
(12) Patent Application Publication
(10) Pub. No.: US 2013/0243004 A1
(43) Pub. Date: Sep. 19, 2013

(54) COMMUNICATION CONTROL METHOD, RELAY DEVICE, AND INFORMATION PROCESSING DEVICE

(71) Applicant: FUJITSU LIMITED, Kawasaki-shi (JP)

(72) Inventors: Kenji HIKICHI, Kawasaki (JP); Shinya KANO, Inagi (JP)

(73) Assignee: FUJITSU LIMITED, Kawasaki-shi (JP)

(21) Appl. No.: 13/733,629

(22) Filed: Jan. 3, 2013

(30) Foreign Application Priority Data
Mar. 16, 2012 (JP) 2012-059949

(51) Int. Cl. H04L 12/66

(52) U.S. Cl. CPC H04L 12/66
USPC 370/401

(57) ABSTRACT

A communication control method of a communication system including a first communication device, a first relay device coupled to the first communication device via a first network which is a network domain where a message broadcast from the first communication device reaches and where communication based on physical addresses is performed, and a second communication device belonging to the same logical network to which the first communication device belongs, the communication control method including: broadcasting, by the first communication device, a first request including a logical address assigned to the second communication device and requesting a physical address assigned to the second communication device, transmitting, by the first relay device, in the event that the second communication device is not coupled to the first network, a first response which is a response to the first request and includes a predetermined physical address, to the first communication device.

### CROSS-REFERENCE TO RELATED APPLICATION

This application is based upon and claims the benefit of priority of the prior Japanese Patent Application No. 2012-059949, filed on Mar. 16, 2012, the entire contents of which are incorporated herein by reference.

### FIELD

The embodiments discussed herein are related to a communication control method, a relay device, and an information processing device.

### BACKGROUND

With Ethernet, Media Access Control (hereinafter may also be referred to as simply “MAC”) addresses are assigned to interfaces of communication devices thereupon, representing each interface. The interfaces of the communication devices are coupled to a small-scale network domain called a Local Area Network (hereinafter may also be referred to as simply “LAN”). A MAC address is an example of a physical address.

Also, when communication devices use Internet Protocol (hereinafter may also be referred to as simply “IP”) on an Ethernet, IP addresses are assigned to interfaces of communication devices thereupon, representing the logical network to which the interfaces are coupled, and the interfaces themselves. An IP address is made up of an identifier of a logical network and an identifier of a interface on the logical network. An IP address is an example of a logical address.

When transmitting packets to another communication device on the same logical network, a communication device broadcasts a message (MAC address resolution request), requesting the MAC addresses of the interface of the communication device having the IP address of the interface of the destination communication device (destination IP address), over the LAN to which the interfaces of the communication devices belonging to that logical network are coupled.

The destination communication device receives the MAC address resolution request, generates a response message including a MAC address which has been assigned to its own interface, and returns the generated response message responding to the MAC address resolution request (MAC address resolution response) to the source communication device.

The source communication device receives the response message regarding the MAC address resolution request (MAC address resolution response) from the destination communication device. The source communication device transmits a packet to be transmitted to the destination communication device, as an Ethernet frame (hereinafter may also be referred to as simply “frame”), of which the destination of the communication device having the MAC address included in the MAC address resolution response.

In order to execute the above-described transmission operations, the MAC address resolution request that has been broadcast has to reach all communication devices on the logical network. Since a broadcast only reaches devices coupled to the same LAN, communication devices on the same logical network are generally coupled to the same LAN.

Work is being done on LISP (Locator/ID Separation Protocol draft-ietf-lisp-15) by IETF (Internet Engineering Task Force), which is a technology that allows packets transmitted from a communication device situated outside of the logical network to be transmitted to a router (or a gateway) to which is coupled the communication device having the destination IP address.

### SUMMARY

According to an aspect of the invention, a communication control method of a communication system including a first communication device, a first relay device coupled to the first communication device via a first network which is a network domain where a message broadcasted from the first communication device reaches and where communication based on physical addresses is performed, and a second communication device belonging to the same logical network to which the first communication device belongs, the communication control method including: broadcasting, by the first communication device, a first request including a logical address assigned to the second communication device and requesting a physical address assigned to the second communication device, transmitting, by the first relay device, in the event that the second communication device is not coupled to the first network, a first response which is a response to the first request and includes a predetermined physical address, to the first communication device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of a communication system operating based on LISP.

FIG. 2 is a sequence chart for describing a communication control method with the communication system.

FIG. 3 is a diagram illustrating the configuration of a communication system according to a first embodiment.

FIGS. 4A and 4B are diagrams illustrating examples of locator lists.

FIGS. 5A and 5B are diagrams illustrating examples of IP address/router ID maps.

FIG. 6 is a diagram illustrating a router ID/locator map.

FIG. 7 is a sequence chart for describing a communication control method with the communication system in FIG. 3.

FIG. 8 is a functional block diagram illustrating the configuration of a router according to the first embodiment.

FIG. 9 is a hardware configuration diagram illustrating the configuration of the router.

FIG. 10 is a functional block diagram illustrating the configuration of a location management server according to the first embodiment.

FIG. 11 is a hardware configuration diagram illustrating the configuration of the location management server.

FIG. 12 is a diagram illustrating the configuration of a communication system according to a second embodiment.

FIG. 13 is a diagram illustrating an example of an of IP address/locator map.

FIG. 14 is a functional block diagram illustrating the configuration of a location management server according to the second embodiment.

FIG. 15 is a diagram illustrating the configuration of a communication system according to a third embodiment.

FIGS. 16A to 16C are diagrams illustrating examples of locator lists.

FIG. 17 is a diagram illustrating an example of an IP address/LAN ID map.

FIG. 18 is a diagram illustrating an example of a LAN ID/router ID map.

FIG. 19 is a diagram illustrating an example of a router ID/locator map.

FIG. 20 is a functional block diagram illustrating the configuration of a location management server according to the third embodiment.

FIG. 21 is a diagram illustrating the configuration of a communication system according to a fourth embodiment.

FIG. 22 is a diagram illustrating an example of an IP address/locator cache map.

FIG. 23 is a sequence chart for describing a communication control method with the communication system in FIG. 21.

FIG. 24 is a diagram illustrating the configuration of a router according to the fourth embodiment.

FIG. 25 is a diagram illustrating the configuration of a communication system according to a fifth embodiment.

FIGS. 26A to 26C are diagrams illustrating an example of IP address/MAC address cache maps before changing of a LAN to which a communication device is coupled.

FIGS. 27A to 27C are diagrams illustrating an example of IP address/MAC address cache maps after changing of the LAN to which the communication device is coupled.

FIG. 28 is a diagram illustrating the configuration of a communication system according to a sixth embodiment.

FIG. 29 is a diagram illustrating an example of a proxy MAC address response list.

FIG. 30 is a diagram illustrating an example of an IP address/MAC address map.

FIG. 31 is a sequence chart for describing a communication control method with the communication system in FIG. 28.

FIG. 32 is a diagram illustrating the configuration of a router according to the sixth embodiment.

FIG. 33 is a functional block diagram illustrating the configuration of a location management server according to the sixth embodiment.

FIG. 34 is a diagram illustrating the configuration of a communication system according to a seventh embodiment.

FIG. 35 is a sequence chart for describing a communication control method with the communication system in FIG. 34.

FIG. 36 is a diagram illustrating the configuration of a router according to the seventh embodiment.

FIG. 37 is a functional block diagram illustrating the configuration of a location management server according to the seventh embodiment.

FIG. 38 is a diagram illustrating the configuration of a communication system according to an eighth embodiment.

FIGS. 39A to 39C are diagrams illustrating examples of locator lists.

FIG. 40 is a diagram illustrating an example of an IP address/LAN ID map.

FIG. 41 is a diagram illustrating an example of a LAN ID/router ID map.

FIG. 42 is a diagram illustrating an example of a router ID/locator map.

FIG. 43 is a functional block diagram illustrating the configuration of a location management server according to the eighth embodiment.

FIG. 44 is a diagram illustrating the configuration of a communication system according to a ninth embodiment.

FIG. 45 is a sequence chart for describing a communication control method with the communication system in FIG. 44.

FIG. 46 is a diagram illustrating the configuration of a router according to the ninth embodiment.

FIG. 47 is a functional block diagram illustrating the configuration of a location management server according to the ninth embodiment.

### DESCRIPTION OF EMBODIMENTS

In recent years, there has come to be demand for operating multiple LANs at physically remote locations as a single logical network, such as with a data center network, for example.

However, in this case, broadcasts only reach devices coupled on the same LAN, so a MAC address resolution request transmitted from a communication device belonging to one LAN does not reach communication devices belonging to another LAN.

Accordingly, in a case where a source communication device and a destination communication device belong to the same logical network but belong to different LANs, the source communication device which has transmitted a MAC address resolution request does not receive a corresponding MAC address resolution response from the destination communication device, and thus does not recognize the MAC address of the interface of the destination communication device.

Consequently, there has been a problem in that packet communication is not properly carried out between communication devices belonging to the same logical network.

It is an aim of embodiments described herein to provide a communication control method enabling packet communication between communication devices belonging to the same logical network, even with a communication system in which a logical network is configured of multiple LANs.

The following is a description of embodiments.

### 1. About LISP

Before describing the embodiments, the aforementioned LISP will be described.

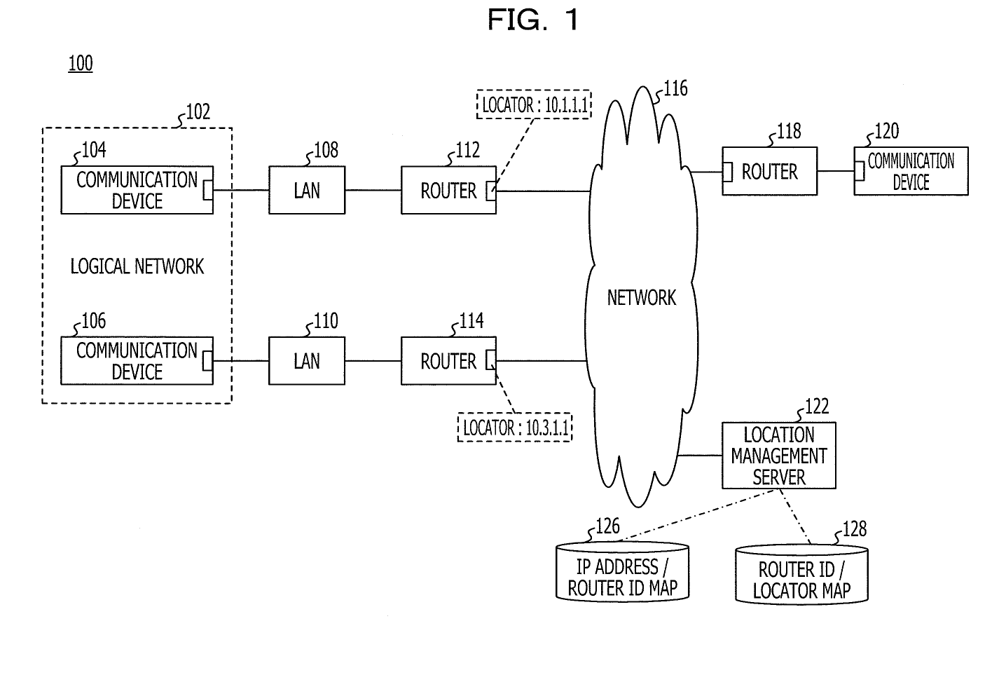

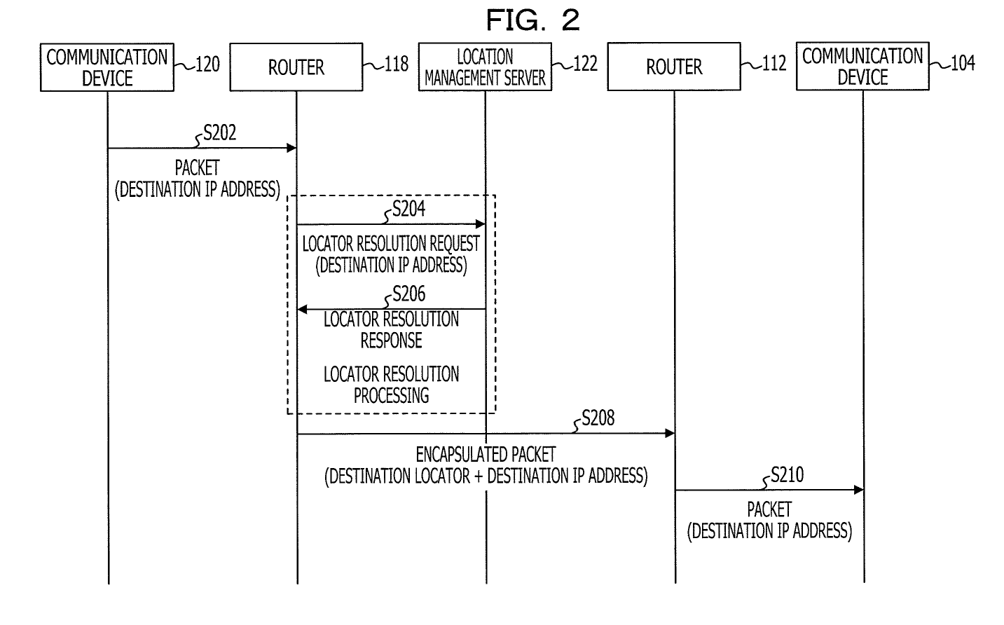

FIG. 1 is a diagram illustrating the configuration of a communication system 100 operating based on LISP, and FIG. 2 is a sequence chart for describing a communication control method with the communication system 100.

With the communication system 100 illustrated in FIG. 1, communication devices 104 and 106 belong to the same logical network 102, but to different LANs. The communication device 104 belongs to a LAN 108, and is coupled to a network 116 via a corresponding router 112. The communication device 106 belongs to a LAN 110, and is coupled to the network 116 via a corresponding router 114.

Also, a location management server 122 is coupled to the network 116. The location management server 122 includes a storage device holding an IP address/router ID map 126 and Router ID/locator map 128. The IP address/router ID map 126 is a table representing the relation between the IP addresses of the interfaces of the communication devices coupled to the network 116, and identification information (router ID) of corresponding routers. The router ID/locator map 128 is a table representing the relation between the identification information (router ID) of each router coupled to the network 116, and the corresponding locators.

Now, communication control performed in a case where a packet is transmitted to the communication device 104 belonging to the logical network 102 from a communication device 120 situated outside of the logical network 102, with reference to FIG. 2.

As illustrated in FIG. 2, in step S202, the communication device 120 transmits of packet, of which the destination is the interface of the communication device 104, to the corresponding router 118. The transmitted packet includes the IP address of the interface of the communication device 104, as a destination IP address (destination IP address).

The communication device 104 belongs to the logical network 102 unlike the communication device 120, and does not exist beneath the router 118. Accordingly, upon having received the packet from the communication device 120 in step S204, the router 118 transmits a message requesting a locator correlated with the destination IP address included in the received packet (locator resolution request) to the location management server 122. The transmitted locator resolution request includes the destination IP address included in the received packet.

Upon receiving the locator resolution request in step S206, the location management server 122 searches the IP address/router ID map 126 that is held, and acquires identification information (router ID) of the router correlated with the destination IP address included in the received locator resolution request. Further, the location management server 122 searches the router ID/locator map 128 that is held, and acquires the locator correlated with the acquired router ID. With the example illustrated in FIG. 1, the acquired locator is “10.1.1.1”, and the destination which the locator indicates is the interface of the router 112 to which the communication device 104 is coupled. The location management server 122 transmits a response message including the acquired locator (locator resolution response) to the router 118.

Note that in the following embodiments, the series of processing executed in steps S204 and S206, and equivalent processing, will be referred to as “locator resolution processing”.

In step S208, the router 118 receives the locator resolution response, encapsulates the received packet, and transmits this as to the locator included in the received locator resolution response (“10.1.1.1” in the example illustrated in FIG. 1) via the network 116.

In step S210, the router 112 decapsulates the encapsulated packet received from the router 118. Subsequently, the router 112 transmits the packet acquired by decapsulating to the interface of the communication device 104 having the destination IP address.

As described above, with LISP, the location management server 122 holds the IP address/router ID map 126 and router ID/locator map 128, and functions to notify each router coupled to the network 116 of location information of the locator corresponding to the interface of the communication device having the destination IP address.

With the embodiments described below, in order to perform packet communication with a communication system in which a logical network is made up of multiple LANs, the aforementioned locator location information held by the location management server 122 is used to employ the locator location information notification function of the location management server 122.

### 2. First Embodiment

The following is a description of a communication system, communication control method, relay device, and information processing device, according to a first embodiment.

### 2-1. Configuration of Communication System 300

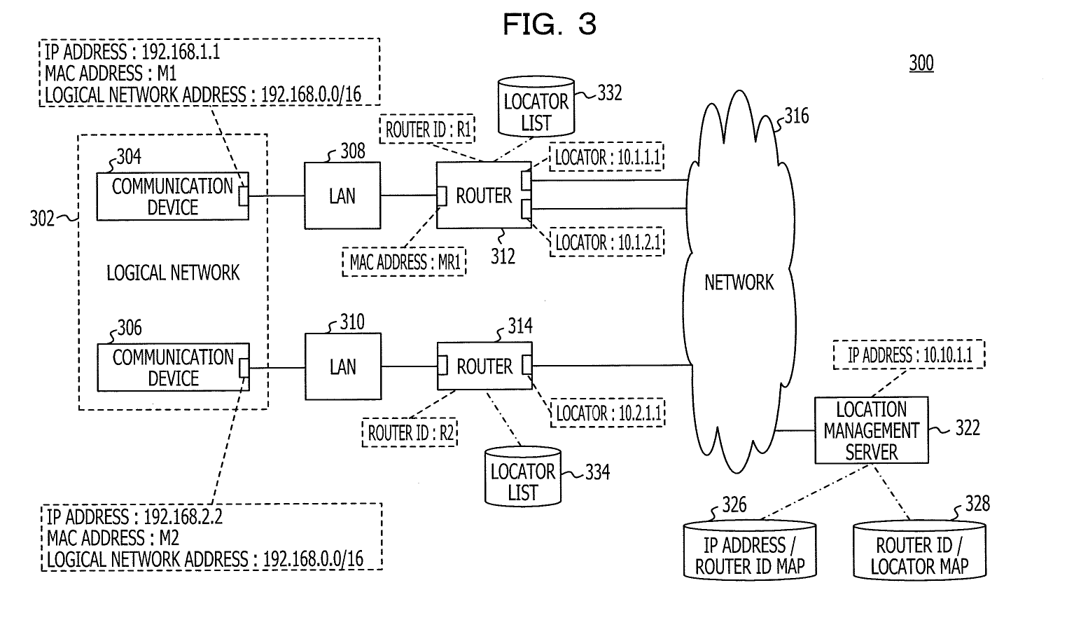

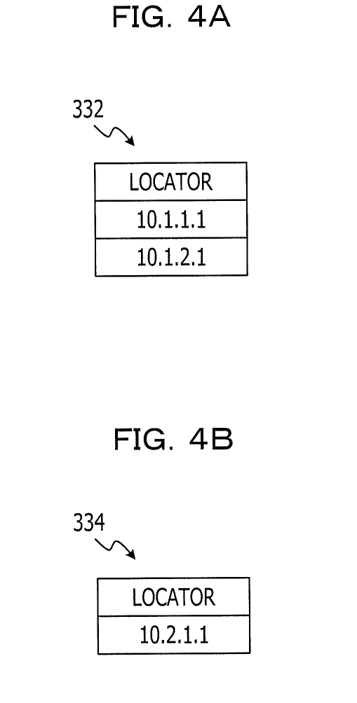

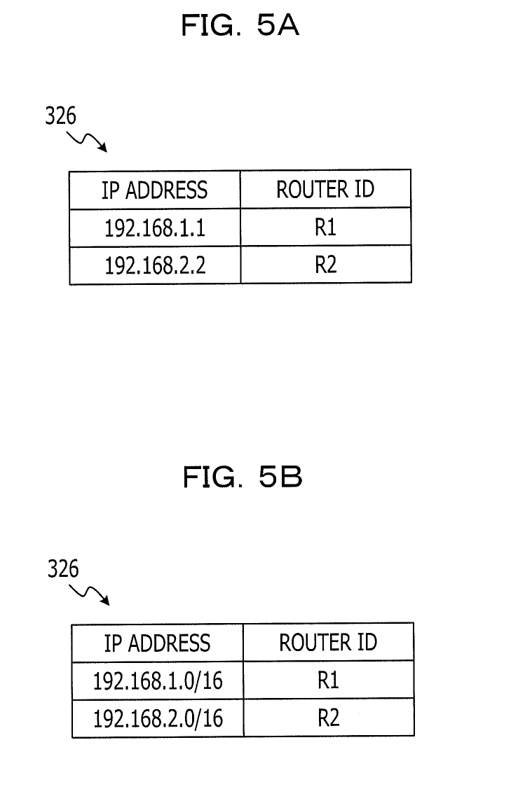

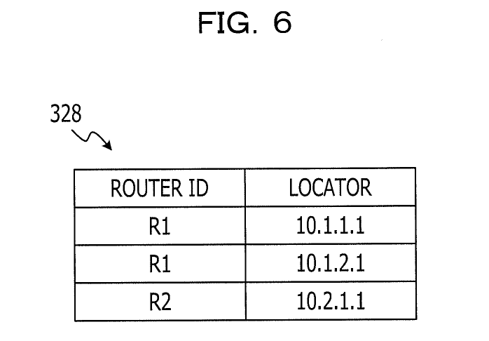

FIG. 3 is a diagram illustrating the configuration of a communication system 300 according to the first embodiment, FIG. 4A is a diagram illustrating an example of a locator list 332, FIG. 4B is a diagram illustrating an example of a locator list 334, FIG. 5A is a diagram illustrating an example of an IP address/router ID map 326, FIG. 5B is a diagram illustrating another example of the IP address/router ID map 326, and FIG. 6 is a diagram illustrating a router ID/locator map 328.

As illustrated in FIG. 3, the communication system 300 includes communication devices 304 and 306, routers 312 and 314, and a location management server 322, and operates based on the above-described LISP.

A corresponding IP address and MAC address are assigned to each interface of the communication devices and routers. Coupled to each LAN is the interface or interfaces of one or multiple communication devices, with one or multiple routers coupled thereto. One or multiple locators are assigned to each router.

With the communication system 300, each LAN 308 and 310 is a network domain configured of communication devices, relay devices, and so forth, capable of executing L2 communication based on Layer 2 (which is the data link layer, also written as “L2”) communication protocol, assuming message communication within the LANs 308 and 310 to be performed by L2 communication based on MAC addresses. Also, the LANs 308 and 310 are each network domains within a range where messages broadcast from a communication device coupled to that LAN will reach.

The communication devices 304 and 306 belong to the same logical network 302, but each belong to different LANs. Here, a logical network is defined as being a network domain which is either physically located at one location, or is handled logically as a single network regardless of being configured of multiple LANs. A logical network may be configured of a single LAN, as well.

The communication device 304 belongs to the LAN 308, and is coupled to the network 316 via the corresponding router 312. The communication device 306 belongs to the LAN 310, and is coupled to the network 316 via the corresponding router 314. The network 316 is configured of communication devices, relay devices, and so forth, capable of executing L3 communication based on Layer 3 (which is the network layer, also written as “L3”) communication protocol, assuming message communication within the network 316 to be performed by L3 communication based on IP addresses.

The router 312 has an interface coupled to the communication device 304 via the LAN 308, and two interfaces coupling to the network 316. The router 312 includes a storage device holding the locator list 332. The router 312 is a relay device to relay packet communication between the communication device 304 and the network 316, and operates based on the above-described LISP.

The locator list 332 is a list indicating locators assigned to the router 312. As indicated in FIG. 4A, the locator list 332 includes two locators, meaning that two locators (10.1.1.1, 10.1.2.1) are assigned to the router 312.

Upon receiving a MAC address resolution request from a communication device belonging to the corresponding LAN 308, the router 312 transmits a locator resolution request to the location management server 322. The locator resolution request that is transmitted here includes the destination IP address included in the received MAC address resolution request.

Subsequently, the router 312 receives a locator resolution response corresponding to the locator resolution request from the location management server. In the event that the locator included in the received locator resolution request is not included in the locator list 332, the router 312 performs processing to transmit a response message (MAC address resolution response) including the MAC address of its own interface, to the source communication device of the MAC address resolution request (Proxy MAC address response processing). Details of the Proxy MAC address response processing at the router 312 will be described later.

The router 314 has an interface coupled to the communication device 306 via the LAN 310, and has an interface coupled to the network 316. The router 314 includes a storage device which holds the locator list 334. The router 314 is a relay device to relay packet communication between the communication device 306 and the network 316, and operates based on the above-described LISP.

The locator list 334 is a list indicating a locator assigned to the router 314. As indicated in FIG. 4B, the locator list 334 includes one locator, meaning that one locator (10.2.1.1) is assigned to the router 314.

In the same way as with the router 312, in the event that the locator included in the received locator resolution request is not included in the locator list 334, the router 314 performs processing to transmit a response message (MAC address resolution response) including the MAC address of its own interface, to the source communication device of the MAC address resolution request (Proxy MAC address response processing). Details of the Proxy MAC address response processing at the router 314 will be described later.

The location management server 322 is an information processing device which is coupled to the network 316 and operates based on the above-described LISP. The location management server 322 includes a storage device holding the IP address/router ID map 326 and a storage device holding the router ID/locator map 328.

The location management server 322 receives locator resolution requests including a destination IP address from the routers coupled to the network 316. The location management server 322 acquires a locator correlated with a destination IP addresses included in a received locator resolution request, by searching the IP address/router ID map 326 and router ID/locator map 328, and transmits a response message including the acquired locator (locator resolution response) to the source router of the locator resolution request. Note that the IP address/router ID map 326 and the router ID/locator map 328 may be held in a single storage device.

The IP address/router ID map 326 is a table representing the relation between IP addresses of the interfaces of the communication devices coupled to the network 316, and identification information of corresponding routers (router IDs). As illustrated in FIG. 5A, the IP address “192.168.1.1” of the interface of the communication device 304 and the router ID “R1” of the router 312 are correlated, and the IP address “192.168.2.2” of the interface of the communication device 306 and the router ID “R2” of the router 314 are correlated. That is to say, two different routers 312 and 314 are correlated with the interfaces of the two communication devices 304 and 306 belonging to the same logical network 302.

While the example illustrated in FIG. 5A is of a format where an entry is provided in the IP address/router ID map 326 for every IP address, this is not restrictive. For example, an arrangement may be made such as illustrated in FIG. 5B, where IP addresses in the IP address/router ID map 326 are replaced with a network address mask format, and router IDs are correlated with an aggregation of IP addresses of multiple interfaces and the correlation is held therein.

The router ID/locator map 328 is a table representing the relation between identification information of the routers coupled to the network 316 (router IDs) and corresponding locators. As illustrated in FIG. 6, the router ID “R1” of the router 312 is correlated with the two locators “10.1.1.1” and “10.1.2.1” of the router 312, and the router ID “R2” of the router 314 is correlated with the one locator “10.2.1.1” of the router 314. That is to say, the router 312 has two locators correlated with a single router ID.

Note that in the above-described embodiment, a router has been exemplified as a relay device relaying communication between the communication devices and the network, but the relay device is not restricted to a router, and may be another device having relay functions.

### 2-2. Communication Control Method with Communication System 300

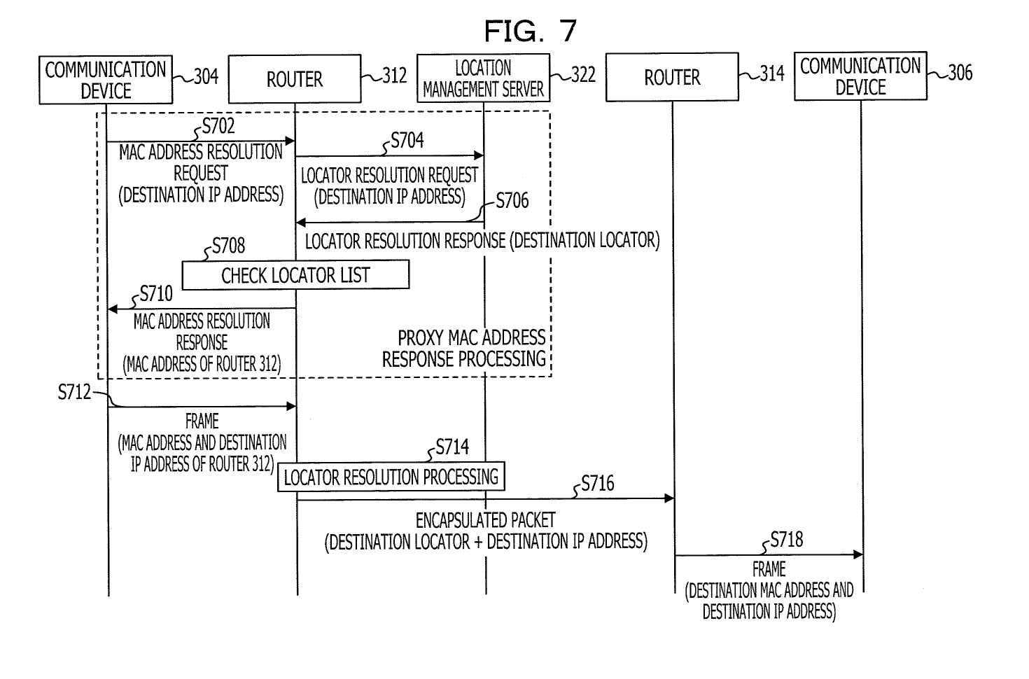

FIG. 7 is a sequence chart for describing a communication control method with the communication system 300. Description will now be made regarding a communication control method with the communication system 300 in a case of transmitting packets from the interface of the communication device 304 to the interface of the communication device 306 belonging to the same logical network, with reference to FIG. 3 in addition to FIG. 7.

As illustrated in FIG. 7, in step S702 the communication device 304 broadcasts a message requesting the MAC address of the interface of the communication device 306 which is the destination (MAC address resolution request) to the LAN 308 to which its own interface is coupled, in order to transmit packets to the interface of the communication device 306. The MAC address resolution request that is transmitted includes the IP address of the interface of the communication device 306 which is the destination (destination IP address). An example of a MAC address resolution request is an ARP (Address Resolution Protocol) request. In the example illustrated in FIG. 3, the transmitted MAC address resolution request includes “192.168.2.2” as the destination IP address.

The communication device 304 determines whether or not the communication device 306 belongs to the same logical network as itself, by matching the destination IP address of the communication device 306 and the logical network address assigned to itself. With the example illustrated in FIG. 3, the destination IP address of the communication device 306 is “192.168.2.2”, and the logical network address assigned to the communication device 304 is “192.168.0.0/16”, so the communication device 304 determines whether or not the upper 16 bits of the addresses “192.168.2.2” and “192.168.0.0” match. Here, the upper 16 bits of the two addresses match each other, so the communication device 304 recognizes that the communication device 306 belongs to the same logical network as itself.

Next, upon having received the MAC address resolution request from the communication device 304, in step S704 the router 312 transmits a message requesting a locator (destination locator) correlated with the destination IP address included in the received MAC address resolution request (locator resolution request) to the location management server 322. A locator resolution request includes the destination IP address included in the received MAC address resolution request. With the example illustrated in FIG. 3, the transmitted locator resolution request includes “192.168.2.2” as a destination IP address.

Note that each router coupled to the network 316 has acquired beforehand the IP address of the location management server 322 (“10.10.1.1” in the example illustrated in FIG. 3), and may transmit locator resolution requests to the location management server 322 using this IP address.

The location management server 322 receives the locator resolution request from the router 312 in step S706. The location management server 322 acquires identification information of the router correlated with the destination IP address (router ID) by searching the IP address/router ID map 326 that is held, based on the destination IP address included in the received locator resolution request. With the example illustrated in FIGS. 3 and 7, the destination IP address is “192.168.2.2”, and according to the map illustrated in FIG. 5A the acquired router ID is “R2”.

Further, the location management server 322 acquires the locator corresponding to the acquired router ID by searching the router ID/locator map 328 that is held, based on the acquired router ID. With the example illustrated in FIGS. 3 and 7, the router ID is “R2”, and according to the map illustrated in FIG. 6 the acquired locator is “10.2.1.1”.

Thus, the location management server 322 acquires locators correlated with destination IP addresses included in locator resolution requests received from the router 312, by the above-described locator acquisition processing. The location management server 322 transmits a response message including the acquired locator (locator resolution response) to the router 312. With the example illustrated in FIGS. 3 and 7, one locator “10.2.1.1” is acquired as to the destination IP address “192.168.2.2”. The destination which the acquired locator indicates is one interface of the router 314 to which the communication device 306 is coupled, and the locator resolution response includes “10.2.1.1” as the locator.

Note that in the event that multiple locators have been assigned to a router coupled to the interface of the destination communication device 306, or in the event that the interface of the destination communication device 306 is coupled to multiple routers, unlike the example illustrated in FIG. 3, multiple locators will be correlated to one destination IP address included in the locator resolution request. In such a case, the locator resolution response will include multiple locators, so the location management server 322 will transmit a locator resolution response including multiple locators to the source router of the locator resolution request.

Next, in step S706, the router 312 receives the locator resolution response from the location management server 322, and in step S708 checks whether or not the locator included in the received locator resolution response is include in its own locator list 332, by referencing the locator list 332 that is held.

With the example illustrated in FIG. 3, the router 312 checks that the locator “10.2.1.1” included in the locator resolution response is not included in its own locator list 332, based on the locator list 332 illustrated in FIG. 4A. Accordingly, the router 312 recognizes that the interface of the communication device 306 having the destination IP address does not belong to the LAN 308.

Next, in step S710, the router 312 transmits to the communication device 304 a response message corresponding to the MAC address resolution request relieved in step S702 (MAC address resolution response). An example of a MAC address resolution response is an ARP response.

At this time, the router 312 assigns the MAC address of the interface of itself to the MAC address resolution response. With the example illustrated in FIG. 3, the MAC address “MR1” of the interface of the router 312 that is coupled to the LAN 308 is assigned. That is to say, the router 312 generates a response message (MAC address resolution response) using the MAC address of its own interface as a proxy for the communication device 306 which originally is supposed to respond to the MAC address resolution request, and performs Proxy MAC address response processing with the generated MAC address resolution response.

By recognizing that the interface of the communication device 306 does not belong to the LAN 308, the router 312 recognizes that in the current state, the communication device 304 which has transmitted the MAC address resolution request will not receive a corresponding MAC address resolution response, and accordingly will not recognize the MAC address of the interface of the communication device 306. Accordingly, the router 312 executes the above-described Proxy MAC address response processing with regard to the communication device 304, so as to avoid a situation in which packet transmission from the communication device 304 to the interface of the communication device 306 is not started.

Note that with the embodiments in the Present Specification, the series of processing executed in steps S704 through S710, and equivalent processing, will be referred to as “Proxy MAC address response processing”.

Next, in step S712, the communication device 304 receives a MAC address resolution response from the router 312, and recognizes the MAC address of the interface of the router 312 that is included in the received MAC address resolution response as being the MAC address which is the destination (destination MAC address). The communication device 304 transmits a packet which is a message of which the destination is the interface of the communication device 306, as a frame which is a message with the corresponding router 312 interface as the destination thereof. At this time, the transmitted frame includes the IP address of the destination communication device 306 interface as the destination IP address, and also includes the MAC address of the interface of the router 312 that is included in the received MAC address resolution response as the destination MAC address. With the example illustrated in FIG. 3, the transmitted frame includes “192.168.2.2” as the destination IP address and also includes “MR1” as the destination MAC address.

Next, in step S714, the router 312 receives the frame from the communication device 304. The router 312 and location management server 322 use the destination IP address included in the received frame, i.e., the IP address of the interface of the communication device 306, to execute locator resolution processing. The locator resolution processing is processing similar to the processing executed in steps S204 and S206 in FIG. 2.

Upon receiving the frame from the communication device 304, the router 312 extracts the packet from the received frame. The router 312 transmits a message requesting the locator correlated with the destination IP address included in the extracted packet (locator resolution request) to the location management server 322.

The location management server 322 receives the locator resolution request from the router 312. The location management server 322 searches the IP address/router ID map 326 so as to acquire identification information of the router (router ID) correlated with the destination IP address included in the received locator resolution request. With the example illustrated in FIGS. 3 and 7, the destination IP address is “192.168.2.2”, and according to the map illustrated in FIG. 5A the acquired router ID is “R2”.

Further, the location management server 322 acquires the locator corresponding to the acquired router ID by searching the router ID/locator map 328. With the example illustrated in FIGS. 3 and 7, the router ID is “R2”, and according to the map illustrated in FIG. 6 the acquired locator is “10.2.1.1”.

Thus, the location management server 322 acquires locators correlated with destination IP addresses included in locator resolution requests received from the router 312, by the above-described locator acquisition processing. The location management server 322 transmits a response message including the acquired locator (locator resolution response) to the router 312. With the example illustrated in FIGS. 3 and 7, one locator “10.2.1.1” is acquired as to the destination IP address “192.168.2.2”. The destination which the acquired locator indicates is one interface of the router 314 to which the communication device 306 is coupled, and the locator resolution response includes “10.2.1.1” as the locator.

Note that in the event that multiple locators have been assigned to a router coupled to the interface of the destination communication device 306, or in the event that the interface of the destination communication device 306 is coupled to multiple routers, unlike the example illustrated in FIG. 3, multiple locators will be correlated to one destination IP address included in the locator resolution request. In such a case, the locator resolution response will include multiple locators, so the location management server 322 will transmit a locator resolution response including multiple locators to the source router of the locator resolution request.

Next, in step S716, the router 312 receives the locator resolution response, encapsulates the packet extracted from the received frame, and transmits this to the locator included in the received locator resolution response (“10.2.1.1” in the example illustrated in FIG. 3) via the network 316. The transmitted packet includes the destination locator (“10.2.1.1” in the example illustrated in FIG. 3) and the destination IP address (“192.168.2.2” in the example illustrated in FIG. 3).

Note that in the event that a locator resolution response including multiple destination locators has been received from the location management server 322, the router 312 selects one of the multiple destination locators, and encapsulates the packet extracted from the received frame transmitted to the selected destination locator. Selection of one destination locator from the multiple destination locators may be performed by Round Robin, for example.

Next, in step S718, the router 314 decapsulates the encapsulated packet received from the router 312. Subsequently, the router 314 acquires the MAC address that is the destination (destination MAC address) corresponding to the destination IP address (“192.168.2.2” in the example illustrated in FIG. 3) included in the packet acquired by decapsualting. The router 314 transmits the received packet as a frame of which the destination is the interface of the communication device 306 having the destination MAC address that has been acquired. In the example illustrated in FIG. 3, the destination MAC address is “M2”. Note that acquisition of the destination MAC address may be performed by the above-described ARP request and ARP response processing.

As described above, with the communication system 300, the router 312 to which the communication device 304 is coupled executes Proxy MAC address response processing as to the communication device 304 which has transmitted a MAC address resolution request, so packet communication is executable in a normal manner even with a case of performing packet communication between communication devices belonging to different LANs in a communication system where a logical network is configured of multiple LANs.

Also, with the communication system 300, at the time of the router 312 deciding whether or not to execute Proxy MAC address response processing, maps (location information) 326 and 328 representing the relation between IP addresses and locators, which the location management server 322 operating based on LISP holds, are used. Accordingly, a database relating to location information of communication devices to perform communication does not have to be newly constructed, thereby avoiding location information of communication devices held in the overall network from becoming redundant, and enabling storage device resources such as memory to be effectively used.

### 2-3. Configuration of Router 312 (314)

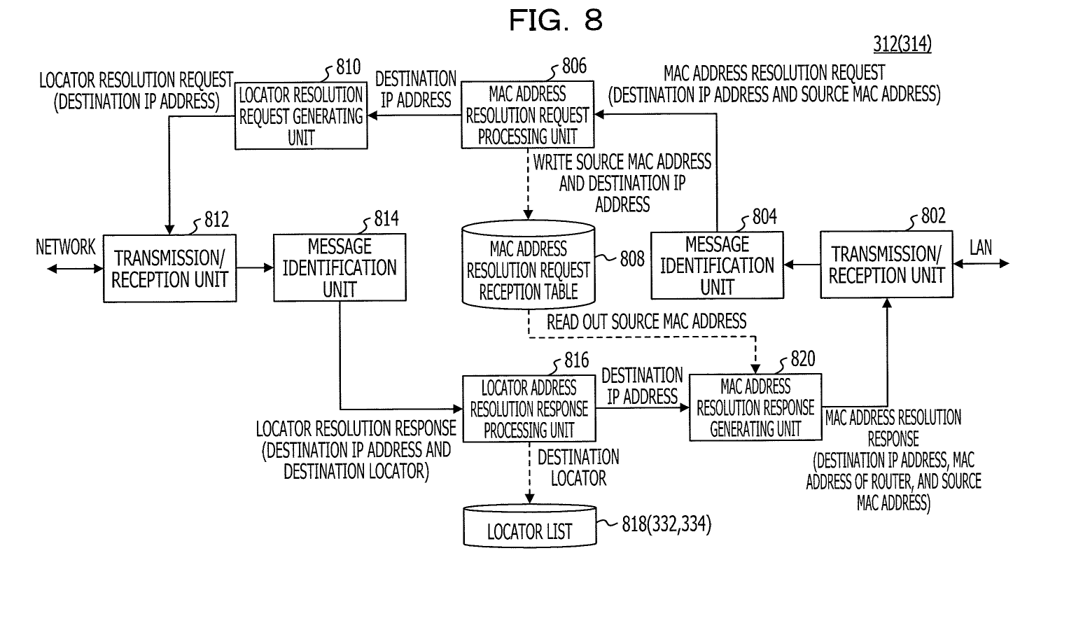

FIG. 8 is a functional block diagram illustrating the configuration of the router 312 (314) according to the first embodiment.

The functional block diagram illustrated in FIG. 8 illustrates the portions of the router 312 (314) corresponding to the functions of the Proxy MAC address response processing described with reference to FIG. 7. Portions corresponding to other functions may use arrangements according to the related art, so description thereof will be omitted from the Present Specification. Also, while description will be made with regard to the configuration of the router 312, the routers 312 and 314 have configurations which are equivalent to each other in the communication system 300.

As illustrated in FIG. 8, the router 312 includes a MAC address resolution request processing unit 806, a locator resolution request generating unit 810, a locator resolution response processing unit 816, a locator list 818, and a MAC address resolution response generating unit 820.

A transmission/reception unit 802 receives messages such as a MAC address resolution request from the LAN 308, and outputs the received message to a message identification unit 804. Also, the transmission/reception unit 802 receives a later-described MAC address resolution response from the MAC address resolution response generating unit 820, and transmits the received MAC address resolution response to the interface of the source communication device of the MAC address resolution request, which will be described later, via the LAN 308.

The message identification unit 804 identifies the content of the message received from the transmission/reception unit 802, and in the event that the received message is a MAC address resolution request, the message identification unit 804 outputs the MAC address resolution request to the MAC address resolution request processing unit 806. The output MAC address resolution request includes the destination IP address (IP address of the interface of the destination communication device) and the source MAC address (MAC address of the interface of the communication device which is the source of the MAC address resolution request).

The MAC address resolution request processing unit 806 receives the MAC address resolution request from the message identification unit 804, and writes the information of the destination IP address and the source MAC address, included in the received MAC address resolution request, to a MAC address resolution request reception table 808. Also, the MAC address resolution request processing unit 806 outputs the information of the destination IP address included in the received MAC address resolution request to the locator resolution request generating unit 810.

The locator resolution request generating unit 810 receives the destination IP address from the MAC address resolution request processing unit 806, and generates a locator resolution request including this destination IP address, based on the received destination IP address. The locator resolution request generating unit 810 outputs the generated locator resolution request to a transmission/reception unit 812.

The transmission/reception unit 812 receives the locator resolution request from the locator resolution request generating unit 810, and transmits the received locator resolution request to the location management server 322 via the network 316. Also, the transmission/reception unit 812 receives a message such as a locator resolution response from the network 316 and outputs this to a message identification unit 814.

The message identification unit 814 identifies the content of the message received from the transmission/reception unit 812, and in the event that the received message is a locator resolution response, outputs the locator resolution response to the locator resolution response processing unit 816. The output locator resolution response includes a destination IP address (IP address of the interface of the destination communication device) and destination locator (IP address of the interface of the packet destination router).

The locator resolution response processing unit 816 receives the locator resolution response from the message identification unit 814, and acquires the information of the destination locator included in the received locator resolution response. By referencing the locator list 818, the locator resolution response processing unit 816 checks whether or not the acquired destination locator is included in the locator list 818. Note that the locator list 818 is the same as the locator list 332 (334) illustrated in FIG. 3.

In the event that the destination locator is not included in the locator list 818, the locator resolution response processing unit 816 notifies the MAC address resolution response generating unit 820 to that effect, and outputs the destination IP address included in the received locator resolution response to the MAC address resolution response generating unit 820.

The MAC address resolution response generating unit 820 receives the destination IP address from the locator resolution response processing unit 816, and reads out the corresponding source MAC address from the MAC address resolution request reception table 808, based on the received destination IP address. In the event that the destination locator is not included in the locator list 818, the MAC address resolution response generating unit 820 further generates a MAC address resolution response, based on the received destination IP address and the source MAC address that has been read out. That is to say, the MAC address resolution response generating unit 820 generates a MAC address resolution response including its own (the router 312) MAC address, in addition to the destination IP address and source MAC address. The MAC address resolution response generating unit 820 outputs the generated MAC address resolution response to the transmission/reception unit 802.

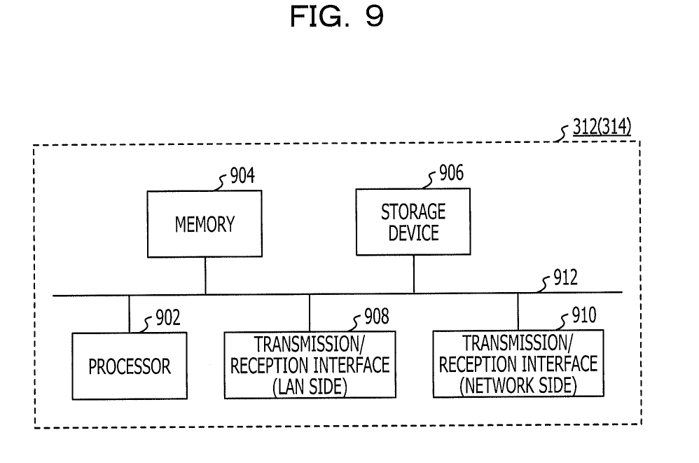

FIG. 9 is a hardware configuration diagram illustrating the configuration of the router 312 (314). The router 312 (314) includes a processor 902, memory 904, a storage device 906, transmission/reception interfaces 908 and 910, and a bus 912. The processor 902, memory 904, storage device 906, and transmission/reception interfaces 908 and 910 are each coupled to the bus 912. The functions of the functional blocks of the router 312 (314) illustrated in FIG. 8 may be realized by the hardware configuration of the router 312 (314) illustrated in FIG. 9. An example of the memory 904 is RAM, and examples of the storage device 906 include nonvolatile memory such as ROM or flash memory, and a magnetic disk device such as a hard disk drive (hereinafter may be referred to simply as “HDD”).

The functions and processing of the functional blocks of the message identification unit 804, MAC address resolution request processing unit 806, locator resolution request generating unit 810, message identification unit 814, locator resolution response processing unit 816, and MAC address resolution response generating unit 820, illustrated in FIG. 8, may be realized by the processor 902 executing processing programs in which are described corresponding functions and processing. Processing programs are stored in the storage device 906, and the above-described functional blocks illustrated in FIG. 8 are realized by the processor 902 loading the processing programs stored in the storage device 906 to the memory 904 and executing the processing described in the processing programs.

Also, the MAC address resolution request reception table 808 and locator list 818 illustrated in FIG. 8 are stored in the memory 904 or storage device 906. Write/read to/from the MAC address resolution request reception table 808 is performed by the processor 902 accessing the memory 904 or storage device 906 as desired with the locator list 818 being referenced, based on the processing described in the above-described processing program.

Note that in addition to the hardware configuration illustrated in FIG. 9, the above-described functional blocks illustrated in FIG. 8 may be realized by a large-scale integrated circuit (hereinafter may be referred to simply as “LSI”) such as an ASIC (Application Specified Integrated Circuit) or FPGA (Field Programmable Gate Array).

The transmission/reception unit 802 illustrated in FIG. 8 may be realized by the transmission/reception interface 908 capable of coupling to the LAN 308 (310), and the transmission/reception unit 812 may be realized by the transmission/reception interface 910 capable of coupling to the network 316. The transmission/reception interfaces 908 and 910 each are input/output (hereinafter may be referred to simply as “I/O”) circuits according to the related art, for example.

As described above, the router 312 to which the communication device 304 is coupled executes Proxy MAC address response processing as to the communication device 304 which has transmitted a MAC address resolution request, so packet communication is executable in a normal manner even with a case of performing packet communication between communication devices 304 and 306 belonging to different LANs.

### 2-4. Configuration of Location Management Server 322

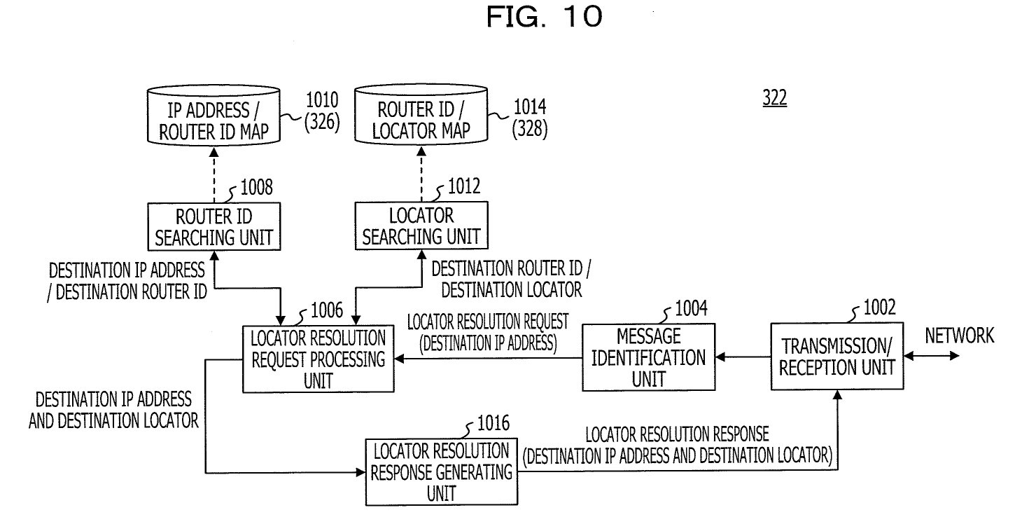

FIG. 10 is a functional block diagram illustrating the configuration of the location management server 322 according to the first embodiment.

With the functional block diagram illustrated in FIG. 10, portions of the location management server 322 operating based on LISP described above which correspond to functions relating to the Proxy MAC address response processing and locator resolution processing described with reference to FIG. 7 are illustrated, and description of portions corresponding to other functions is omitted from the Present Specification, since arrangements according to the related art may be used.

As illustrated in FIG. 10, the location management server 322 includes a locator resolution request processing unit 1006, a router ID searching unit 1008, an IP address/router ID map 1010, a locator searching unit 1012, a router IP/locator map 1014, and a locator resolution response generating unit 1016.

The transmission/reception unit 1002 receives message such as locator resolution requests from the network 316 and outputs the received messages to a message identification unit 1004. Also, a transmission/reception unit 1002 receives a later-described locator resolution response from the locator resolution response generating unit 1016, and transmits the received locator resolution response to the source router of the locator resolution request, which will be described later, via the network 316.

The message identification unit 1004 identifies the content of the message received from the transmission/reception unit 1002, an in the event that the received message is a locator resolution request, outputs the locator resolution request to the locator resolution request processing unit 1006. The output locator resolution request includes the destination IP address (the IP address of the interface of the destination communication device).

The locator resolution request processing unit 1006 receives the locator resolution request from the message identification unit 1004, and notifies the information of the destination IP address included in the received locator resolution request to the router ID searching unit 1008.

The router ID searching unit 1008 receives the destination IP address information from the locator resolution request processing unit 1006, and acquires identification information of the router correlated with that destination IP address (destination router ID), by searching the IP address/router ID map 1010 based on the received destination IP address. The router ID searching unit 1008 notifies the information of the acquired destination router ID to the locator resolution request processing unit 1006. Note that the IP address/router ID map 1010 is the same as the IP address/router ID map 326 illustrated in FIG. 3.

The locator resolution request processing unit 1006 receives the information of the destination router ID from the router ID searching unit 1008, and notifies the information of the received destination router ID to the locator searching unit 1012.

The locator searching unit 1012 receives the information of the destination router ID from the locator resolution request processing unit 1006, and acquires the locator correlated with the destination router ID (destination locator) by searching the router ID/locator map 1014, based on the received destination router ID. The locator searching unit 1012 notifies the locator resolution request processing unit 1006 of the information of the acquired destination locator. Note that the router ID/locator map 1014 is the same as the router ID/locator map 328 illustrated in FIG. 3.

The locator resolution request processing unit 1006 acquires the information of the destination locator from the locator searching unit 1012. The locator resolution request processing unit 1006 notifies the locator resolution response generating unit 1016 of the acquired information of the destination locator, in addition to the destination IP address.

The locator resolution response generating unit 1016 receives the destination IP address and destination locator information from the locator resolution request processing unit 1006, and generates a locator resolution response including the received destination IP address and destination locator. The locator resolution response generating unit 1016 outputs the generated locator resolution response to the transmission/reception unit 1002.

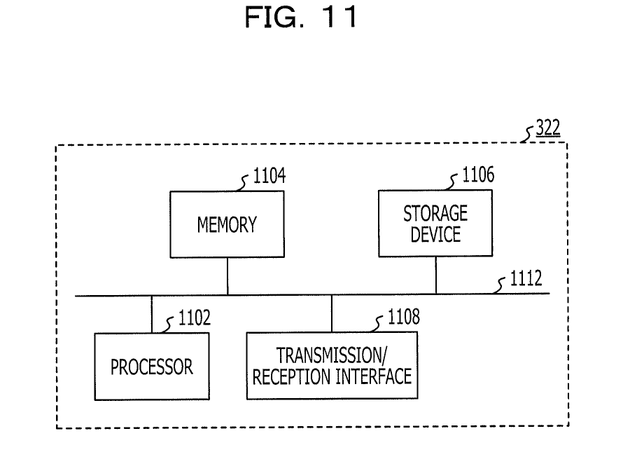

FIG. 11 is a hardware configuration diagram illustrating the configuration of the location management server 322. The location management server 322 includes a processor 1102, memory 1104, a storage device 1106, a transmission/reception interface 1108, and a bus 1112. The processor 1102, memory 1104, storage device 1106, and transmission/reception interface 1108 are each coupled to the bus 1112. The functions of the functional blocks of the location management server 322 illustrated in FIG. 10 may be realized by the hardware configuration of the location management server 322 illustrated in FIG. 11. An example of the memory 1104 is RAM, and examples of the storage device 1106 include nonvolatile memory such as ROM or flash memory, and a magnetic disk device such as an HDD.

The functions and processing of the functional blocks of the message identification unit 1004, locator resolution request processing unit 1006, router ID searching unit 1008, locator searching unit 1012, and locator resolution response generating unit 1016, may be realized by the processor 1102 executing processing programs in which are described corresponding functions and processing. Processing programs are stored in the storage device 1106, and the above-described functional blocks illustrated in FIG. 10 are realized by the processor 1102 loading the processing programs stored in the storage device 1106 to the memory 1104 and executing the processing described in the processing programs.

Also, the IP address/router ID map 1010 and router ID/locator map 1014 illustrated in FIG. 10 are stored in the memory 1104 or storage device 1106. Searching of the IP address/router ID map 1010 and router ID/locator map 1014 is performed by the processor 1102 accessing the memory 1104 or storage device 1106 as desired, based on the processing described in the above-described processing program.

Note that in addition to the hardware configuration illustrated in FIG. 11, the above-described functional blocks illustrated in FIG. 10 may be realized by an LSI an ASIC or FPGA.

The transmission/reception unit 1002 illustrated in FIG. 10 may be realized by the transmission/reception interface 1108. An example of the transmission/reception interface 1108 is an I/O circuit according to the related art.

As described above, at the time of the router 312 (314) deciding whether or not to execute Proxy MAC address response processing, the location management server 322 operating based on LISP acquires the destination locator using the maps (location information) 326 and 328 representing the relation between IP addresses and locators, which it holds itself. Accordingly, a database relating to location of communication devices to perform communication does not have to be newly constructed, thereby avoiding location information of communication devices held in the overall network from becoming redundant, and enabling storage device resources such as memory to be effectively used.

### 3. Second Embodiment

The following is a description of a communication system, communication control method, relay device, and information processing device, according to a second embodiment.

### 3-1. Configuration of Communication System 1200

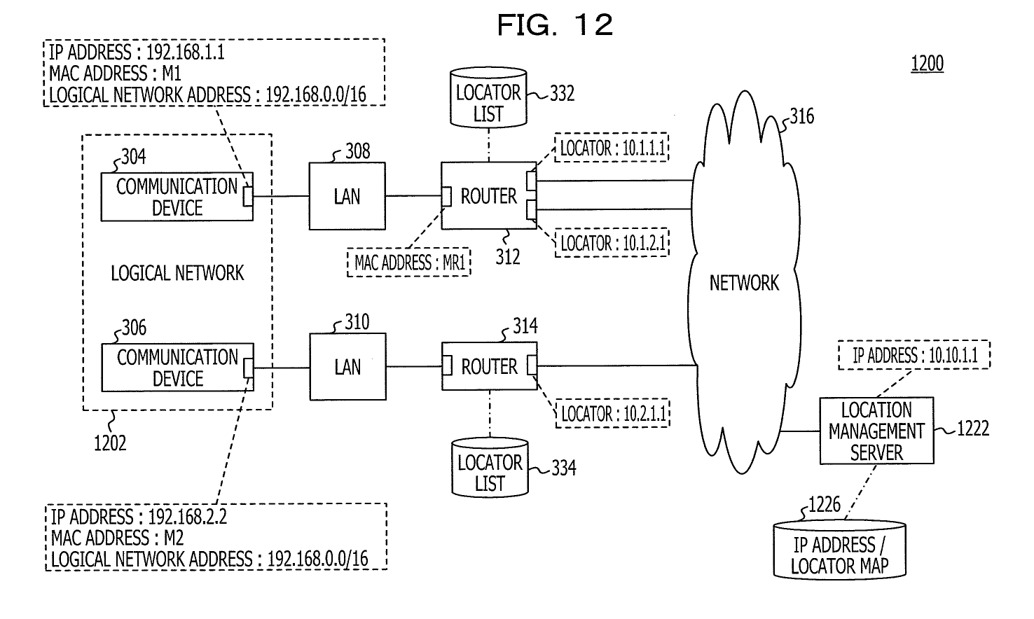

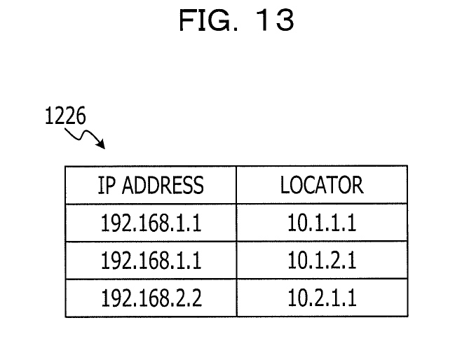

FIG. 12 is a diagram illustrating the configuration of a communication system 1200 according to the second embodiment. FIG. 13 is a diagram illustrating an example of an IP address/locator map 1226.

The communication system 1200 illustrated in FIG. 12 differs from the communication system 300 illustrated in FIG. 3 in that a location management server 1222 is provided instead of the location management server 322 and the IP address/locator map 1226 is provided instead of the IP address/router ID map 326 and router ID/locator map 328, but other parts are the same. Parts which are the same as or equivalent to those in the communication system 300 in FIG. 3 are denoted with the same reference numerals. The operations and functions of the parts denoted by the same reference numerals in FIG. 12 are the same as described with reference to FIG. 3, so detailed description will be omitted.

In FIG. 12, a location management server 1222 is an information processing device which is coupled to the network 316, and operates based on the above-described LISP. The location management server 1222 includes a storage device which holds the IP address/locator map 1226. The location management server 1222 searches the IP address/locator map 1226 and acquires locators correlated with destination IP addresses included in locator resolution requests received from the routers, and transmits response messages including the acquired locators (locator resolution responses) to the source routers of the locator resolution requests.

The IP address/locator map 1226 is a table representing the relation between the IP addresses of the interfaces of the communication devices coupled to the network 316, and the IP addresses (locators) of the interfaces of the corresponding routers. As illustrated in FIG. 13, two locators “10.1.1.1” and “10.1.2.1” corresponding to the two interfaces of the router 312 are correlated with the IP address “192.168.1.1” of the interface of the communication device 304, and the one locator “10.2.1.1” of the router 314 is correlated with the IP address “192.168.2.2” of the communication device 306. That is to say, with the router 312, two different locators are correlated with the interface of a single communication device.

### 3-2. Communication Control Method with Communication System 1200

The communication control method with the communication system 1200 differs from the communication control method of the communication system 300 illustrated in FIG. 7 with regard to the locator acquisition processing executed in step S706 and step S714, but other parts are the same.

The locator acquisition processing with the communication system 1200 differs from the locator acquisition processing with the communication system 300 with regard to the point that, at the time of acquiring a locator correlated with a destination IP address included in the locator resolution request, only the IP address/locator map 1226 is used, instead of using the two tables of the IP address/router ID map 326 and router ID/locator map 328, but other parts are the same.

With the communication system 1200, unlike the location management server 322, in steps S706 and S714, the location management server 1222 searches the IP address/locator map 1226 and acquires a locator correlated with a destination IP address included in the locator resolution request received from the router 312, according to the above-described locator acquisition processing. In the examples illustrated in FIGS. 7 and 12, the destination IP address is “192.168.2.2”, and according to the map illustrated in FIG. 13, the acquired locator is “10.2.1.1”.

As described above, the location management server 1222 acquires a locator correlated with a destination IP address included in a locator resolution request received from the router 312, by the above-described locator acquisition processing. The location management server 1222 transmits a response message including the acquired locator (locator resolution response) to the router 312. In the examples illustrated in FIGS. 7 and 12, one locator of “10.2.1.1” is acquired as to the destination IP address “192.168.2.2”. The destination which the acquired locator indicates is the one interface of the router 314 to which the communication device 306 is coupled, and the locator resolution response includes “10.2.1.1” as the locator.

In step S708, the router 312 checks whether or not the locator included in the locator resolution response received from the location management server 1222 is included in the locator list 332. In step S710, in response to a locator included in a locator resolution response not being included in its own locator list 332, the router 312 performs Proxy MAC address response processing as to the communication device 304 by a MAC address resolution response including the MAC address of its own interface.

As described above, even in a case where packet communication is performed between communication devices belonging to different LANs with a communication system where one logical network is configured of multiple LANs, with the communication system 1200 the router 312 to which the communication device 304 which has transmitted a MAC address resolution response is coupled executes Proxy MAC address response processing as to the communication device 304, so packet communication may be executed in a normal manner.

Also, with the communication system 1200, at the time of the router 312 deciding whether or not to execute Proxy MAC address response processing, the map (location information) 1226 indicating the relation between IP addresses and locators, which the location management server 1222 operating based on LISP holds, is used. Accordingly, a database relating to location information of communication devices to perform communication does not have to be newly constructed, thereby avoiding location information of communication devices held in the overall network from becoming redundant, and enabling storage device resources such as memory to be effectively used.

### 3-3. Configuration of Router 312 (314)

The configuration of the routers 312 and 314 in the communication system 1200 is the same as the configuration of the routers 312 and 314 in the communication system 300. Accordingly, detailed description will be omitted.

### 3-4. Configuration of Location Management Server 1222

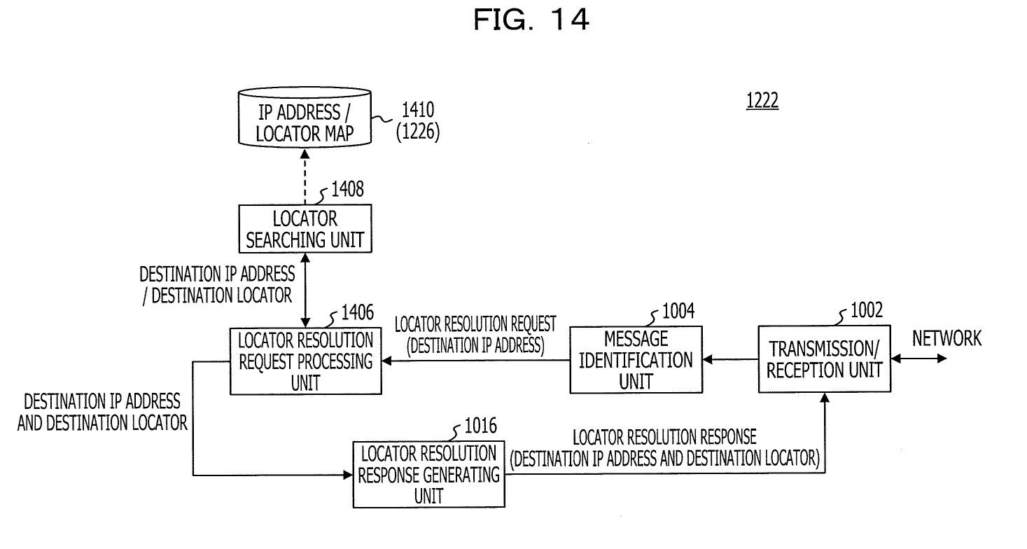

FIG. 14 is a functional block diagram illustrating the configuration of the location management server 1222 according to the second embodiment.

The location management server 1222 illustrated in FIG. 14 differs from the location management server 322 illustrated in FIG. 10 with regard to the point that a locator resolution request processing unit 1406 is provided instead of the locator resolution request processing unit 1006, and locator searching unit 1408 and IP address/locator map 1410 are provided instead of the router ID searching unit 1008, IP address/router ID map 1010, locator searching unit 1012, and router ID/locator map 1014, but other parts are the same. Parts which are the same as or equivalent to those in the location management server 322 illustrated in FIG. 10 are denoted with the same reference numerals. The operations and functions of the parts denoted by the same reference numerals in FIG. 14 are the same as described with reference to FIG. 10, so detailed description will be omitted.

With the functional block diagram illustrated in FIG. 14, in the same way as with the functional block diagram illustrated in FIG. 10 portions of the location management server 1222 which correspond to functions relating to the Proxy MAC address response processing and locator resolution processing described with reference to FIG. 7 are illustrated, and description of portions corresponding to other functions is omitted from the Present Specification, since arrangements according to the related art may be used.

The locator resolution request processing unit 1406 receives a locator resolution request from the message identification unit 1004, and notifies information of the destination IP address included in the received locator resolution request to the locator searching unit 1408.

The locator searching unit 1408 receives the information of the destination IP address from the locator resolution request processing unit 1406, and searches the IP address/locator map 1410 based on the received destination IP address, thereby acquiring a locator correlated with that destination IP address (destination locator). The locator searching unit 1408 notifies the information of the acquired destination locator to the locator resolution request processing unit 1406. Note that the IP address/locator map 1410 is the same as the IP address/locator map 1226 illustrated in FIG. 12.

The locator resolution request processing unit 1406 acquires the information of the destination locator from the locator searching unit 1408, and notifies the information of the acquired destination locator to the locator resolution response generating unit 1016.

Note that the hardware configuration of the location management server 1222 is the same as the hardware configuration of the location management server 322 illustrated in FIG. 11. The functions of the functional blocks of the location management server 1222 may be realized with the same hardware configuration of the location management server 322 illustrated in FIG. 11. The IP address/locator map 1410 illustrated in FIG. 10 is stored in memory or a storage device. Accordingly, detailed description will be omitted.

As described above, at the time of the router 312 (314) deciding whether or not to execute Proxy MAC address response processing, the location management server 1222 operating based on LISP acquires a destination locator using the IP address/locator map (location information) 1226, and notifies the information of the acquired destination locator to the router 312 (314). Accordingly, a database relating to location information of communication devices to perform communication does not have to be newly constructed, thereby avoiding location information of communication devices held in the overall network from becoming redundant, and enabling storage device resources such as memory to be effectively used.

### 4. Third Embodiment

The following is a description of a communication system, communication control method, relay device, and information processing device, according to a third embodiment.

### 4-1. Configuration of Communication System 1500

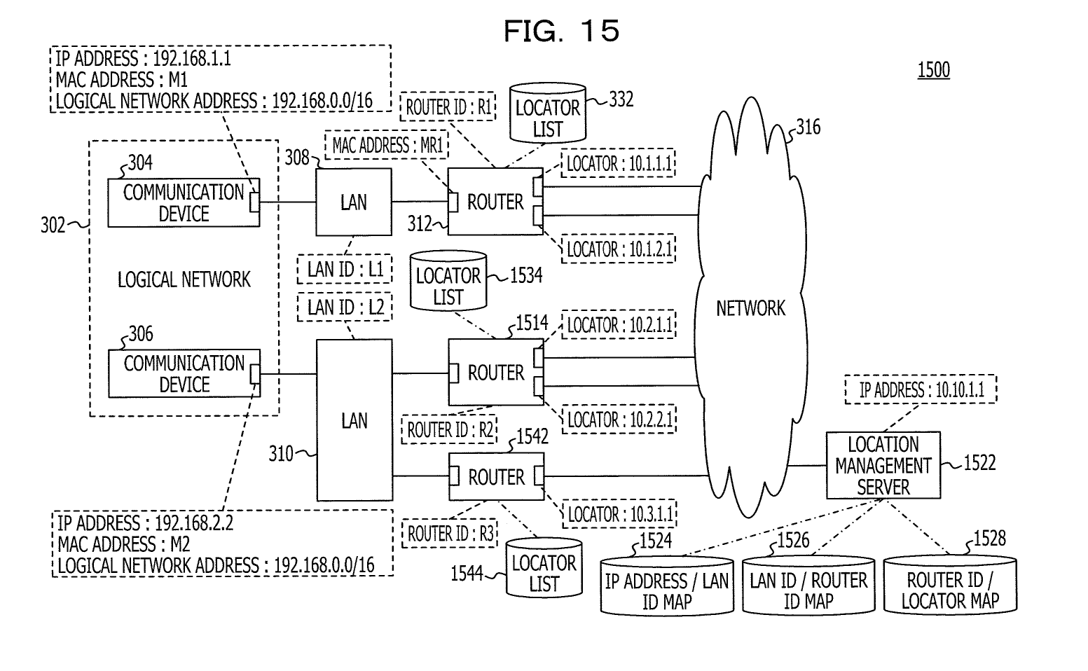

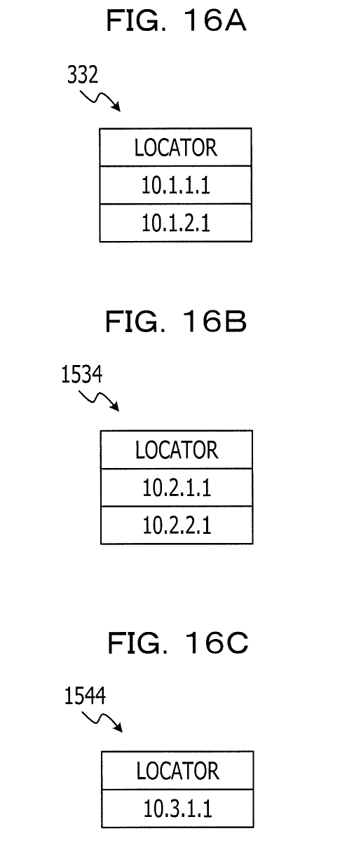

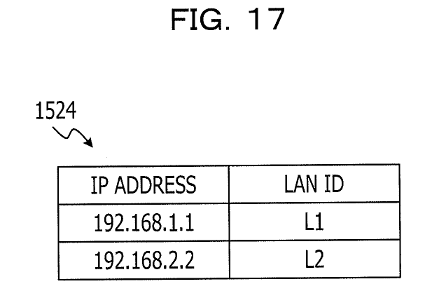

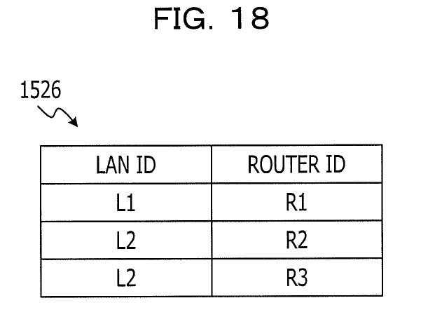

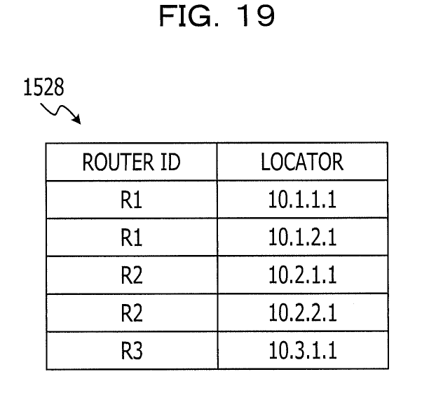

FIG. 15 is a diagram illustrating the configuration of a communication system 1500 according to a third embodiment, FIGS. 16A through 16C are diagrams illustrating an example of locator lists 332, 1534, and 1544, FIG. 17 is a diagram illustrating an example of an IP address/LAN ID map 1524, FIG. 18 is a diagram illustrating an example of a LAN ID/router ID map 1526, and FIG. 19 is a diagram illustrating an example of a router ID/locator map 1528.

The communication system 1500 illustrated in FIG. 15 differs from the communication system 300 illustrated in FIG. 3 with regard to the points that a router 1514 and locator list 1534 are provided instead of the router 314 and locator list 334, and a router 1542 and locator list 1544 have been added. Further, the communication system 1500 differs from the communication system 300 with regard to the point that a location management server 1522 is provided instead of the location management server 322, and that an IP address/LAN ID map 1524, LAN ID/router ID map 1526, and a router ID/locator map 1528, are provided instead of the IP address/locator map 326 and router ID/locator map 328.

Parts of the communication system 1500 other than those described above are the same as with the communication system 300. Parts which are the same as or equivalent to those in the communication system 300 illustrated in FIG. 3 are denoted with the same reference numerals. The operations and functions of the parts denoted by the same reference numerals in FIG. 15 are the same as described with reference to FIG. 3, so detailed description will be omitted.

In FIG. 15, the router 1514 has an interface coupled to the communication device 306 via the LAN 310, and two interfaces coupled to the network 316. The router 1514 includes a storage device holding the locator list 1534. The router 1514 is a relay device which relays communication between the communication device 306 and the network 316, and operates based on the above-described LISP.

The locator list 1534 is a list indicating locators assigned to the router 1514. As illustrated in FIG. 16B, the locator list 1534 includes two locators. That is to say, the router 1514 has assigned thereto two locators (10.2.1.1 and 10.2.2.1).

The router 1542 has an interface coupled to the communication device 306 via the LAN 310, and an interface coupled to the network 316. The router 1544 includes a storage device holding the locator list 1544. The router 1542 is a relay device which relays communication between the communication device 306 and the network 316, and operates based on the above-described LISP.

The locator list 1544 is a list indicating a locator assigned to the router 1542. As illustrated in FIG. 16C, the locator list 1544 includes one locator. That is to say, the router 1542 has assigned thereto one locators (10.3.1.1).

Note that FIG. 16A illustrates an example of the locator list 332, which is the same as that in FIG. 4A.

The location management server 1522 Is coupled to the network 316, and is an information processing device which operates based on the above-described LISP. The location management server 1522 has coupled thereto a storage device holding the IP address/LAN ID map 1524, a storage device holding the LAN ID/router ID map 1526, and a storage device holding the router ID/locator map 1528. The location management server 1522 searches the IP address/LAN ID map 1524, LAN ID/router ID map 1526, and router ID/locator map 1528, thereby acquiring locators correlated with destination IP addresses included in locator resolution requests received from the routers, and transmits response message including the acquired locators (locator resolution responses) to the source routers of the locator resolution requests. Note that the IP address/LAN ID map 1524, LAN ID/router ID map 1526, and router ID/locator map 1528 may be held in a single storage device.

The IP address/LAN ID map 1524 is a table representing the relation between the IP addresses of the interfaces of the communication devices coupled to the network 316, and the identification information of the corresponding LANs (LAN ID). As illustrated in FIG. 17, the IP address “192.168.1.1” of the interface of the communication device 304 and the LAN ID “L1” of the LAN 308 are correlated, and the IP address “192.168.2.2” of the interface of the communication device 306 and the LAN ID “L2” of the LAN 310 are correlated. That is to say, two different LANs 308 and 310 are correlated as to the interfaces of the two communication device 304 and 306 belonging to the same logical network 302.

The LAN ID/router ID map 1526 is a table indicating the relation between the identification information of each LAN (LAN ID) and the identification information of the routers coupled to the LANs (router ID). As illustrated in FIG. 18, the LAN ID “L1” of the LAN 308 and the router ID “R1” of the router 312 are correlated, and the LAN ID “L2” of the LAN 310 and the two router IDs “R2” and “R3” of the routers 1514 and 1542 coupled to the network 316 are correlated. That is to say, with the LAN 310, two different routers 1514 and 1542 are correlated to a single LAN.

The router ID/locator map 1528 is a table indicating the relation between the identification information of each router coupled to the network 316 (router ID) and corresponding locators. As illustrated in FIG. 19, the router ID “R1” of the router 312 and the two locators “10.1.1.1” and “10.1.2.1” of the router 312 are correlated, the router ID “R2” of the router 1514 and the two locators “10.2.1.1” and “10.2.2.1” of the router 1514 are correlated, and the router ID “R3” of the router 1542 and the locator “10.3.1.1” of the router 1542 are correlated. That is to say, With the routers 312 and 1514, two locators are correlated to one router ID.

### 4-2. Communication Control Method with Communication System 1500

The communication control method with the communication system 1500 differs from the communication control method of the communication system 300 illustrated in FIG. 7 with regard to the locator acquisition processing executed in step S706 and step S714, but other parts are the same.

The locator acquisition processing with the communication system 1500 differs from the locator acquisition processing with the communication system 300 with regard to the point that, at the time of acquiring a locator correlated with a destination IP address included in the locator resolution request, the three tables of the IP address/LAN ID map 1524, LAN ID/router ID map 1526, and router ID/locator map 1528 are used, instead of using the two tables of the IP address/router ID map 326 and router ID/locator map 328, but other parts are the same.

Unlike the location management server 322, in steps S706 and S714, the location management server 1522 acquires a LAN ID correlated with the destination IP address included in the received locator resolution request, by searching the IP address/LAN ID map 1524. In the examples illustrated in FIGS. 7 and 15, the destination IP address is “192.168.2.2”, and according to the map illustrated in FIG. 17, the acquired LAN ID is “L2”.

Further, the location management server 1522 acquires a router ID correlated with the acquired LAN ID, by searching the LAN ID/router ID map 1526. In the examples illustrated in FIGS. 7 and 15, the LAN ID is “L2”, and according to the map illustrated in FIG. 18, the acquired router IDs are “R2” and “R3”

Further, the location management server 1522 acquires locators correlated with the acquired router IDs, by searching the router ID/locator map 1528. In the examples illustrated in FIGS. 7 and 15, the router IDs are “R2” and “R3”, and according to the map illustrated in FIG. 19, the acquired locators are “10.2.1.1”, “10.2.2.1”, and “10.3.1.1”.

As described above, the location management server 1522 acquires locators correlated to destination IP addresses included in locator resolution requests received from the router 312, in accordance with the above-described locator acquisition processing. The location management server 1522 transmits a response message including the acquired locators (locator resolution response) to the router 312. In the examples illustrated in FIGS. 7 and 15, the three locators of “10.2.1.1”, “10.2.2.1”, and “10.3.1.1” are acquired as to the destination IP address 192.168.2.2. The destinations which the acquired locators indicate are three of the interfaces of the routers 1514 and 1542 to which the communication device 306 is coupled, so the locator resolution response includes “10.2.1.1”, “10.2.2.1”, and “10.3.1.1” as locators.

In step S708, the router 312 checks whether or not the locators included in the locator resolution response received from the location management server 1522 are included in the locator list 332. In response to the locators included in the locator resolution response not being included in its own locator list 332, in step S710 the router 312 performs Proxy MAC address response processing as to the communication device 304 by a MAC address resolution response including the MAC address of its own interface.

As described above, even in a case where packet communication is performed between communication devices belonging to different LANs with a communication system where one logical network is configured of multiple LANs, with the communication system 1200 the router 312 to which the communication device 304 which has transmitted a MAC address resolution response is coupled executes Proxy MAC address response processing as to the communication device 304, so packet communication may be executed in a normal manner.

Also, with the communication system 1500, at the time of the router 312 deciding whether or not to execute Proxy MAC address response processing, the maps (location information) 1524, 1526, and 1528, indicating the relation between IP addresses and locators, held in the location management server 1522 which operates based on LISP, are used. Accordingly, a database relating to location information of communication devices to perform communication does not have to be newly constructed, thereby avoiding location information of communication devices held in the overall network from becoming redundant, and enabling storage device resources such as memory to be effectively used.

### 4-3. Configuration of Routers 1514 and 1542

The configuration of the routers 1514 and 1542 in the communication system 1500 is the same as with the configuration of the routers 312 and 314 in the communication system 300. Accordingly, detailed description will be omitted.

### 4-4. Configuration of Location Management server 1522

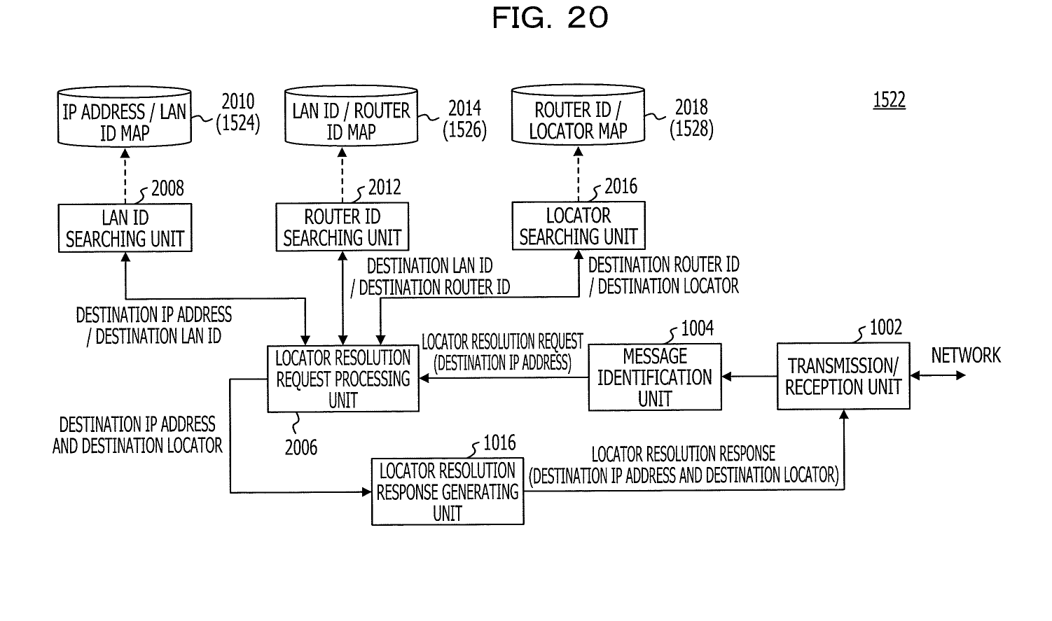

FIG. 20 is a functional block diagram illustrating the configuration of the location management server 1522 according to the third embodiment.

The location management server 1522 illustrated in FIG. 20 differs from the location management server 322 illustrated in FIG. 10 with regard to the point that a locator resolution request processing unit 2006 is provided instead of the locator resolution request processing unit 1006, a LAN ID searching unit 2008, an IP address/LAN ID map 2010, a router ID searching unit 2012, a LAN ID/router ID map 2014, a locator searching unit 2016, and an ID locator table 2018, are provided instead of the router ID searching unit 1008, IP address/router ID map 1010, locator searching unit 1012, and router ID/locator map 1014, but other parts are the same. Parts which are the same as or equivalent to those in the location management server 322 illustrated in FIG. 10 are denoted with the same reference numerals. The operations and functions of the parts denoted by the same reference numerals in FIG. 20 are the same as described with reference to FIG. 10, so detailed description will be omitted.

With the functional block diagram illustrated in FIG. 20, in the same way as with the functional block diagram illustrated in FIG. 10, portions of the location management server 1522 which correspond to functions relating to the Proxy MAC address response processing and locator resolution processing described with reference to FIG. 7 are illustrated, and description of portions corresponding to other functions is omitted from the Present Specification, since arrangements according to the related art may be used.

The locator resolution request processing unit 2006 receives locator resolution requests from the message identification unit 1004, and notifies the information of the destination IP address included in the received locator resolution request to the LAN ID searching unit 2008.

The LAN ID searching unit 2008 receives the information of the destination IP address from the locator resolution request processing unit 2006, and searches the IP address/LAN ID map 2010 based on the received destination IP address, thereby acquiring the LAN ID correlated with that destination IP address (destination LAN ID). The LAN ID searching unit 2008 notifies the information of the acquired destination LAN ID to the locator resolution request processing unit 2006. Note that the IP address/LAN IP map 2010 is the same as the IP address/LAN ID map 1524 illustrated in FIG. 15.

The locator resolution request processing unit 2006 acquires information of the destination LAN ID from the LAN ID searching unit 2008, and notifies information of the acquired LAN ID to the router ID searching unit 2012.

The router ID searching unit 2012 receives the information of the destination LAN ID from the locator resolution request processing unit 2006, and searches the LAN ID/router ID map 2014 based on the received destination LAN ID, thereby acquiring the router ID correlated to that destination LAN ID (destination router ID). The router ID searching unit 2012 notifies the information of the acquired destination router ID to the locator resolution request processing unit 2006. The LAN ID/router ID map 2014 is the same as the LAN ID/router ID map 1526 illustrated in FIG. 15.

The locator resolution request processing unit 2006 acquires information of the destination router ID from the router ID searching unit 2012, and notifies the information of the acquired destination router ID to the locator searching unit 2016.

The locator searching unit 2016 receives the information of the destination router ID from the locator resolution request processing unit 2006, and searches the router ID/locator map 2018 based on the received destination router ID, thereby acquiring a locator correlated with the destination router ID (destination locator). The locator searching unit 2016 notifies the information of the acquired destination locator to the locator resolution request processing unit 2006. Note that the router ID/locator map 2018 is the same as the router ID/locator map 1528 illustrated in FIG. 15.

The locator resolution request processing unit 2006 acquires information of the destination locator from the locator searching unit 2016. The locator resolution request processing unit 2006 notifies the locator resolution response generating unit 1016 of the information of the acquired destination locator, in addition to the destination IP address.

Note that the hardware configuration of the location management server 1222 is the same as the hardware configuration of the location management server 322 illustrated in FIG. 11. The functions of the functional blocks of the location management server 1222 may be realized with the same hardware configuration of the location management server 322 illustrated in FIG. 11. The IP address/LAN ID map 2010, LAN ID/router ID map 2014, and router ID/locator map 2018, are each stored in memory or a storage device. Accordingly, detailed description will be omitted.

As described above, at the time of the router 312 (314) deciding whether or not to execute Proxy MAC address response processing, the location management server 1522 operating based on LISP acquires the destination locator using the maps (location information) 1524, 1526, and 1528, representing the relation between IP addresses and locators, which it holds itself, and notifies the information of the acquired destination locators to the router 312 (314). Accordingly, a database relating to location information of communication devices to perform communication does not have to be newly constructed, thereby avoiding location information of communication devices held in the overall network from becoming redundant, and enabling storage device resources such as memory to be effectively used.

### 5. Fourth Embodiment

The following is a description of a communication system, communication control method, relay device, and information processing device, according to a fourth embodiment.

### 5-1. Configuration of Communication System 2100

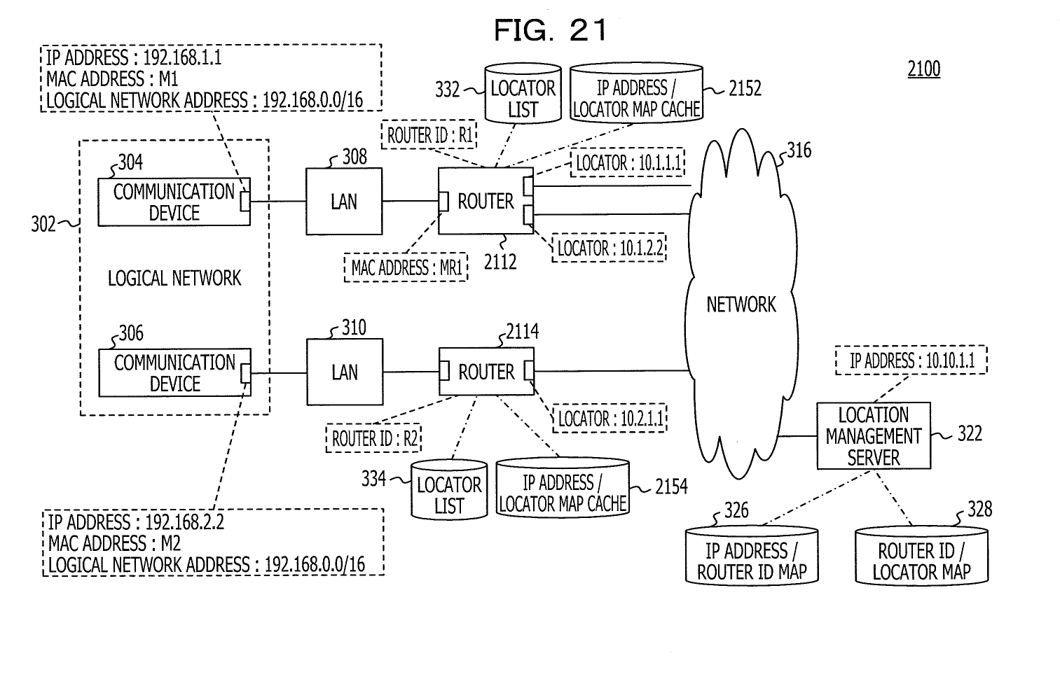

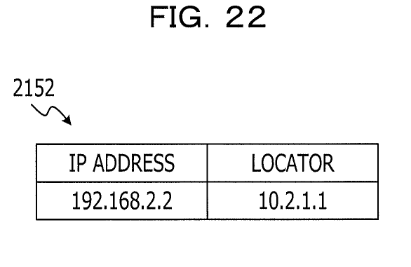

FIG. 21 is a diagram illustrating the configuration of a communication system 2100 according to the fourth embodiment. FIG. 22 is a diagram illustrating an example of an IP address/locator cache map 2152.

The communication system 2100 illustrated in FIG. 21 differs from the communication system 300 illustrated in FIG. 3 with regard to the points that routers 2112 and 2114 are provided instead of the routers 312 and 314, and that IP address/locator cache maps 2152 and 2154 are added, and parts other than the above points are the same as with the communication system 300. Parts which are the same as or equivalent to those in the communication system 300 illustrated in FIG. 3 are denoted with the same reference numerals. The operations and functions of the parts denoted by the same reference numerals in FIG. 21 are the same as described with reference to FIG. 3, so detailed description will be omitted.

In FIG. 21, the router 2112 has, in the same way as with the router 312 illustrated in FIG. 3, an interface coupled to the communication device 304 via the LAN 308, and two interfaces coupled to the network 316. The router 2112 includes a storage device holding the locator list 332. The router 2112 is a relay devices which relays packet communication between the communication device 304 and the network 316, and operates based on the above-described LISP.

In the same way as with the router 312, upon receiving a MAC address resolution request from a communication device belonging to the corresponding LAN 308, the router 2112 transmits a locator resolution request to the location management server 322, and thereafter receives a locator resolution response corresponding to that locator resolution request, from the location management server 322. In the event that the destination locator included in the received locator resolution request is not included in the locator list 332, the router 2112 performs Proxy MAC address response processing as to the source communication device using the MAC address of an interface of itself.

The router 2112 further includes a storage device holding the IP address/locator cache map 2152. The IP address/locator cache map 2152 is a table holding information of destination IP addresses and destination locators included in a received locator resolution response, when the router 2112 receives a locator resolution response from the location management server 322. In the example illustrated in FIG. 22, the IP address/locator cache map 2152 holds an entry indicating the relation between the IP address “192.168.2.2” (IP address of the interface of the communication device 306) and the corresponding locator “10.2.1.1” (IP address of the interface of the router 2114).

In the same way as with the router 314, the router 2114 has an interface coupled to the communication device 306 via the LAN 310, and an interface coupled to the network 316. The router 2114 includes a storage device holding the locator list 334. The router 2114 is a relay devices which relays packet communication between the communication device 306 and the network 316, and operates based on the above-described LISP.

Upon receiving a MAC address resolution request from a communication device belonging to the corresponding LAN 310, the router 2114 transmits a locator resolution request to the location management server 322, and thereafter receives a locator resolution response corresponding to that resolution request, from the location management server 322. In the event that the destination locator included in the received locator resolution request is not included in the locator list 334, the router 2114 performs Proxy MAC address response processing as to the source communication device using the MAC address of an interface of itself.

The router 2114 further includes a storage device holding the IP address/locator cache map 2154. The IP address/locator cache map 2154 is a storage table holding information of destination IP addresses and destination locators included in a received locator resolution response, when the router 2114 receives a locator resolution response from the location management server 322.

Note that the IP address/locator cache maps 2152 and 2154 may each be held in a single storage device, or may be held spanning multiple storage devices.

### 5-2. Communication Control Method with Communication System 2100

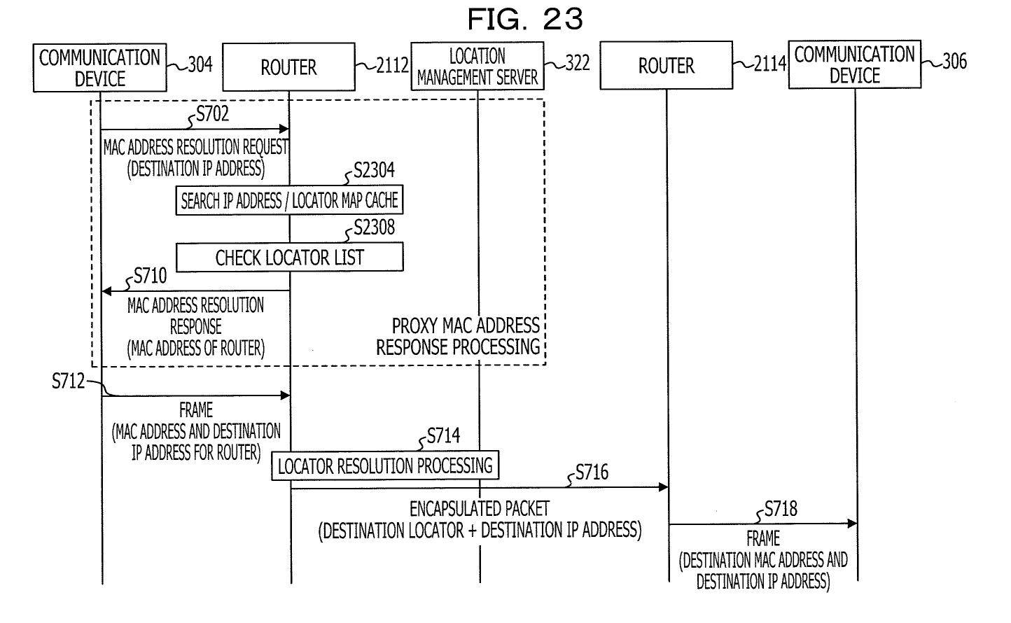

FIG. 23 is a sequence chart for describing a communication control method with the communication system 2100. Hereinafter, description will be made referencing FIG. 21 in addition to FIG. 23, regarding a communication control method with the communication system 2100 in a case of transmitting packets from the interface of the communication device 304 to the interface of the communication device 306 belonging to the same logical network.

The communication control method illustrated in FIG. 23 differs from the communication control method illustrated in FIG. 7 with regard to the point that processing of steps S2304 and S2308 is performed instead of the processing of steps S704 and S708, but processing other than these steps is the same as the communication control method illustrated in FIG. 7. Portions which are the same as or equivalent to those in the communication control method illustrated in FIG. 7 are denoted with the same reference numerals. The operations and functions of the portions denoted by the same reference numerals in FIG. 23 are the same as described with reference to FIG. 7, so detailed description will be omitted.

As illustrated in FIG. 23, in step S2304 the router 2112 receives a MAC address resolution request transmitted from the communication device 304 in step S702. At this time, before transmitting a message (locator resolution request) requesting a locator (destination locator) correlated with the destination IP address included in the received MAC address resolution request to the location management server 322, the router 2112 searches the IP address/locator cache map 2152 illustrated in FIG. 22, and based on the destination IP address included in the received MAC address resolution request, checks whether or not the destination locator correlated to that destination IP address is included in the IP address/locator cache map 2152.

In the event that the destination locator is included in the IP address/locator cache map 2152, the router 2112 references the IP address/locator cache map 2152, thereby acquiring the destination locator correlated with the destination IP address. With the example illustrated in FIGS. 21 and 23, the IP address of the interface of the communication device 306 (destination IP address) is “192.168.2.2”, and according to the table illustrated in FIG. 22, the acquired destination locator is “10.2.1.1”.

On the other hand, in the event that the destination locator is not included in the IP address/locator cache map 2152, the router 2112 transmits a message requesting the destination locator (locator resolution request) to the location management server 322, in the same way as with step S704. In the same way as with step S706, the router 2112 acquires the destination locator correlated with the destination IP address by receiving a locator resolution response corresponding to that locator resolution request from the location management server 322.

Note that in the event that multiple locators are assigned to the router coupled to the interface of the destination communication device 306, or in the event that the interface of the destination communication device 306 is coupled to multiple routers, unlike the example illustrated in FIG. 21, multiple locators are correlated with a single IP address in the IP address/locator cache map 2152, unlike the example illustrated in FIG. 22. In this case, the router 2112 acquires the multiple destination locators correlated with the destination IP address.

Next, in step S708, the router 2112 references the locator list 332, so as to check whether or not the destination locator acquired in step S2304 is included in its own locator list 332.

With the example illustrated in FIG. 21, the router 2112 checks that the acquired destination locator “10.2.1.1” is not included in its own locator list 332, based on the locator list 332 illustrated in FIG. 4A. Accordingly, the router 2112 recognizes that the interface of the communication address 306 having this destination IP address does not belong to the LAN 308.

In step S710, in response to the acquired destination locator not being included in its own locator list 332, the router 2112 performs Proxy MAC address response processing as to the communication device 304 which has transmitted to the MAC address resolution request in step S702, by a MAC address proxy response including the MAC address of the interface of itself.

As described above, even in a case where packet communication is performed between communication devices belonging to different LANs with a communication system where one logical network is configured of multiple LANs, with the communication system 2100 the router 2112 to which the communication device 304 which has transmitted a MAC address resolution request is coupled executes Proxy MAC address response processing as to the communication device 304, so packet communication may be executed in a normal manner.

Also, with the communication system 2100, at the time of the router 2112 deciding whether or not to execute Proxy MAC address response processing, the cache map information (location information) of the IP address/locator cache map 2152 indicating the relation between IP addresses and locators, held in the router 2112, is used. Accordingly, a database relating to location information of communication devices to perform communication does not have to be newly constructed, thereby avoiding location information of communication devices held in the overall network from becoming redundant, and enabling storage device resources such as memory to be effectively used. Also, in the event that cache map information (location information) of the IP address/locator cache map 2152 may be used, transmission/reception of a locator resolution request and a corresponding locator resolution response is not performed between the router 2112 and the location management server 322, so the amount of communication between the router 2112 and the location management server 322 may be suppressed, thereby alleviating the communication load with regard to the network 316.

### 5-3. Configuration of Router 2112 (2114)

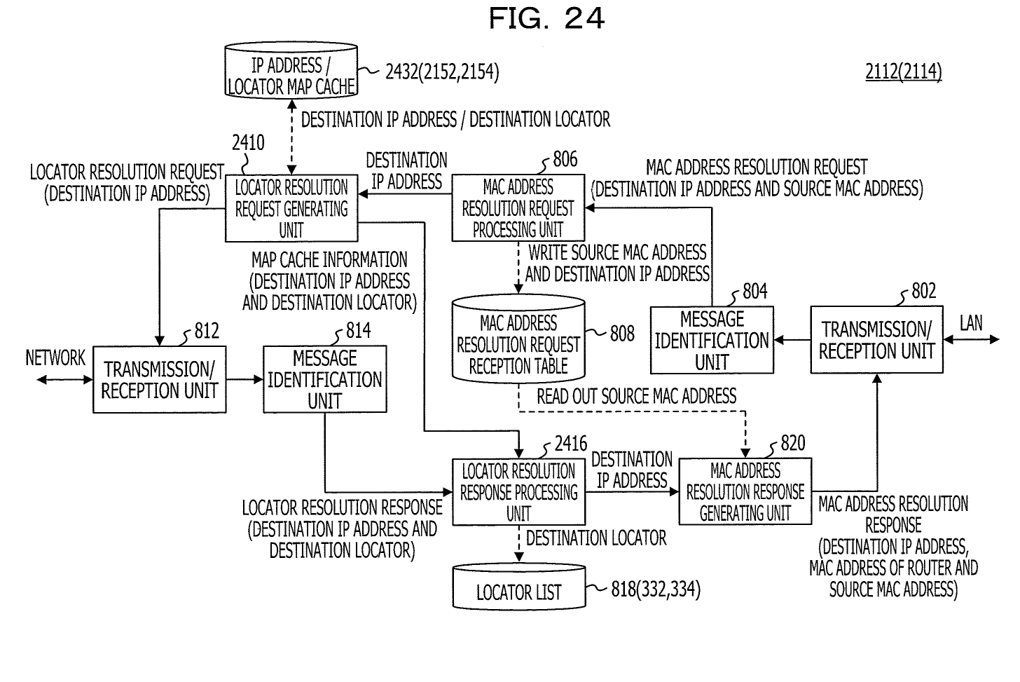

FIG. 24 is a diagram illustrating the configuration of the router 2112 (2114) according to the fourth embodiment.

The router 2112 (2114) illustrated in FIG. 24 differs from the router 312 (314) illustrated in FIG. 8 with regard to the points that a locator resolution request generating unit 2410 and a locator resolution response processing unit 2416 are provided instead of the locator resolution request generating unit 810 and locator resolution response processing unit 816, and that an IP address/locator cache map 2432 is provided but is the same as the router 312 (314) other than the above points. Parts which are the same as or equivalent to those in the router 312 (314) illustrated in FIG. 8 are denoted with the same reference numerals. The operations and functions of the parts denoted by the same reference numerals in FIG. 24 are the same as described with reference to FIG. 8, so detailed description will be omitted.

With the functional block illustrated in FIG. 24, the portions corresponding to the functions of the router 2112 (2114) relating to the Proxy MAC address response processing described with reference to FIG. 23 are illustrated, and description of portions corresponding to other functions is omitted from the Present Specification, since arrangements according to the related art may be used. Also, while the configuration of the router 2112 will be described, the router 2112 and 2114 have mutually equivalent configurations in the communication system 2100.

As illustrated in FIG. 24, the locator resolution request generating unit 2410 receives information of a destination IP address from the MAC address resolution request processing unit 806. The locator resolution request generating unit 2410 searches the IP address/locator cache map 2432 based on the information of that destination IP address, and checks whether or not the destination locator correlated to that destination IP address is included in the IP address/locator cache map 2432. Note that the IP address/locator cache map 2432 is the same as the IP address/locator cache map 2152 (2154) illustrated in FIG. 21.

In the event that the destination locator is included in the IP address/locator cache map 2432, the locator resolution request generating unit 2410 references the IP address/locator cache map 2432, so as to acquire the destination locator correlated with the destination IP address. The locator resolution request generating unit 2410 outputs the destination IP address included in the MAC address resolution request and cache map hit information including the acquired destination locator to the locator resolution response processing unit 2416. At this time, the locator resolution request generating unit 2410 does not generate a locator resolution request.

On the other hand, in the event that the destination locator is not included in the IP address/locator cache map 2432, the locator resolution request generating unit 2410 generates a locator resolution request including the destination IP address based on the received destination IP address. The locator resolution request generating unit 2410 outputs the generated locator resolution request to the transmission/reception unit 812.

In the event of having received cache map hit information from the MAC address resolution request processing unit 806, the locator resolution response processing unit 2416 acquires information of the destination IP address and destination locator from the received cache map hit information. In the other hand, in the event of having received a locator resolution request from the message identification unit 814, the locator resolution response processing unit 2416 acquires information of the destination IP address and destination locator from the received locator resolution request.

The locator resolution response processing unit 2416 references the locator list 818, thereby checking whether or not the acquired destination locator is included in the locator list 818. Now, the locator list 818 is the same as the locator list 332 (334) illustrated in FIG. 3.

In the event that the destination locator is not included in the locator list 818, the locator resolution response processing unit 2416 notifies the MAC address resolution request generating unit 820 to that effect, and also outputs the destination IP address included in the received locator resolution response to the MAC address proxy response generating unit 820.

Note that the hardware configuration of the router 2112 (2114) is the same as the hardware configuration of the router 312 (314) illustrated in FIG. 9. The functions of the functional blocks of the router 2112 (2114) may be realized with the same hardware configuration of the router 312 (314) illustrated in FIG. 9. The IP address/locator cache map 2432 is stored in memory or a storage device. Accordingly, detailed description will be omitted.

As described above, even in a case where packet communication is performed between communication devices 304 and 306 belonging to different LANs, the router 2112 to which the communication device 304 which has transmitted a MAC address resolution response is coupled executes Proxy MAC address response processing as to the communication device 304, so packet communication may be executed in a normal manner.

Also, at the time of the router 2112 deciding whether or not to execute Proxy MAC address response processing, the cache map information (location information) of the IP address/locator cache map 2152 indicating the relation between IP addresses and locators, held in the router 2112 itself, is used. Accordingly, a database relating to location information of communication devices to perform communication does not have to be newly constructed, thereby avoiding location information of communication devices held in the overall network from becoming redundant, and enabling storage device resources such as memory to be effectively used. Also, in the event that cache map information (location information) of the IP address/locator cache map 2152 may be used, transmission/reception of a locator resolution request and a corresponding locator resolution response is not performed between the router 2112 and the location management server 322, so the amount of communication with the location management server 322 may be suppressed, thereby alleviating the communication load with regard to the network 316.

### 5-4. Configuration of Location Management Server 322

The configuration of the location management server 322 in the communication system 2100 is the same as the configuration of the location management server 322 in the communication system 300. Accordingly, detailed description will be omitted.

### 6. Fifth Embodiment

The following is a description of a communication system and communication control method, according to a fifth embodiment.

### 6-1. Configuration of Communication System 2500

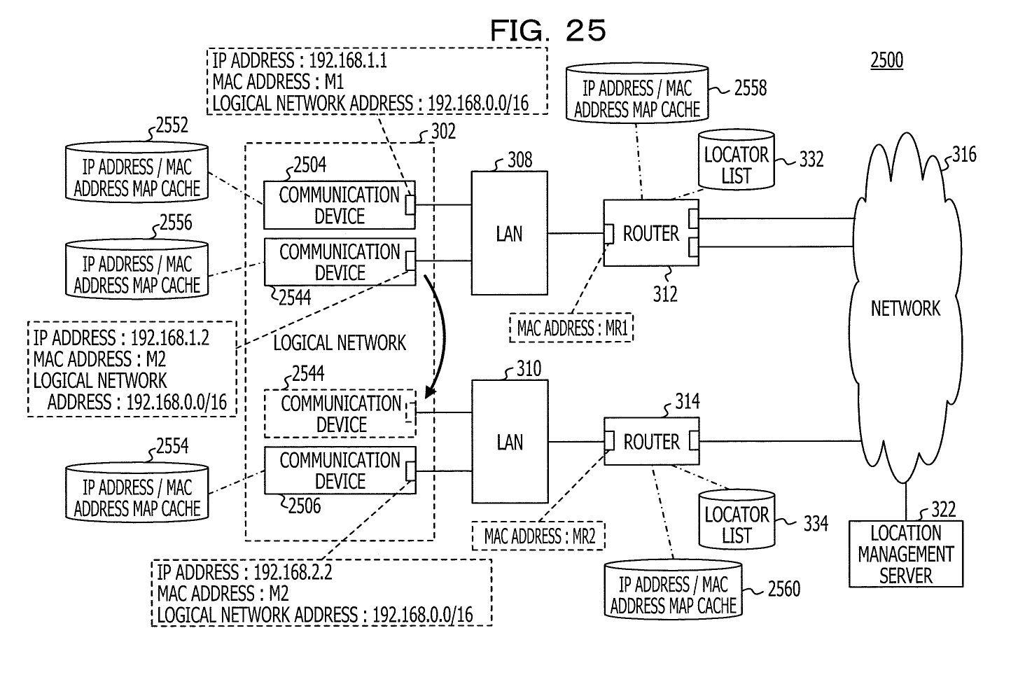

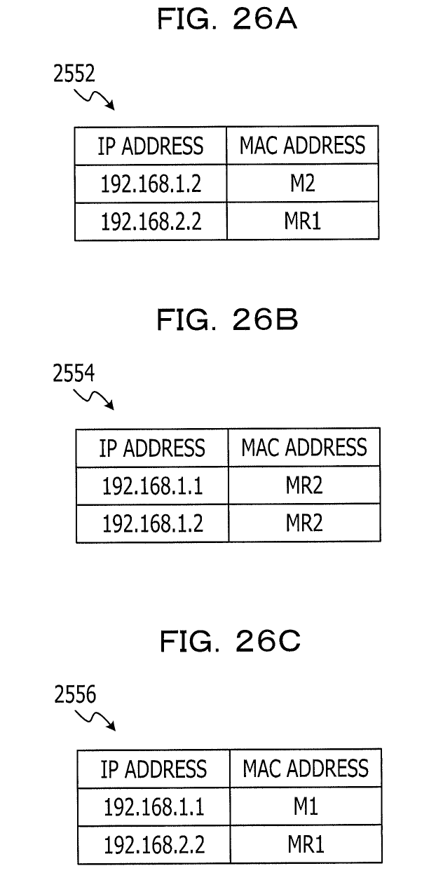

FIG. 25 is a diagram illustrating the configuration of a communication system 2500 according to a fifth embodiment, and FIGS. 26A through 26C are diagrams illustrating an example of IP address/MAC address cache maps 2552 through 2556 before changing of a LAN to which a communication device 2554 is coupled.

The communication system 2500 illustrated in FIG. 25 differs from the communication system 300 illustrated in FIG. 3 with regard to the points that communication devices 2504, 2506, and 2544 are provided instead of the communication devices 302 and 304, and that IP address/MAC address cache maps 2552 through 2560 are added, and parts other than the above points are the same as with the communication system 300. Parts which are the same as or equivalent to those in the communication system 300 illustrated in FIG. 3 are denoted with the same reference numerals. The operations and functions of the parts denoted by the same reference numerals in FIG. 25 are the same as described with reference to FIG. 3, so detailed description will be omitted.

The communication device 2504 and communication device 2544 belong to the same logical network 302, and further belong to the same LAN 308. The communication devices 2504 and 2544 each are coupled to the network 316 via the corresponding router 312. The communication device 2506 belongs to the same logical network 302 as the communication devices 2504 and 2544, but belong to a different LAN. The communication device 2506 belongs to LAN 310, and is coupled to the network 316 via the corresponding router 314.

The communication device 2504 includes a storage device holding the IP address/MAC address cache map 2552. The IP address/MAC address cache map 2552 is a cache map table holding information of destination IP addresses and destination MAC addresses included in a received MAC address resolution response, when the communication device 2504 receives a MAC address resolution response. In the event that the MAC address proxy response is an ARP response, an ARP cache map is held in the IP address/MAC address cache map 2552.

With the example illustrated in FIG. 26A, two entries are held in the IP address/MAC address cache map 2552, which are the relation between the IP address “192.168.1.2” (IP address of the interface of the communication device 2544) and the corresponding MAC address “M2” (MAC address of the interface of the communication device 2544), and the relation between the IP address “192.168.2.2” (IP address of the interface of the communication device 2506) and the corresponding MAC address “MR1” (MAC address of the interface of the router 312).

Now, the reason why the MAC address “MR1” of the interface of the router 312 has been correlated with the IP address “192.168.2.2” of the interface of the communication device 2506 is in order for, since the communication device 2506 belongs to a different LAN 310 from the communication device 2504, the router 312 to perform Proxy MAC address response processing as to the communication device 2504 by a MAC address resolution response including the MAC address “MR1” of its own device, when the communication device 2504 transmits a message requesting the MAC address of the interface of the communication device 2506 (MAC address resolution request).

In the same way as with the communication device 2504, the communication device 2506 includes a storage device holding the IP address/MAC address cache map 2554. The IP address/MAC address cache map 2554 is a cache map table holding information of destination IP addresses and destination MAC addresses included in a received MAC address resolution response, when the communication device 2506 receives a MAC address resolution response. In the event that the MAC address proxy response is an ARP response, an ARP cache map is held in the IP address/MAC address cache map 2554.

With the example illustrated in FIG. 26B, two entries are held in the IP address/MAC address cache map 2554, which are the relation between the IP address “192.168.1.1” (IP address of the interface of the communication device 2504) and the corresponding MAC address “MR2” (MAC address of the interface of the router 314), and the relation between the IP address “192.168.1.2” (IP address of the interface of the communication device 2544) and the corresponding MAC address “MR2” (MAC address of the interface of the router 314).

Now, the reason why the MAC address “MR2” of the interface of the router 314 has been correlated with both IP addresses “192.168.1.1” and “192.168.1.2” of the interface of the communication device 2506 is in order for, since the communication devices 2504 and 2544 belong to a different LAN 308 from the communication device 2506, the router 314 to perform Proxy MAC address response processing as to the communication device 2506 by a MAC address resolution response including the MAC address “MR2” of its own interface, when the communication device 2506 transmits a message requesting the MAC address of the interface of the communication device 2504 (MAC address resolution request).

The communication device 2544 includes a storage device holding the IP address/MAC address cache map 2556. The IP address/MAC address cache map 2556 is a table holding information of destination IP addresses and destination MAC addresses included in a received MAC address resolution response, when the communication device 2544 receives a MAC address resolution response.

With the example illustrated in FIG. 26C, two entries are held in the IP address/MAC address cache map 2556, which are the relation between the IP address “192.168.1.1” (IP address of the interface of the communication device 2504) and the corresponding MAC address “M1” (MAC address of the interface of the communication device 2504), and the relation between the IP address “192.168.2.2” (IP address of the interface of the communication device 2506) and the corresponding MAC address “MR1” (MAC address of the interface of the router 312).

The routers 312 and 314 also include storage devices which store IP address/MAC address cache maps 2558 and 2560 in the same way.

### 6-2. Communication Control Method with Communication System 2500

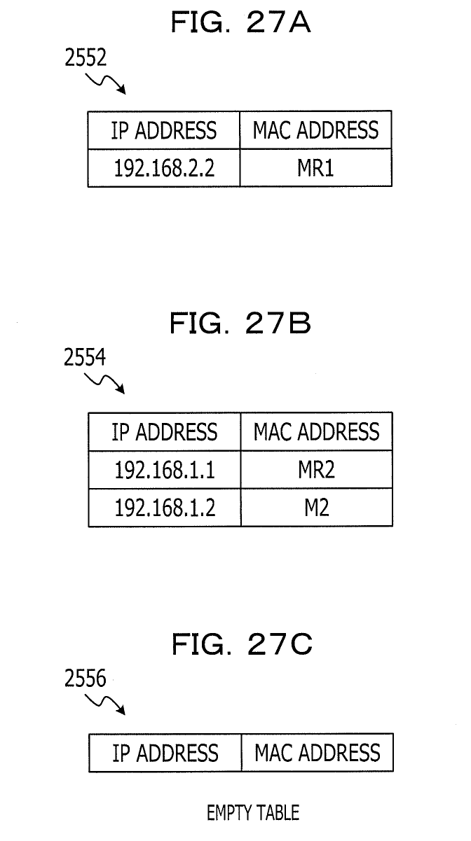

Now, a communication control method will be described regarding a case where, with the communication system 2500 illustrated in FIG. 25, the communication device 2544 is switched from being coupled to the LAN 308 to a different LAN 310 within the same logical network 302. FIGS. 26A through 26C are diagrams illustrating an example of IP address/MAC address cache maps 2552 through 2556 before changing of the LAN to which the communication device 2544 is coupled, and FIGS. 27A through 27C are diagrams illustrating an example of IP address/MAC address cache maps 2552 through 2556 after changing of the LAN to which the communication device 2544 is coupled;

In the event that the communication device 2544 is a virtual machine, moving of the communication device 2544 described above occurs when the communication device 2544 is moved from the server where it is currently situated to another server by live migration, for example. Also, the event that the communication device 2544 is a rack-mounted server, moving of the communication device 2544 described above occurs when the communication device 2544 is relocated from the rack where it is currently mounted to another rack, for example.

Before the LAN to which it is coupled is changed, the communication device 2544 broadcasts a message to all communication devices and routers belonging to the LAN 308 to which it is coupled, to invalidate entries corresponding to the IP address “192.168.1.2” of its own interface from their IP address/MAC address cache maps (entry invalidation request).

The communication device 2504 receives the above-described entry invalidation request from the communication device 2544 and invalidates the entry corresponding to the IP address “192.168.1.2” of the interface of the communication device 2544 from the entries in the IP address/MAC address cache map 2552. Accordingly, as illustrated in FIG. 27A, the IP address/MAC address cache map 2552 no longer includes an entry corresponding to the IP address “192.168.1.2” of the interface of the communication device 2544.

At the IP address/MAC address cache map 2558 which the router 312 holds as well, the entry corresponding to the IP address “192.168.1.2” of the interface of the communication device 2544 is invalidated.

Further, after the LAN to which it is coupled is changed, the communication device 2544 broadcasts a message to all communication devices and routers belonging to the LAN 310 to which it has been coupled, to update entries corresponding to the IP address “192.168.1.2” of its own interface in their IP address/MAC address cache maps (entry update request). That is to say, the communication device 2544 requests updating of the entry corresponding to the IP address “192.168.1.2” (IP address of the interface of the communication device 2544), in each of the IP address/MAC address cache maps, so as to indicate the relation with the MAC address “M2” (MAC address of the interface of the communication device 2544).

The communication device 2506 receives the above-described entry update request from the communication device 2544 and updates the entry corresponding to the IP address “192.168.1.2” of the interface of the communication device 2544 in the entries in the IP address/MAC address cache map 2554. Accordingly, as illustrated in FIG. 27B, the IP address/MAC address cache map 2554 includes an entry indicating the relation between the IP address “192.168.1.2” of the interface of the communication device 2544 and the corresponding MAC address “M2” (MAC address of the interface of the communication device 2544).

At the IP address/MAC address cache map 2560 which the router 314 holds as well, the entry corresponding to the IP address “192.168.1.2” of the interface of the communication device 2544 is updated.

Further, after the LAN to which it is coupled is changed, the communication device 2544 invalidates all entries of the IP address/MAC address cache map 2556. Accordingly, as illustrated in FIG. 27C, the IP address/MAC address cache map 2556 becomes empty, with no entries included.

While the above embodiment has been described with an entry update request being transmitted by the communication device 2544 after the LAN to which it is coupled has been changed. An entry invalidation request may be transmitted instead. In this case, an entry corresponding to the IP address “192.168.1.2” (the IP address of the interface of the communication device 2544) is newly generated at the IP address/MAC address cache maps of each of the communication devices and routers belonging to the LAN 310, by way of ARP request and ARP response processing.

As described above, with a communication system where one logical network is configured of multiple LANs, even in a case where the LAN to which a communication devices is coupled is changed to a different LAN, with the communication system 2500 cache map information (location information) of the IP address/MAC address cache maps 2552 through 2560 which the communication devices hold may be updated to suitable content, so malfunctioning in communication after the LAN to which the communication devices is coupled is changed may be avoided, thereby improving the stability of the communication system.

### 7. Sixth Embodiment

The following is a description of a communication system, communication control method, relay device, and information processing device, according to a sixth embodiment.

### 7-1. Configuration of Communication System 2800

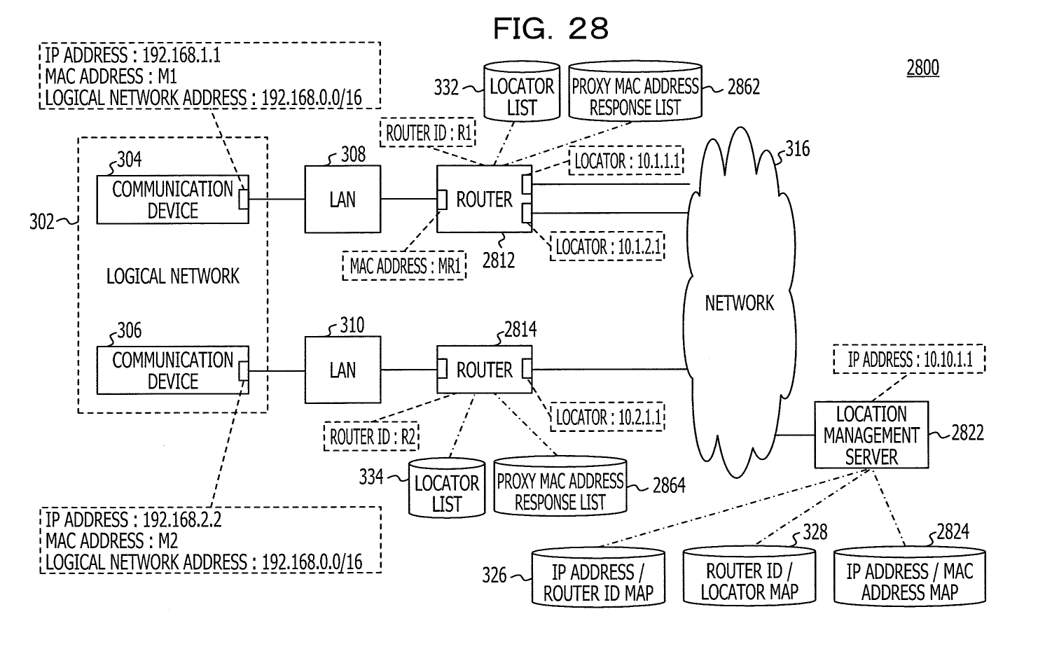

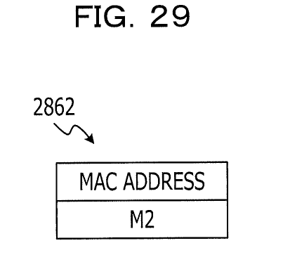

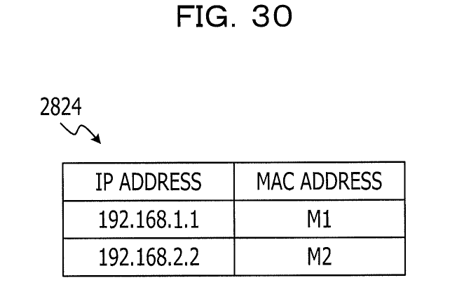

FIG. 28 is a diagram illustrating the configuration of a communication system 2800 according to the sixth embodiment, FIG. 29 is a diagram illustrating an example of a proxy MAC address response list 2862, and FIG. 30 is a diagram illustrating an example of an IP address/MAC address map 2824.

The communication system 2800 illustrated in FIG. 28 differs from the communication system 300 illustrated in FIG. 3 with regard to the points that routers 2812 and 2814 are provided instead of the routers 312 and 314, and that proxy MAC address response lists 2862 and 2864, and an IP address/MAC address map 2824 are provided, and parts other than the above points are the same as with the communication system 300. Parts illustrated which are the same as or equivalent to those in the communication system 300 illustrated in FIG. 3 are denoted with the same reference numerals. The operations and functions of the parts denoted by the same reference numerals in FIG. 28 are the same as described with reference to FIG. 3, so detailed description will be omitted.

In FIG. 28, the router 2812 has, in the same way as with the router 312 illustrated in FIG. 3, an interface coupled to the communication device 304 via the LAN 308, and two interfaces coupled to the network 316. The router 2812 includes a storage device holding the locator list 332. The router 2812 is a relay devices which relays packet communication between the communication device 304 and the network 316, and operates based on the above-described LISP.

In the same way as with the router 312, upon receiving a MAC address resolution request from a communication device belonging to the corresponding LAN 308, the router 2812 transmits a locator resolution request to the location management server 2822, and thereafter receives a locator resolution response corresponding to that resolution request, from the location management server. In the event that the destination locator included in the received locator resolution request is not included in the locator list 332, the router 2812 generates a MAC address resolution response using the MAC address included in the locator resolution request, and performs Proxy MAC address response processing as to the source communication device by way of the generated MAC address resolution response.

The router 2812 further includes a storage device holding the proxy MAC address response list 2862. The proxy MAC address response list 2862 is a table holding information of destination MAC addresses included in a received locator resolution response, when the router 2812 receives a locator resolution response from a location management server 2822. With the communication system 2800 illustrated in FIG. 28, the locator resolution response which the location management server 2822 transmits includes information of the destination MAC address, in addition to the destination IP address and destination locator, unlike the case of the communication system 300 illustrated in FIG. 3. In the example illustrated in FIG. 29, the proxy MAC address response list 2862 holds an entry indicating the MAC address “M2” (MAC address of the interface of the communication device 306).

In the same way as with the router 314, the router 2814 has an interface coupled to the communication device 306 via the LAN 310, and an interface coupled to the network 316. The router 2814 includes a storage device holding the locator list 334. The router 2814 is a relay devices which relays packet communication between the communication device 306 and the network 316, and operates based on the above-described LISP.

Upon receiving a MAC address resolution request from a communication device belonging to the corresponding LAN 310, in the same way as with the router 314, the router 2814 transmits a locator resolution request to the location management server 2822, and thereafter receives a locator resolution response corresponding to that resolution request, from the location management server 2822. In the event that the destination locator included in the received locator resolution request is not included in the locator list 334, the router 2814 generates a MAC address resolution response using the MAC address included in the locator resolution request, and performs Proxy MAC address response processing as to the source communication device by way of the generated MAC address resolution response.

The router 2814 further includes a storage device holding the proxy MAC address response list 2864. The proxy MAC address response list 2864 is a table holding information of destination MAC addresses included in a received locator resolution response, when the router 2814 receives a locator resolution response from the location management server 2822.

Note that the proxy MAC address response lists 2862 and 2864 may each be held in a single storage device, or may be held spanning multiple storage devices.

The location management server 2822 is an information processing device coupled to the network 316 and operating based on LISP described above. The location management server 2822 includes a storage device holding the IP address/router ID map 326 and router ID/locator map 328, in the same way as with the location management server 322 illustrated in FIG. 3. The location management server 2822 searches the IP address/router ID map 326 and the router ID/locator map 328, thereby acquiring locators correlated with destination IP addresses included in locator resolution requests received from the routers (destination locators).

The location management server 2822 further includes a storage device holding an IP address/MAC address map 2824. The IP address/MAC address map 2824 is a table representing the relation between IP addresses and MAC addresses of the communication devices coupled to the network 316 via corresponding routers. As illustrated in FIG. 30, the IP address “192.168.1.1” of the interface of the communication device 304 and the corresponding MAC address “M1” are correlated, and the IP address “192.168.2.2” of the interface of the communication device 306 and the corresponding MAC address “M2” are correlated.

That is to say, with the communication system 2800 illustrated in FIG. 28, the location management server 2822 holds information indicating the correlation between the IP addresses and MAC addresses of the communication devices coupled to the network to which it is coupled. Note that the IP address/MAC address map 2824 may be held in a single storage device, or may be held spanning multiple storage devices.

The location management server 2822 searches the IP address/MAC address map 2824, thereby acquiring MAC addresses correlated with destination IP addresses included in locator resolution requests received from the routers (destination MAC addresses). The location management server 2822 transmits a response message including the acquired destination locator and destination MAC address (locator resolution response) to the source router of the locator resolution request.

### 7-2. Communication Control Method with Communication System 2800

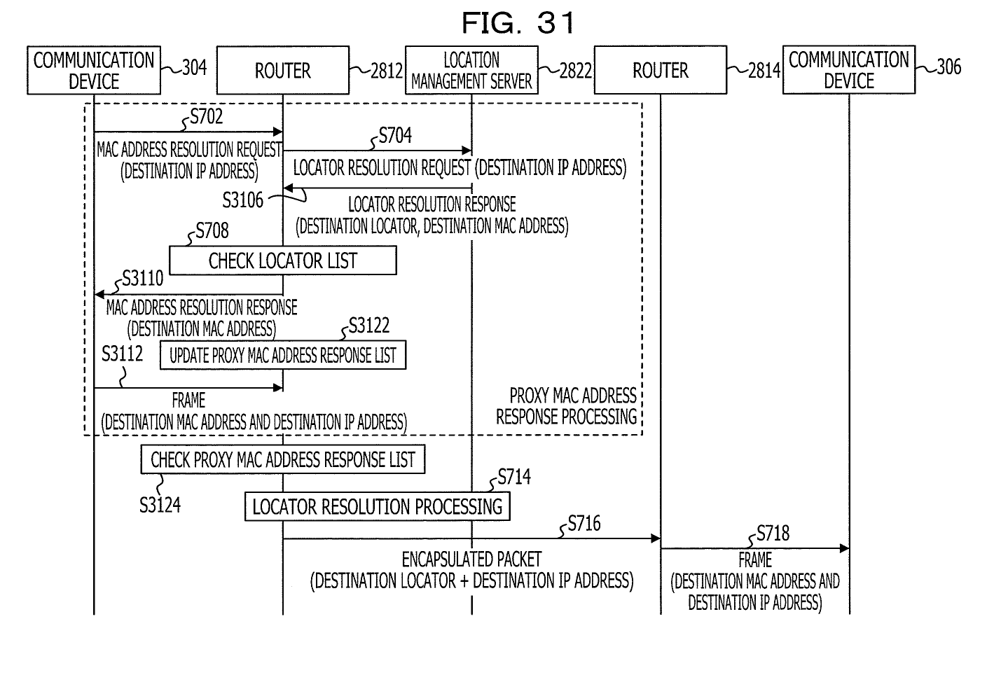

FIG. 31 is a sequence chart for describing a communication control method with the communication system 2800. Hereinafter, description will be made referencing FIG. 28 in addition to FIG. 31, regarding a communication control method with the communication system 2800 in a case of transmitting packets from the interface of the communication device 304 to the interface of the communication device 306 belonging to the same logical network.

The communication control method illustrated in FIG. 31 differs from the communication control method illustrated in FIG. 7 with regard to the point that processing of step S3106 is performed instead of the processing of step S706, and processing of steps S3110, S3122, S3112, and S3124 is performed instead of the processing of steps S710 and S712, but processing other than these steps is the same as the communication control method illustrated in FIG. 7. Portions which are the same as or equivalent to those in the communication control method illustrated in FIG. 7 are denoted with the same reference numerals. The operations and functions of the portions denoted by the same reference numerals in FIG. 31 are the same as described with reference to FIG. 7, so detailed description will be omitted.

As illustrated in FIG. 31, in step S3106 the location management server 2822 receives a locator resolution request from the router 2812.

The location management server 2822 searches the IP address/router ID map 326 based on the destination IP address included in the received locator resolution request, thereby acquiring identification information of the router correlated to that destination IP address (router ID). Further, the location management server 2822 searches the router ID/locator map 328 that is held, based on the acquired router ID, thereby acquiring the locator correlated with the acquired router ID.

The location management server 2822 acquires the destination locator correlate with the destination IP address included in the locator resolution request received from the router 312, by the above-described locator acquisition processing. In the example illustrated in FIGS. 28 and 31, one locator “10.2.1.1” is acquired as to the destination IP address “192.168.2.2”.

Note that unlike the example illustrated in FIG. 28, in a case where multiple locators are assigned to the router coupled to the interface of the destination communication device 306, or in the event that the interface of the destination communication device 306 is coupled to multiple routers, multiple locators are correlated with a single IP address included in the locator resolution request, and the location management server 2822 transmits a locator resolution response including multiple locators.

Further, the location management server 2822 searches the IP address/MAC address map 2824 that is held, based on the destination IP address included in the received locator resolution request, thereby acquiring the MAC address of the interface of the destination communication device having that destination IP address (destination MAC address). With the example illustrated in FIGS. 28 and 31, the destination IP address is “192.168.2.2”, and according to the map illustrated in FIG. 30, the acquired destination MAC address is “M2”.

The location management server 2822 transmits a response message including the acquired destination locator and destination MAC address (locator resolution response) to the router 2812.

Next, in step S708, the router 2812 references the locator list 332, so as to check whether or not the destination locator included in the locator resolution response received from the location management server 2822 is included in its own locator list 332.

With the example illustrated in FIG. 28, the router 2812 checks that the destination locator “10.2.1.1” included in the locator resolution response is not included in the locator list 332, and recognizes that the interface of the communication address 306 having this destination IP address does not belong to the LAN 308.

Next, in step S3110, in response to the acquired destination locator included in the locator resolution response not being included in the locator list 332, the router 2812 transmits a response message as to the MAC address resolution request (MAC address resolution response) to the communication device 304.

At this time, the router 2812 appends the destination MAC address “M2” which is included in the locator resolution response to the MAC address resolution response. That is to say, the router 2812 uses the MAC address of the interface of the communication device 306 to generate a response message (MAC address resolution response), as a proxy for the communication device 306 which originally ought to respond to the MAC address resolution request, and performs Proxy MAC address response processing with the generated MAC address resolution response.

By recognizing that the interface of the communication device 306 does not belong to the LAN 308, the router 2812 recognizes that in the current state, the communication device 304 which has transmitted the MAC address resolution request will not receive a corresponding MAC address resolution response, and accordingly will not recognize the MAC address of the interface of the communication device 306. Accordingly, the router 312 executes the above-described Proxy MAC address response processing with regard to the communication device 304, so as to avoid a situation in which packet transmission from the communication device 304 to the interface of the communication device 306 is not started.

Next, in step S3122, the router 2812 updates the proxy MAC address response list 2862 in accordance with the destination MAC address included in the received MAC address resolution response. In the event that the destination MAC address included in the received MAC address resolution response is not included in the proxy MAC address response list 2862, the router 2812 adds the value of that destination MAC address to the proxy MAC address response list 2862. In the example illustrated in FIG. 28, the destination MAC address is “M2”, and as illustrated in FIG. 29, the MAC address “M2” is added to the proxy MAC address response list 2862 which is an empty state.

Next, in step S3112, the communication device 304 receives a MAC address resolution response from the router 2812. The communication device 304 recognizes the MAC address of the interface of the communication device 306 (“M2” in the example illustrated in FIG. 28) that is included in the received MAC address resolution response as being the MAC address which is the destination (destination MAC address). The communication device 304 transmits a packet of which the destination is the interface of the communication device 306, as a frame with the interface of the communication device 306 as the destination thereof. At this time, the transmitted frame includes the IP address of the destination communication device 306 interface as the destination IP address, and also includes the MAC address and IP address of the interface of the destination communication device 306 as the destination MAC address. With the example illustrated in FIG. 28, the transmitted frame includes “192.168.2.2” as the destination IP address and also includes “M2” as the destination MAC address.

Next, in step S3124, the router 2812 checks the destination MAC address included in the frame transmitted from the communication device 304. The router 2812 references the proxy MAC address response list 2862 that is held, thereby checking whether or not the destination MAC address included in the frame transmitted from the communication device 304 is included in its own proxy MAC address response list 2862.

In the example illustrated in FIG. 28, the router 2812 checks that the destination MAC address “M2” included in the frame is included in the proxy MAC address response list 2862, based on the proxy MAC address response list 2862 illustrated in FIG. 29. Accordingly, the router 2812 recognizes that this frame has been transmitted from the router 2812 itself to the communication device which has performed the Proxy MAC address response processing in step S3110.

In the event that the destination MAC address included in the frame is included in the proxy MAC address response list 2862, the router 2812 decides to receive that frame. The router 2812 extracts the packet from the received frame, and transmits to the location management server 2822 a message requesting the locator correlated with the destination IP address included in the extracted packet (locator resolution request).

The router 2812 recognizes that the communication device 306 which has performed the MAC address resolution response in proxy does not belong to the LAN 308, and accordingly recognizes that in the current state the frame transmitted from the communication device 304 will not be revived by any device. Accordingly, in order to avoid a situation in which the frame does not reach the interface of the communication device 306 which is the destination thereof, the router 312 receives the frame transmitted from the communication device 304, and transmits a locator resolution request described above to the location management server 2822.

Next, in step S714, the router 2812 receives the frame from the communication device 304. The router 2812 and location management server 2822 use the destination IP address included in the received frame, i.e., the IP address of the interface of the communication device 306, to execute locator resolution processing.

As described above, even in a case where packet communication is performed between communication devices belonging to different LANs with a communication system where one logical network is configured of multiple LANs, with the communication system 2800 the router 2812 to which the communication device 304 which has transmitted a MAC address resolution request is coupled executes Proxy MAC address response processing as to the communication device 304 using the MAC address of the destination communication device 306, so packet communication may be executed in a normal manner.

### 7-3. Configuration of Router 2812 (2814)

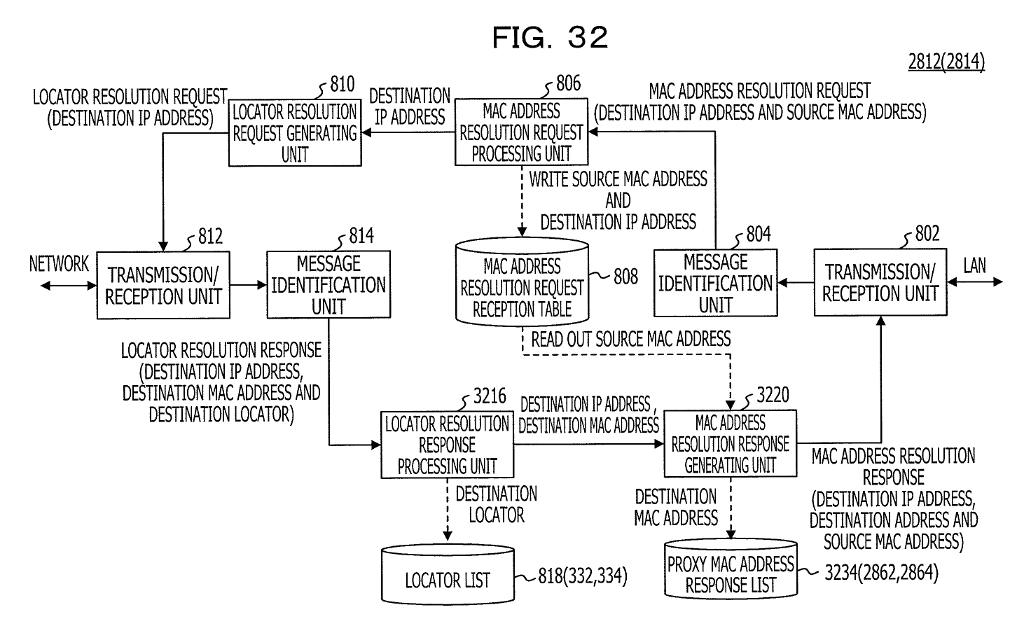

FIG. 32 is a diagram illustrating the configuration of the router 2812 (2814) according to the sixth embodiment.

The router 2812 (2814) illustrated in FIG. 32 differs from the router 312 (314) illustrated in FIG. 8 with regard to the points that a locator resolution response processing unit 3216 and a MAC address resolution response generating unit 3220 are provided instead of the locator resolution response processing unit 820 and MAC address resolution response generating unit 820, and that a proxy MAC address response list 3234 is provided, but is the same as the router 312 (314) other than the above points. Parts which are the same as or equivalent to those in the router 312 (314) illustrated in FIG. 8 are denoted with the same reference numerals. The operations and functions of the parts denoted by the same reference numerals in FIG. 32 are the same as described with reference to FIG. 8, so detailed description will be omitted.

With the functional block illustrated in FIG. 32, the portions corresponding to the functions of the router 2812 (2814) relating to the Proxy MAC address response processing described with reference to FIG. 31 are illustrated, and description of portions corresponding to other functions is omitted from the Present Specification, since arrangements according to the related art may be used. Also, while the configuration of the router 2812 will be described, the router 2812 and 2814 have mutually equivalent configurations in the communication system 2800.

As illustrated in FIG. 32, the locator resolution response processing unit 3216 receives a locator resolution response from the message identification unit 814. The received locator resolution response includes a destination IP address (IP address of the interface of the destination communication device), destination MAC address (MAC address of the interface of the destination communication device), and destination locator (IP address of the interface of the packet destination router).

The locator resolution response processing unit 3216 acquires the information of the destination locator included in the received locator resolution response. By referencing the locator list 818, the locator resolution response processing unit 3216 checks whether or not the acquired destination locator is included in the locator list 818. Note that the locator list 818 is the same as the locator list 332 (334) illustrated in FIG. 3.

In the event that the destination locator is not included in the locator list 818, the locator resolution response processing unit 3216 notifies the MAC address resolution response generating unit 3220 to that effect, and outputs the destination IP address included in the received locator resolution response to the MAC address resolution response generating unit 3220.

The MAC address resolution response generating unit 3220 acquires the destination IP address and destination MAC address from the locator resolution response processing unit 3216. Based on the acquired destination IP address, the locator resolution response processing unit 3216 reads out the corresponding source MAC address (MAC address of the interface of the communication device which is the source of the MAC address resolution request) from the MAC address resolution request reception table 808.

In the event that the destination locator is not included in the locator list 818, the MAC address resolution response generating unit 3220 further references the proxy MAC address response list 3234, thereby checking whether or not the acquired destination MAC address is included in the proxy MAC address response list 3234. Note that the proxy MAC address response list 3234 is the same as the proxy MAC address response list 2862 (2864) illustrated in FIG. 28.

In the event that the acquired destination MAC address is included in the proxy MAC address response list 3234, the MAC address resolution response generating unit 3220 generates a MAC address resolution response, based on the acquired destination IP address and the source MAC address. That is to say, the MAC address resolution response generating unit 3220 generates a MAC address resolution response including the destination MAC address, in addition to the destination IP address and source MAC address. The MAC address resolution response generating unit 3220 outputs the generated MAC address resolution response to the transmission/reception unit 802.

Note that the hardware configuration of the router 2812 (2814) is the same as the hardware configuration of the router 312 (314) illustrated in FIG. 9. The functions of the functional blocks of the router 2812 (2814) may be realized by the same hardware configuration as the hardware configuration of the router 312 (314) illustrated in FIG. 9. The proxy MAC address response list 3234 is stored in memory or a storage device. Accordingly, detailed description will be omitted.

As described above, even in a case where packet communication is performed between communication devices belonging to different LANs with a communication system where one logical network is configured of multiple LANs, the router 2812 to which the communication device 304 which has transmitted a MAC address resolution request is coupled executes Proxy MAC address response processing as to the communication device 304 using the MAC address of the destination communication device, so packet communication may be executed in a normal manner.

### 7-4. Configuration of Location Management Server 2822

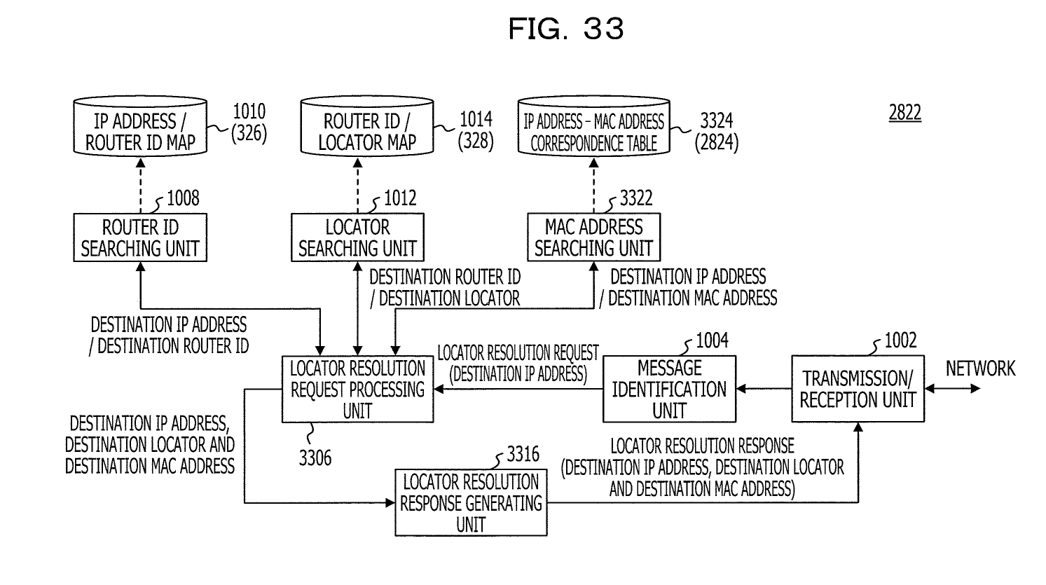

FIG. 33 is a functional block diagram illustrating the configuration of the location management server 2822 according to the sixth embodiment.

The location management server 2822 illustrated in FIG. 33 differs from the location management server 322 illustrated in FIG. 10 with regard to the point that a locator resolution request processing unit 3306 and locator resolution response generating unit 3316 are provided instead of the locator resolution request processing unit 1006 and locator resolution response generating unit 1016, and a MAC address searching unit 3322 and IP address/MAC address map 3324 have been added, but other parts are the same. Parts which are the same as or equivalent to those in the location management server 322 illustrated in FIG. 10 are denoted with the same reference numerals. The operations and functions of the parts denoted by the same reference numerals in FIG. 33 are the same as described with reference to FIG. 10, so detailed description will be omitted.

With the functional block diagram illustrated in FIG. 33, in the same way as with the functional block diagram illustrated in FIG. 10 portions of the location management server 2822 which correspond to functions relating to the Proxy MAC address response processing and locator resolution processing described with reference to FIG. 31 are illustrated, and description of portions corresponding to other functions is omitted from the Present Specification, since arrangements according to the related art may be used.

The locator resolution request processing unit 3306 receives a locator resolution request from the message identification unit 1004 in the same way as with the locator resolution request processing unit 1006 illustrated in FIG. 10, and notifies information of the destination IP address included in the received locator resolution request to the router ID searching unit 1008, thereby acquiring the information of the destination router ID correlated with the destination IP address. The locator resolution request processing unit 3306 notifies the information of the acquired destination router ID to the locator searching unit 1012, thereby acquiring information of the destination locator correlated to the destination router ID from the locator searching unit 1012.

The locator resolution request processing unit 3306 further notifies the information of the destination IP address included in the received locator resolution request to the MAC address searching unit 3322.

The MAC address searching unit 3322 receives the information of the destination IP address from the locator resolution request processing unit 3306, and searches the IP address/MAC address map 3324 based on the received destination IP address, thereby acquiring the MAC address correlated with that destination IP address (destination MAC address). The MAC address searching unit 3322 notifies the information of the acquired destination MAC address to the locator resolution request processing unit 3306. Note that the IP address/MAC address map 3324 is the same as the IP address/MAC address map 2824 illustrated in FIG. 28.

In addition to the destination IP address, the locator resolution request processing unit 3306 notifies the information of the acquired destination locator and destination MAC address to the locator resolution response generating unit 3316.

The locator resolution response generating unit 3316 receives the information of the destination IP address, destination locator, and destination MAC address from the locator resolution request processing unit 3306, and generates a locator resolution response including the received destination IP address, destination locator, and destination MAC address. The locator resolution response generating unit 3316 outputs the generated locator resolution response to the transmission/reception unit 1002.

Note that the hardware configuration of the location management server 2822 is the same as the hardware configuration of the location management server 322 illustrated in FIG. 11. The functions of the functional blocks of the location management server 2822 may be realized with the same hardware configuration of the location management server 322 illustrated in FIG. 11. The IP address/MAC address map 3324 illustrated in FIG. 33 is stored in memory or a storage device. Accordingly, detailed description will be omitted.

As described above, with the communication system 2800, at the time of the router 2812 deciding whether or not to execute Proxy MAC address response processing, the location management server 2822 operating based on LISP notifies the MAC address of the destination communication device 306 to the router 2812, using the maps (location information) 326, 328, and 2824, representing the relation between IP addresses, locators, and MAC addresses, which the location management server 2822 itself holds. Accordingly, a database relating to location information of communication devices to perform communication does not have to be newly constructed, thereby avoiding location information of communication devices held in the overall network from becoming redundant, and enabling storage device resources such as memory to be effectively used.

### 8. Seventh Embodiment

The following is a description of the communication system, communication method, relay device, and information processing device according to a seventh embodiment.

### 8-1. Configuration of Communication System 3400

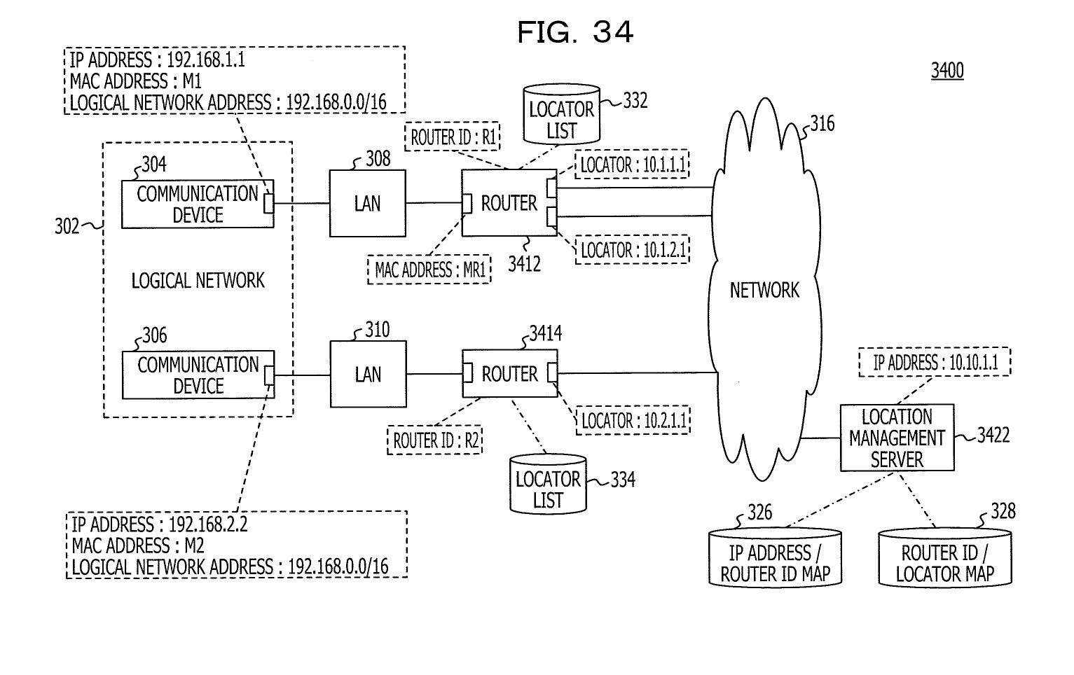

FIG. 34 is a diagram illustrating the configuration of a communication system 3400 according to a seventh embodiment.

The communication system 3400 illustrated in FIG. 34 differs from the communication system 300 illustrated in FIG. 3 with regard to the points that routers 3412 and 3414 and a location management server 3422 are provided instead of the routers 312 and 314 and the location management server 322, and parts other than the above points are the same as with the communication system 300. Parts illustrated which are the same as or equivalent to those in the communication system 300 illustrated in FIG. 3 are denoted with the same reference numerals. The operations and functions of the parts denoted by the same reference numerals in FIG. 34 are the same as described with reference to FIG. 3, so detailed description will be omitted.

In FIG. 34, the router 3412 has an interface coupled to the communication device 304 via the LAN 308, and two interfaces coupled to the network 316. The router 3412 includes a storage device holding the locator list 332. The router 3412 is a relay device which relays packet communication between the communication device 304 and the network 316, and operates based on the above-described LISP.

Upon receiving a MAC address resolution request from a communication device belonging to the corresponding LAN 308, the router 3412 transmits a locator resolution request to the location management server 3422. The transmitted locator resolution request includes, in addition to the destination IP address included in the received MAC address resolution request, the IP address of the interface of the source of the router 3412 (source locator). The router 3412 references the locator list 332 so as to acquire information of the locator corresponding to the interface of which is the source of the locator resolution request.

Subsequently, the router 3412 receives a locator resolution response corresponding to the locator resolution request, from the location management server 3422. The received locator resolution response includes a MAC address resolution response transmission flag, in addition to the destination locator. A MAC address resolution response transmission flag is a flag which instructs the router which has transmitted the locator resolution request whether or not the above-described Proxy MAC address response processing will be executed.

In the event that the MAC address resolution response transmission flag included in the received locator resolution response instructs execution of Proxy MAC address response processing, the router 3412 performs Proxy MAC address response processing as to the source communication device of the MAC address resolution request, by a MAC address resolution response including the MAC address of its own interface.

The router 3414 has an interface coupled to the communication device 306 via the LAN 310, and an interface coupled to the network 316. The router 3414 includes a storage device holding the locator list 334. The router 3414 is a relay device which relays packet communication between the communication device 306 and the network 316, and operates based on the above-described LISP.

In the same way as with the router 3412, in the event that the MAC address resolution response transmission flag included in the received locator resolution response instructs execution of Proxy MAC address response processing, the router 3414 performs Proxy MAC address response processing as to the source communication device of the MAC address resolution request, by a MAC address resolution response including the MAC address of its own interface.

The location management server 3422 receives locator resolution requests including source locators, in addition destination IP addresses, from the routers coupled to the network 316. The location management server 3422 searches the IP address/router ID map 326, and thereby acquires router IDs correlated with the destination IP addresses included in the received locator resolution requests (destination router IDs). Also, the location management server 3422 searches the router ID/locator map 328, thereby acquiring router IDs correlated with source locators included in the received locator resolution requests (source router IDs).

The location management server 3422 then checks whether or not the acquired destination router ID and source router ID match. In the event that the acquired destination router ID and source router ID do not match, the location management server 3422 sets the MAC address resolution response transmission flag to instruct execution of the Proxy MAC address response processing. On the other hand, in the event that the acquired destination router ID and source router ID match, the location management server 3422 sets the MAC address resolution response transmission flag to not instruct execution of the Proxy MAC address response processing.

The location management server 3422 then transmits the response message (locator resolution response) including the MAC address resolution response transmission flag which has been set, to the source router of the locator resolution request.

### 8-2. Communication Control Method with Communication System 3400

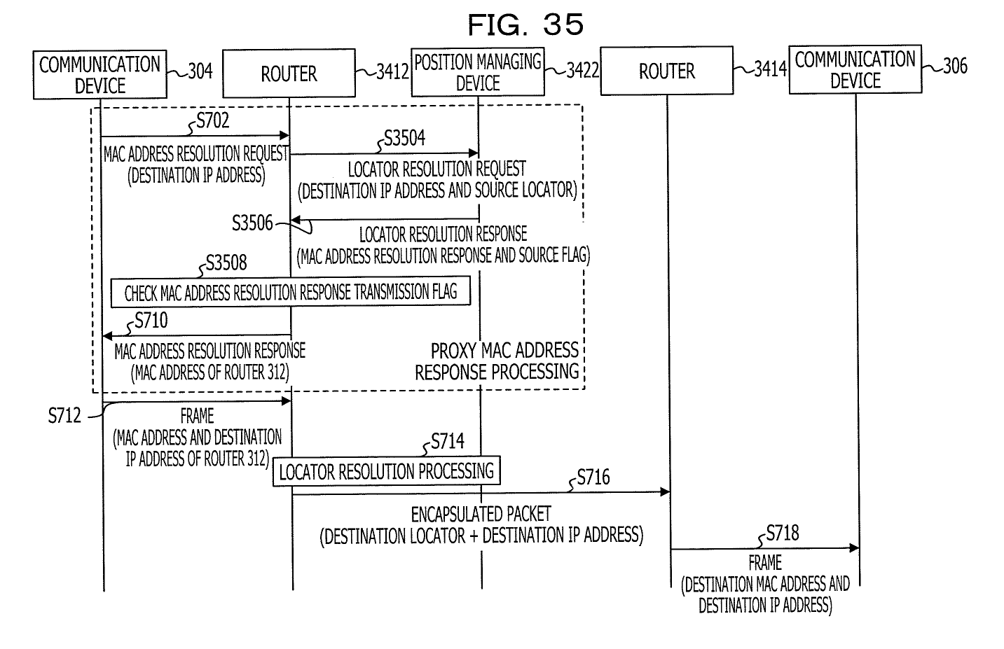

FIG. 35 is a sequence chart for describing a communication control method with the communication system 3400. Hereinafter, description will be made referencing FIG. 34 in addition to FIG. 35, regarding a communication control method with the communication system 3400 in a case of transmitting packets from the interface of the communication device 304 to the interface of the communication device 306 belonging to the same logical network.

The communication control method illustrated in FIG. 35 differs from the communication control method illustrated in FIG. 7 with regard to the point that processing of steps S3504 through S3508 are performed instead of the processing of steps S704 through S708, but processing other than these steps is the same as the communication control method illustrated in FIG. 7. Portions which are the same as or equivalent to those in the communication control method illustrated in FIG. 7 are denoted with the same reference numerals. The operations and functions of the portions denoted by the same reference numerals in FIG. 35 are the same as described with reference to FIG. 7, so detailed description will be omitted.

As illustrated in FIG. 35, in step S3504, upon having received a MAC address resolution request from the communication device 304, the router 3412 transmits the locator resolution request to the location management server 3422. The locator resolution request includes the destination IP address of the received MAC address resolution request, and the IP address of the interface of the source of the router 3412 (source locator). The router 3412 references the locator list 332 so as to acquire information of the locator corresponding with the interface which is the source of the locator resolution request. With the example illustrated in FIGS. 34 and 35, the transmitted locator resolution request includes “192.168.2.2” as the destination IP address, and includes “10.1.1.1” or “10.1.2.1” as the source locator.

Next, in step S3506, the location management server 3422 receives the locator resolution request from the router 3412. The location management server 3422 searches the IP address/router ID map 326 based on the destination IP address included in the received locator resolution request, thereby acquiring the router ID correlated with that destination IP address (destination router ID). With the example illustrated in FIGS. 34 and 35, the destination IP address is “192.168.2.2”, and according to the map illustrated in FIG. 5A the acquired destination router ID is “R2”.

The location management server 3422 searches the router ID/locator map 328 based on the source locator included in the received locator resolution request, and thereby acquires the router ID correlated with that source locator (source router ID). With the example illustrated in FIGS. 34 and 35, the source locator is “10.1.1.1” or “10.1.2.1”, and according to the map illustrated in FIG. 6 the acquired destination router ID is “R1”.

The location management server 3422 then checks whether or not the acquired destination router ID and source router ID match. In the event that the acquired destination router ID and source router ID do not match, the location management server 3422 recognizes that the interface of the communication device 306 having the destination IP address does not belong to the LAN 308 beneath the router 3412 which is the source of the locator resolution request. In the event that the acquired destination router ID and source router ID do not match, the location management server 3422 sets the MAC address resolution response transmission flag to instruct execution of the Proxy MAC address response processing.

On the other hand, in the event that the acquired destination router ID and source router ID match, the location management server 3422 recognizes that the interface of the communication device 306 having the destination IP address belongs to the LAN 308 beneath the router 3412 which is the source of the locator resolution request, and accordingly sets the MAC address resolution response transmission flag to not instruct execution of the Proxy MAC address response processing.

With the example illustrated in FIGS. 34 and 35, the destination router ID is “R2” and the source router ID is “R1”, so the destination router ID and source router ID do not match. Accordingly, the MAC address resolution response transmission flag is set to instruct execution of the Proxy MAC address response processing.

The location management server 3422 transmits a locator resolution response including the MAC address resolution response transmission flag which has been set, to the router 3412.

Next, in step S3508, the router 3412 receives a locator resolution response from the location management server 3422, and recognizes whether or not the MAC address resolution response transmission flag included in the received locator resolution response instructs execution of Proxy MAC address response processing. With the example illustrated in FIGS. 34 and 35, the router 3412 checks that the MAC address resolution response transmission flag instructs execution of the Proxy MAC address response processing, and thus recognizes that the interface of the communication device 306 having the destination IP address does not belong to the LAN 308.

Next, in response to the MAC address resolution response transmission flag instructing execution of the Proxy MAC address response processing, in step S710 the router 3412 performs Proxy MAC address response processing as to the communication device 304 which has transmitted the MAC address resolution request, by a MAC address resolution response including the MAC address of its own interface.

As described above, even in a case where packet communication is performed between communication devices belonging to different LANs with a communication system where one logical network is configured of multiple LANs, with the communication system 3400, the router 3412 to which the communication device 304 which has transmitted a MAC address resolution request is coupled executes Proxy MAC address response processing as to the communication device 304 under instruction of the location management server 3422, so packet communication may be executed in a normal manner.

Also, with the communication system 3400, the location management server 3422 determines whether or not for the router 3412 to execute Proxy MAC address response processing, using maps (location information) 326 and 328 indicating the relation between IP addresses and locators, which the location management server 3422 holds. Accordingly, a database relating to location of communication devices to perform communication does not have to be newly constructed, thereby avoiding location information of communication devices held in the overall network from becoming redundant, and enabling storage device resources such as memory to be effectively used. Also, whether or not Proxy MAC address response processing is to be executed is centrally determined at the location management server 3422, so the load of processing on the servers coupled to the network 316 may be alleviated.

### 8-3. Configuration of Router 3412 (3414)

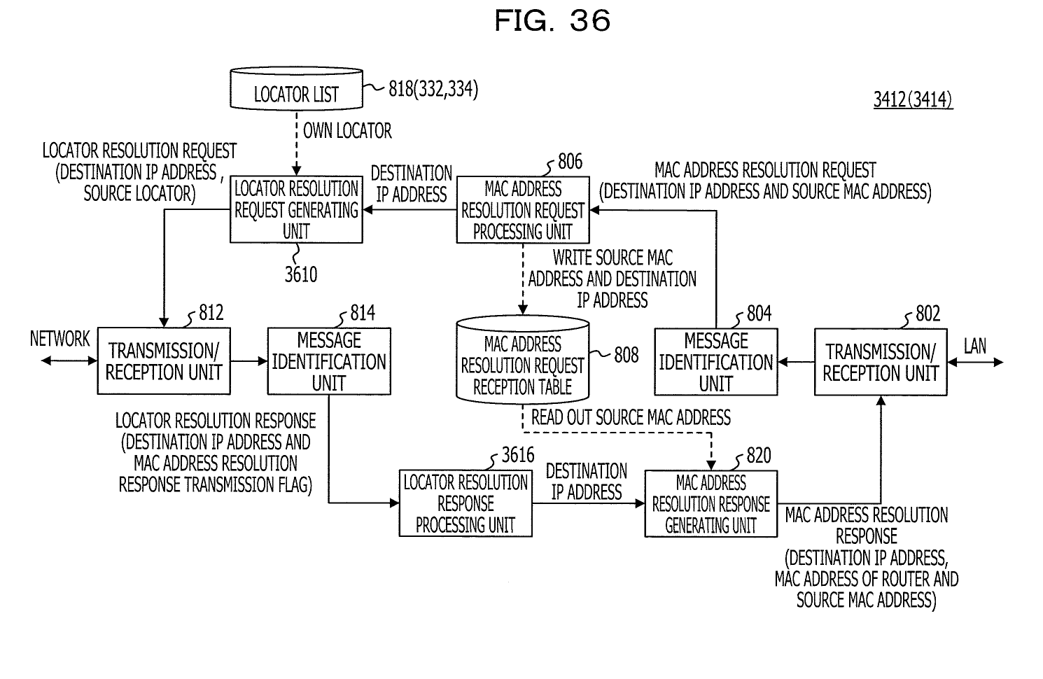

FIG. 36 is a diagram illustrating the configuration of the router 3412 (3414) according to the seventh embodiment.

The router 3412 (3414) illustrated in FIG. 36 differs from the router 312 (314) illustrated in FIG. 8 with regard to the points that a locator resolution request generating unit 3610 and a locator resolution response processing unit 3616 are provided instead of the locator resolution request generating unit 810 and locator resolution response processing unit 816, but is the same as the router 312 (314) other than the above points. Parts which are the same as or equivalent to those in the router 312 (314) illustrated in FIG. 8 are denoted with the same reference numerals. The operations and functions of the parts denoted by the same reference numerals in FIG. 36 are the same as described with reference to FIG. 8, so detailed description will be omitted.

With the functional block illustrated in FIG. 36, the portions corresponding to the functions of the router 3412 (3414) relating to the Proxy MAC address response processing described with reference to FIG. 35 are illustrated, and description of portions corresponding to other functions is omitted from the Present Specification, since arrangements according to the related art may be used. Also, while the configuration of the router 3412 will be described, the router 3412 and 3414 have mutually equivalent configurations in the communication system 3400.

The locator resolution request generating unit 3610 receives a destination IP address from the MAC address resolution request processing unit 806. Also, the locator resolution request generating unit 3610 references the locator list 818, thereby acquiring information of the IP address of the interface serving as the source of the locator resolution request (source locator). Based on the received destination IP address and acquired source locator, the locator resolution request generating unit 3610 generates a locator resolution request including this destination IP address and source locator. The locator resolution request generating unit 3610 outputs the generated locator resolution request to the transmission/reception unit 812. Note that the locator list 818 is the same as the locator list 332 (334) illustrated in FIG. 34.

The locator resolution response processing unit 3616 receives a locator resolution response from the message identification unit 814. the locator resolution response includes, in addition to the destination IP address, a MAC address resolution response transmission flag to instruct whether or not to execute Proxy MAC address response processing.

In the event that the MAC address resolution response transmission flag included in the received locator resolution response instructs execution of the Proxy MAC address response processing, the locator resolution response processing unit 3616 notifies the MAC address resolution response generating unit 820 to that effect, and also outputs the destination IP address included in the received locator resolution response to the MAC address resolution response generating unit 820.

Note that the hardware configuration of the router 3412 (3414) is the same as the hardware configuration of the router 312 (314) illustrated in FIG. 9. The functions of the functional blocks of the router 3412 (3414) may be realized by the same hardware configuration as the hardware configuration of the router 312 (314) illustrated in FIG. 9. Accordingly, detailed description will be omitted.

As described above, even in a case where packet communication is performed between communication devices belonging to different LANs with a communication system where one logical network is configured of multiple LANs, the router 3412 to which the communication device 304 which has transmitted a MAC address resolution request is coupled executes Proxy MAC address response processing as to the communication device 304, based on instruction from the location management server 3422, so packet communication may be executed in a normal manner.

### 8-4. Configuration of Location Management Server 3422

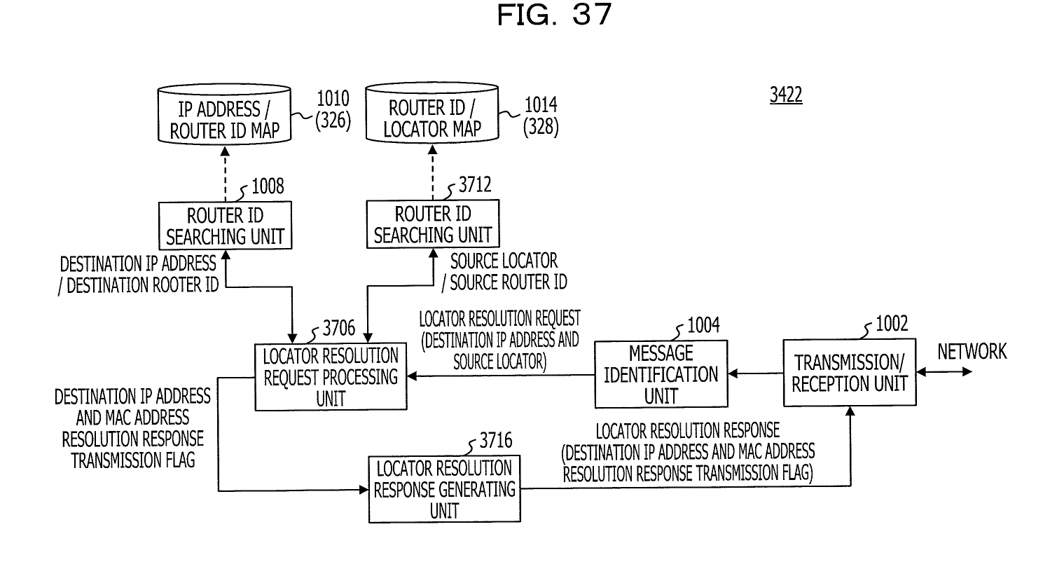

FIG. 37 is a functional block diagram illustrating the configuration of the location management server 3422 according to the seventh embodiment.

The location management server 3422 illustrated in FIG. 37 differs from the location management server 322 illustrated in FIG. 10 with regard to the point that a locator resolution request processing unit 3706, router ID searching unit 3712, and locator resolution response generating unit 3716 are provided instead of the locator resolution request processing unit 1006, locator searching unit 1012, and locator resolution response generating unit 1016, but other parts are the same. Parts which are the same as or equivalent to those in the location management server 322 illustrated in FIG. 10 are denoted with the same reference numerals. The operations and functions of the parts denoted by the same reference numerals in FIG. 37 are the same as described with reference to FIG. 10, so detailed description will be omitted.

With the functional block diagram illustrated in FIG. 37, in the same way as with the functional block diagram illustrated in FIG. 10 portions of the location management server 3422 which correspond to functions relating to the Proxy MAC address response processing and locator resolution processing described with reference to FIG. 35 are illustrated, and description of portions corresponding to other functions is omitted from the Present Specification, since arrangements according to the related art may be used.

The locator resolution request processing unit 3706 receives a locator resolution request from the message identification unit 1004. The received locator resolution request includes, in addition to the destination IP address, the IP address of the interface serving as the source of the locator resolution request (source locator).

The locator resolution request processing unit 3706 notifies information of the destination IP address included in the received locator resolution request to the router ID searching unit 1008. The router ID searching unit 1008 receives information of the destination IP address from the locator resolution request processing unit 3706, and searches the IP address/router ID map 1010 based on the received destination IP address, thereby acquiring the router ID correlated with that destination IP address (destination router ID). The router ID searching unit 1008 notifies the information of the destination router ID that has been acquired to the locator resolution request processing unit 3706. Note that the IP address/router ID map 1010 is the same as the IP address/router ID map 326 illustrated in FIG. 34.

Also, the locator resolution request processing unit 3706 notifies the information of the source locator included in the received locator resolution request to the router ID searching unit 3712. The router ID searching unit 3712 receives the information of the source locator from the locator resolution request processing unit 3706, and searches the router ID/locator map 1014 based on the received source locator, thereby acquiring the router IP correlated with that source locator (source router ID). The router ID searching unit 3712 notifies the information of the acquired source router ID to the locator resolution request processing unit 3706. Note that the IP address/router ID map 1014 is the same as the IP address/router ID map 328 illustrated in FIG. 34.

The locator resolution request processing unit 3706 then checks whether or not the notified destination router ID and source router ID match. In the event that the notified destination router ID and source router ID do not match, the locator resolution request processing unit 3706 sets the MAC address resolution response transmission flag to instruct execution of the Proxy MAC address response processing. On the other hand, in the event that the destination router ID and source router ID match, the locator resolution request processing unit 3706 sets the MAC address resolution response transmission flag to not instruct execution of the Proxy MAC address response processing.

In addition to the destination IP address, the locator resolution request processing unit 3706 notifies the information of the MAC address resolution response transmission flag which has been set, to the locator resolution response generating unit 3716.

The locator resolution response generating unit 3716 receives the information of the destination IP address and MAC address resolution response transmission flag from the locator resolution request processing unit 3706, and generates a locator resolution response including the received destination IP address and MAC address resolution response transmission flag. The locator resolution response generating unit 3716 outputs the generated locator resolution response to the transmission/reception unit 1002.

Note that the hardware configuration of the location management server 3422 is the same as the hardware configuration of the location management server 322 illustrated in FIG. 11. The functions of the functional blocks of the location management server 3422 may be realized with the same hardware configuration of the location management server 322 illustrated in FIG. 11. Accordingly, detailed description will be omitted.

As described above, with the communication system 3400, the location management server 3422 operating based on LISP decides whether or not for the router 3412 to execute Proxy MAC address response processing, using the maps (location information) 326 and 328, indicating the relation between IP addresses and locators, which the location management server 3422 itself holds. Accordingly, a database relating to location of communication devices to perform communication does not have to be newly constructed, thereby avoiding location information of communication devices held in the overall network from becoming redundant, and enabling storage device resources such as memory to be effectively used. Also, determination of whether or not for the location management server 3422 to execute the Proxy MAC address response processing is centrally made, so the load of processing at the servers coupled to the network 316 may be alleviated.

### 9. Eighth Embodiment

The following is a description of the communication system, communication control method, relay device, and information processing device according to an eighth embodiment.

### 9-1. Configuration of Communication System 3800

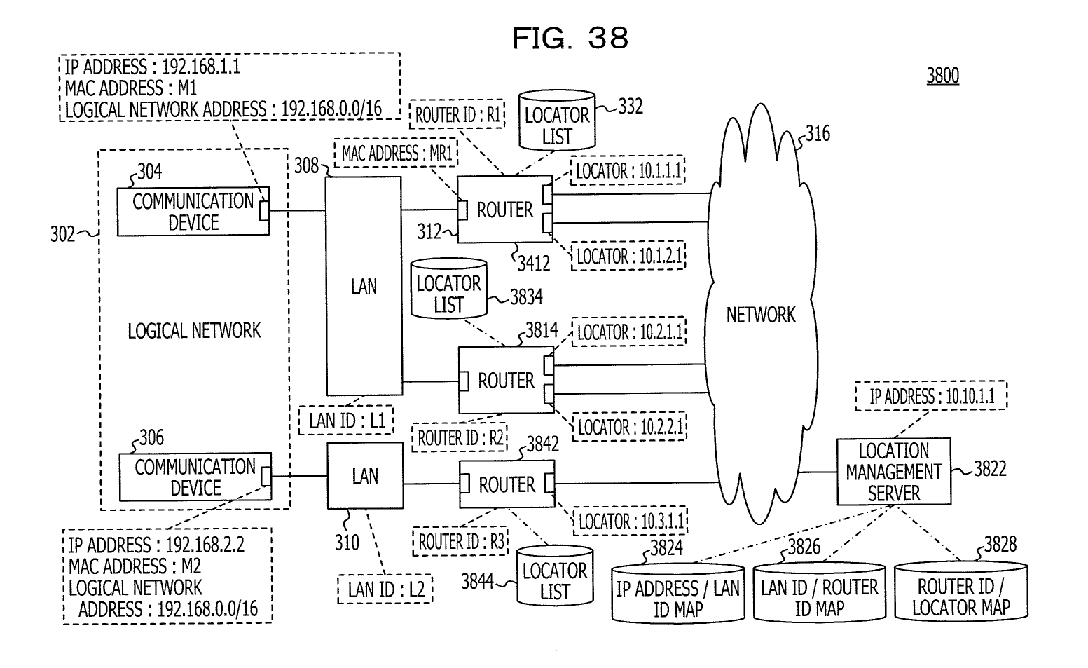

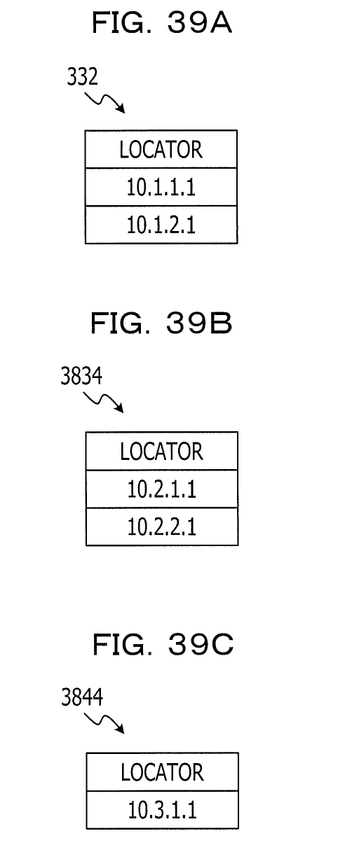

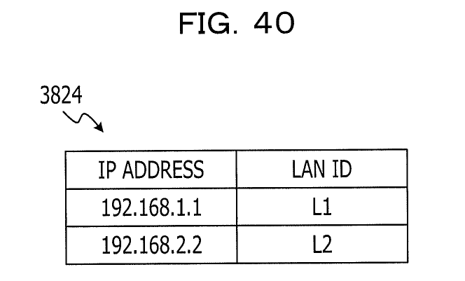

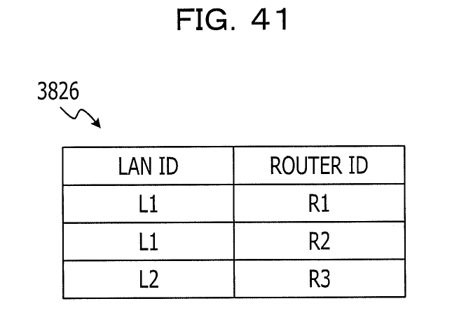

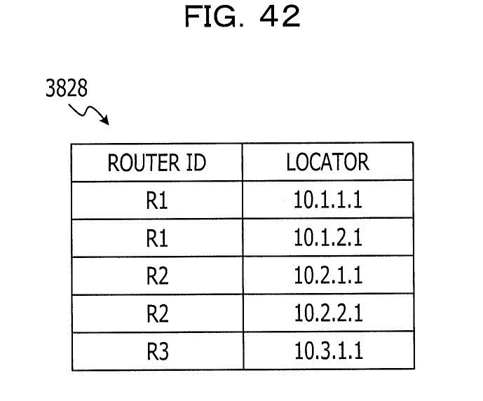

FIG. 38 is a diagram illustrating the configuration of a communication system 3800 according to an eighth embodiment, FIGS. 39A through 39C are diagrams illustrating examples of locator lists 332, 3834, and 3844, FIG. 40 is a diagram illustrating an example of an IP address/LAN ID map 3824, FIG. 41 is a diagram illustrating an example of a LAN ID/router ID map 3826, and FIG. 42 is a diagram illustrating an example of a router ID/locator map 3828.

The communication system 3800 illustrated in FIG. 38 differs from the communication system 3400 illustrated in FIG. 34 with regard to the points that a router 3814, locator list 3834, router 3842, and locator list 3834 are provided instead of the router 3414 and the locator list 334. The communication system 3800 differs from the communication system 3400 with regard to the points that a location management server 3822 is provided instead of the location management server 3422, and that an IP address/LAN ID map 3824, a LAN ID/router ID map 3826, and a router ID/locator map 3828 are provided instead of the IP address/router ID map 326 and router ID/locator map 328.

Parts of the communication system 3800 other than the above points are the same as with the communication system 300. Parts illustrated which are the same as or equivalent to those in the communication system 300 illustrated in FIG. 3 are denoted with the same reference numerals. The operations and functions of the parts denoted by the same reference numerals in FIG. 38 are the same as described with reference to FIG. 3, so detailed description will be omitted.

In FIG. 38, the router 3814 has an interface coupled to the communication device 304 via the LAN 308, and two interfaces coupled to the network 316. The router 3814 includes a storage device holding the locator list 3834. The router 3814 is a relay device which relays packet communication between the communication device 304 and the network 316, and operates based on the above-described LISP.

The locator list 3834 is a list indicating locators assigned to the router 3814. AS illustrated in FIG. 39B, the locator list 3834 includes two locators. That is to say, two locators (10.2.1.1 and 10.2.2.1) are assigned to the router 3814.

Upon receiving a MAC address resolution request from a communication device belonging to the corresponding LAN 308, the router 3814 transmits a locator resolution request to the location management server 3822. The transmitted locator resolution request includes, in addition to the destination IP address included in the received MAC address resolution request, the IP address of the interface of the source of the router 3814 (source locator). The router 3814 references the locator list 3834 so as to acquire information of the locator corresponding to the interface of which is the source of the locator resolution request.

Subsequently, the router 3814 receives a locator resolution response corresponding to the locator resolution request from the location management server 3822. The received locator resolution response includes a MAC address resolution response transmission flag, in addition to the destination locator. A MAC address resolution response transmission flag is a flag which instructs the router which has transmitted the locator resolution request whether or not the above-described Proxy MAC address response processing will be executed.

In the event that the MAC address resolution response transmission flag included in the received locator resolution response instructs execution of Proxy MAC address response processing, the router 3814 performs Proxy MAC address response processing as to the source communication device of the MAC address resolution request, by a MAC address resolution response including the MAC address of its own interface.

The router 3842 has an interface coupled to the communication device 306 via the LAN 310, and an interface coupled to the network 316. The router 3842 includes a storage device holding the locator list 3844. The router 3842 is a relay device which relays communication between the communication device 306 and the network 316, and operates based on the above-described LISP.

The locator list 3844 is a list indicating a locator assigned to the router 3842. As illustrated in FIG. 39C, the locator list 3844 includes one locator. That is to say, one locator (10.3.1.1) is assigned to the router 3842.

In the same way as with the router 3814, the router 3842 transmits a locator resolution request including the IP address of the source interface of the router 3842 (source locator), in addition to the destination IP address included in the received MAC address resolution request, to the location management server 3822.

In the same way as with the router 3814, in the event that the MAC address resolution response transmission flag included in the received locator resolution response instructs execution of Proxy MAC address response processing, the router 3842 performs Proxy MAC address response processing as to the source communication device of the MAC address resolution request, by a MAC address resolution response including the MAC address of its own interface.

The location management server 3822 Is coupled to the network 316, and is an information processing device which operates based on the above-described LISP. The location management server 3822 includes a storage device holding the IP address/LAN ID map 3824, a storage device holding the LAN ID/router ID map 3826, and a storage device holding the router ID/locator map 3828. Note that the IP address/LAN ID map 3824, LAN ID/router ID map 3826, and router ID/locator map 3828 may be held in a single storage device.

The IP address/LAN ID map 3824 is a table representing the relation between the IP addresses of the interfaces of the communication devices coupled to the network 316, and the identification information of the corresponding LANs (LAN ID). As illustrated in FIG. 40, the IP address “192.168.1.1” of the interface of the communication device 304 and the LAN ID “L1” of the LAN 308 are correlated, and the IP address “192.168.2.2” of the interface of the communication device 306 and the LAN ID “L2” of the LAN 310 are correlated. That is to say, two different LANs 308 and 310 are correlated as to the interfaces of the two communication device 304 and 306 belonging to the same logical network 302.

The LAN ID/router ID map 3826 is a table indicating the relation between the identification information of each LAN (LAN ID) and the identification information of the routers coupled to the LANs (router ID). As illustrated in FIG. 41, the LAN ID “L1” of the LAN 308 and the router ID “R1” of the router 312 are correlated, and the LAN ID “L2” of the LAN 310 and the router IDs “R2” and “R3” of the two routers 3814 and 3842 coupled to the network 316 are correlated. That is to say, with the LAN 310, two different routers 3814 and 3842 are correlated to a single LAN.

The router ID/locator map 3828 is a table indicating the relation between the identification information of each router coupled to the network 316 (router ID) and corresponding locators. As illustrated in FIG. 42, the router ID “R1” of the router 3412 and the two locators “10.1.1.1” and “10.1.2.1” of the router 3412 are correlated, the router ID “R2” of the router 3814 and the two locators “10.2.1.1” and “10.2.2.1” of the router 3414 are correlated, and the router ID “R3” of the router 3842 and the one locator “10.3.1.1” of the router 3842 are correlated. That is to say, with the routers 3412 and 3814, two locators are correlated to one router ID.

The location management server 3822 receives locator resolution requests including source locators, in addition destination IP addresses, from the routers coupled to the network 316. The location management server 3822 searches the IP address/LAN ID map 3824, and thereby acquires LAN IDs (destination LAN IDs) correlated to destination IP addresses included in the received locator resolution requests.

Also, the location management server 3822 searches the router ID/locator map 3828, thereby acquiring router IDs correlated with source locators included in the received locator resolution requests (source router IDs). Further, the location management server 3822 searches the LAN ID/router ID map 3826, and thereby acquires LAN IDs correlated with the acquired source router IDs (source LAN IDs).

The location management server 3822 then checks whether or not the acquired destination LAN ID and source LAN ID match. In the event that the acquired destination LAN ID and source LAN ID do not match, the location management server 3822 sets the MAC address resolution response transmission flag to instruct execution of the Proxy MAC address response processing. On the other hand, in the event that the acquired destination LAN ID and source LAN ID match, the location management server 3822 sets the MAC address resolution response transmission flag not to instruct execution of the Proxy MAC address response processing.

The location management server 3822 then transmits the response message (locator resolution response) including the MAC address resolution response transmission flag which has been set, to the source router of the locator resolution request.

As described above, with the communication system 3800, two routers 3412 and 3814 are coupled to the single LAN 308. In this case, one router does not recognize the locator information of the other router (contents of the locator list), so even in the event that the location management server 3822 transmits a locator resolution request including the information of the destination locator to the routers 3412 and 3814, as with the case of the communication system 300 illustrated in FIG. 3 for example, these routers 3412 and 3814 will not accurately recognize whether the interface of the communication device having the destination IP address belong to the LAN 308 beneath them, if the only information they are given is the received destination locator.

Accordingly, in a case where multiple routers 3414 and 3814 are coupled to the LAN 308 to which the communication device 304 which has transmitted the MAC address resolution request belongs, the location management server 3822 checks whether the destination LAN ID and source LAN ID match as described above, thereby checking whether or not the interface of the communication device having the destination IP address belongs to the LAN beneath the router which is the source of the locator resolution request.

Note that in the event of having received a locator resolution request having the same destination IP address from multiple different routers (in the example illustrated in FIG. 38, the routers 3412 and 3814), the location management server 3822 transmits a locator resolution response including the MAC address resolution response transmission flag set to instruct execution of the Proxy MAC address response processing, to only one of the locator resolution requests.

For example, the location management server 3822 transmits a locator resolution response including the MAC address resolution response transmission flag set to instruct execution of the Proxy MAC address response processing only to the locator resolution request received at the earliest timing, and for locator resolution requests having the same destination IP address received thereafter, transmits a locator resolution response including the MAC address resolution response transmission flag set to not instruct execution of the Proxy MAC address response processing.

### 9-2. Communication Control Method with Communication System 3800

The communication control method with the communication system 3800 differs from the communication control method of the communication system 3400 illustrated in FIG. 35 with regard to the MAC address resolution response transmission flag setting processing executed in step S3506 and the locator acquisition processing executed in step S714, but other parts are the same.

The MAC address resolution response transmission flag setting processing according to the communication system 3800 differs from the MAC address resolution response transmission flag setting processing according to the communication system 3400 in that the three tables of the IP address/LAN ID map 3824, LAN ID/router ID map 3826, and router ID/locator map 3828 are used instead of the two tables of the IP address/router ID map 326 and router ID/locator map 328, but other parts are the same.

In step S3506, unlike the location management server 3422, the location management server 3822 searches the IP address/LAN ID map 3824 so as to acquire a LAN ID correlated with the destination IP address included in the received locator resolution request (destination LAN ID). With the example illustrated in FIGS. 35 and 38, the destination IP address is “192.168.2.2”, and according to the map illustrated in FIG. 40, the acquired LAN ID is “L2”.

Further, the location management server 3822 searches the router ID/locator map 3828 so as to acquire the router ID correlated with the source locator included in the received locator resolution request (source router ID). With the example illustrated in FIGS. 35 and 38, the source locator is “10.0.1.1” or “10.1.2.1”, and according to the map illustrated in FIG. 42, the acquired router ID is “R1”.

Further, the location management server 3822 searches the LAN ID/router ID map 3826, so as to acquire the LAN ID correlated with the acquired source router ID (source LAN ID). With the example illustrated in FIGS. 35 and 38, the source router ID is “R1”, and according to the map illustrated in FIG. 41, the acquired LAN ID is “L1”.

The location management server 3822 then checks whether to the acquired destination LAN ID and source LAN ID match. In the event that the acquired destination LAN ID and source LAN ID do not match, the location management server 3822 recognizes that the interface of the communication device 306 having the destination IP address does not belong to the LAN 308 beneath the router 3412 which is the source of the locator resolution request. In the event that the acquired destination LAN ID and source LAN ID do not match, the location management server 3822 sets the MAC address resolution response transmission flag to instruct execution of the Proxy MAC address response processing.

On the other hand, in the event that the acquired destination LAN ID and source LAN ID match, the location management server 3822 recognizes that the interface of the communication device 306 having the destination IP address belongs to the LAN 308 beneath the router 3412 which is the source of the locator resolution request, and sets the MAC address resolution response transmission flag to not instruct execution of the Proxy MAC address response processing.

With the example illustrated in FIGS. 35 and 38, the destination LAN ID is “L2” and the source LAN ID is “L1”, so the destination LAN ID and source LAN ID do not match. Accordingly, the MAC address resolution response transmission flag is set to instruct execution of the Proxy MAC address response processing.

The location management server 3822 transmits a locator resolution response including the MAC address resolution response transmission flag which has been set, to the router 3412.

In step S3508, the router 3412 receives the locator resolution response from the location management server 3822, and checks whether or not the MAC address resolution response transmission flag included in the received locator resolution response instructs execution of the Proxy MAC address response processing. In response to the MAC address resolution response transmission flag included in the received locator resolution response instructing execution of the Proxy MAC address response processing, in step S710 the router 3412 performs Proxy MAC address response processing as to the communication device 304 which has transmitted the MAC address resolution request, by MAC address resolution response including the MAC address of its own interface.

On the other hand, the locator acquisition processing with the communication system 3800 differs from the locator acquisition processing with the communication system 3400 regarding the point that the three tables of the IP address/LAN ID map 3824, LAN ID/router ID map 3826, and router ID/locator map 3828 are used instead of the IP address/router ID map 326 and router ID/locator map 328, but other points are the same. The locator acquisition processing with the communication system 3800 is the same as the locator acquisition processing with the communication system 1500, so detailed description will be omitted.

As described above, even in a case where packet communication is performed between communication devices belonging to different LANs with a communication system where one logical network is configured of multiple LANs, with the communication system 3800, the router 3412 to which the communication device 304 which has transmitted a MAC address resolution request is coupled executes Proxy MAC address response processing as to the communication device 304 based on instruction from the location management server 3822, so packet communication may be executed in a normal manner.

Also, with the communication system 3800, the location management server 3822 operating based on LISP decides whether or not for the router 3412 to execute Proxy MAC address response processing, using the maps (location information) 3824, 3826, and 3828, indicating the relation between IP addresses and locators, which the location management server 3822 itself holds. Accordingly, a database relating to location of communication devices to perform communication does not have to be newly constructed, thereby avoiding location information of communication devices held in the overall network from becoming redundant, and enabling storage device resources such as memory to be effectively used.

Also, whether or not Proxy MAC address response processing is to be executed is centrally determined at the location management server 3822, so the load of processing on the servers coupled to the network 316 may be alleviated. Further, even in a case where multiple routers 3412 and 3814 are coupled to the LAN 308 to which the communication device 304 which has transmitted the MAC address resolution request belongs, whether or not to execute Proxy MAC address response processing may be appropriately determined and instructed for each router.

### 9-3. Configuration of Router 3412 (3814, 3842)

The configurations of the routers 3412, 3814, and 3842 in the communication system 3800 are the same as the configurations of the routers 3412 and 3414 in the communication system 3400. Accordingly, detailed description will be omitted.

### 9-4. Configuration of Location Management Server 3822

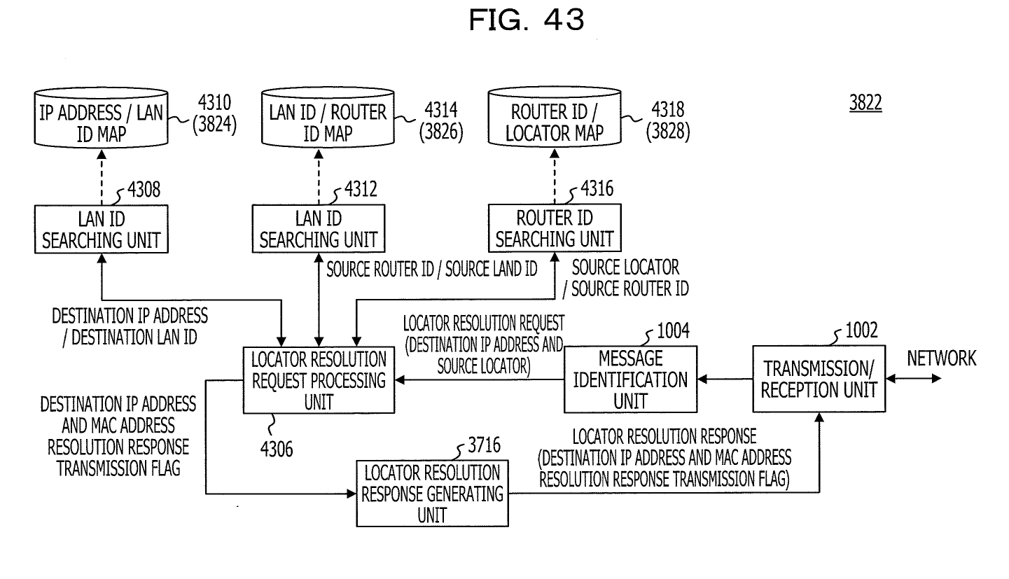

FIG. 43 is a functional block diagram illustrating the configuration of the location management server 3822 according to the eighth embodiment.

The location management server 3822 illustrated in FIG. 43 differs from the location management server 3422 illustrated in FIG. 37 with regard to the points that a locator resolution request processing unit 4306 is provided instead of the location management server 3422 and locator resolution request processing unit 3706, and that a LAN ID searching unit 4308, an IP address/LAN ID map 4310, a LAN ID searching unit 4312, a LAN ID/router ID map 4314, a router ID searching unit 4316, and a router ID/locator map 4318 are provided instead of the router ID searching unit 1008, IP address/router ID map 1010, router ID searching unit 3712, and router ID/locator map 1014, but other parts are the same. Parts which are the same as or equivalent to those in the location management server 3422 illustrated in FIG. 37 are denoted with the same reference numerals. The operations and functions of the parts denoted by the same reference numerals in FIG. 43 are the same as described with reference to FIG. 37, so detailed description will be omitted.

With the functional block diagram illustrated in FIG. 43, in the same way as with the functional block diagram illustrated in FIG. 37 portions of the location management server 3822 which correspond to functions relating to the Proxy MAC address response processing and locator resolution processing described with reference to FIG. 35 are illustrated, and description of portions corresponding to other functions is omitted from the Present Specification, since arrangements according to the related art may be used.

The locator resolution request processing unit 4306 receives a locator resolution request from the message identification unit 1004. The received locator resolution request includes, in addition to the destination IP address, the IP address of the interface serving as the source of the locator resolution request (source locator).

The locator resolution request processing unit 4306 notifies information of the destination IP address included in the received locator resolution request to the LAN ID searching unit 4308. The LAN ID searching unit 4308 receives information of the destination IP address from the locator resolution request processing unit 4306, and searches the IP address/LAN ID map 4310 based on the received destination IP address, thereby acquiring the LAN ID correlated with that destination IP address (destination LAN ID). The LAN ID searching unit 4308 notifies the information of the destination LAN ID that has been acquired to the locator resolution request processing unit 4306. Note that the IP address/LAN ID map 4310 is the same as the IP address/LAN ID map 3824 illustrated in FIG. 38.

The locator resolution request processing unit 4306 notifies information of the source locator included in the received locator resolution request to the router ID searching unit 4316. The router ID searching unit 4316 receives information of the source locator from the locator resolution request processing unit 4306, and searches the router ID/locator map 4318 based on the received source locator, thereby acquiring the router ID correlated with that destination locator (destination router ID). The router ID searching unit 4316 notifies the information of the destination router ID that has been acquired to the locator resolution request processing unit 4306. Note that the router ID/locator map 4318 is the same as the router ID/locator map 3828 illustrated in FIG. 38.

Further, the locator resolution request processing unit 4306 notifies the information of the notified source router ID to the LAN ID searching unit 4312. The LAN ID searching unit 4312 receives the information of the source router ID from the locator resolution request processing unit 4306, and searches the LAN ID/router ID map 4314 based on the received source router ID, thereby acquiring the LAN ID correlated with that source router ID (source LAN ID). The LAN ID searching unit 4312 notifies the information of the acquired source LAN ID to the locator resolution request processing unit 4306. Note that the LAN ID/router ID map 4314 is the same as the LAN ID/router ID map 3826 illustrated in FIG. 38.

The locator resolution request processing unit 4306 then checks whether or not the notified destination LAN ID and source LAN ID match. In the event that the notified destination LAN ID and source LAN ID do not match, the locator resolution request processing unit 4306 sets the MAC address resolution response transmission flag to instruct execution of the Proxy MAC address response processing. On the other hand, in the event that the destination router ID and source router ID match, the locator resolution request processing unit 3706 sets the MAC address resolution response transmission flag to not instruct execution of the Proxy MAC address response processing.

In addition to the destination IP address, the locator resolution request processing unit 4306 notifies the information of the MAC address resolution response transmission flag which has been set, to the locator resolution response generating unit 3716.

The locator resolution response generating unit 3716 receives the information of the destination IP address and MAC address resolution response transmission flag from the locator resolution request processing unit 4306, and generates a locator resolution response including the received destination IP address and MAC address resolution response transmission flag.

Note that in the event of having received multiple locator resolution requests having the same destination IP address but different source locators, the locator resolution request processing unit 4306 transmits a locator resolution response including the MAC address resolution response transmission flag set to instruct execution of the Proxy MAC address response processing, to only one of the locator resolution requests.

For example, the locator resolution request processing unit 4306 transmits a locator resolution response including the MAC address resolution response transmission flag set to instruct execution of the Proxy MAC address response processing only to the locator resolution request received at the earliest timing, and for locator resolution requests having the same destination IP address received thereafter, transmits a locator resolution response including the MAC address resolution response transmission flag set to not instruct execution of the Proxy MAC address response processing.

Also, the hardware configuration of the location management server 3822 is the same as the hardware configuration of the location management server 322 illustrated in FIG. 11. The functions of the functional blocks of the location management server 3822 may be realized with the same hardware configuration of the location management server 322 illustrated in FIG. 11. The IP address/LAN ID map 4310, LAN ID/router ID map 4314, and router ID/locator map 4318 illustrated in FIG. 43 are each stored in memory or a storage device. Accordingly, detailed description will be omitted.

As described above, with the communication system 3800, the location management server 3822 operating based on LISP decides whether or not the router 3412 will execute Proxy MAC address response processing, using the maps (location information) 3824, 3826, and 3828, indicating the relation between IP addresses and locators, which the location management server 3822 itself holds. Accordingly, a database relating to location of communication devices to perform communication does not have to be newly constructed, thereby avoiding location information of communication devices held in the overall network from becoming redundant, and enabling storage device resources such as memory to be effectively used.

Also, whether or not Proxy MAC address response processing is to be executed is centrally determined at the location management server 3822, so the load of processing on the servers coupled to the network 316 may be alleviated. Further, even in a case where multiple routers 3414 and 3814 are coupled to the LAN 308 to which the communication device 304 which has transmitted the MAC address resolution request belongs, whether or not to execute Proxy MAC address response processing may be appropriately determined and instructed for each router.

### 10. Ninth Embodiment

The following is a description of the communication system, communication control method, relay device, and information processing device according to a ninth embodiment.

### 10-1. Configuration of Communication System 4400

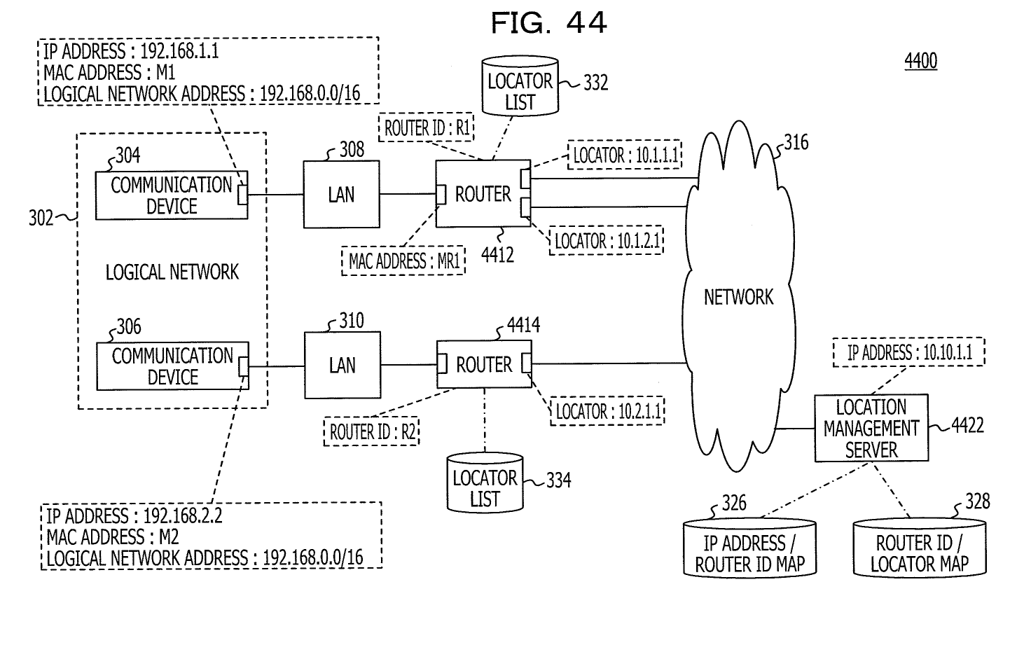

FIG. 44 is a diagram illustrating the configuration of a communication system 4400 according to a ninth embodiment.

The communication system 4400 illustrated in FIG. 44 differs from the communication system 300 illustrated in FIG. 3 with regard to the points that routers 4412 and 4414 and a location management server 4422 are provided instead of the routers 312 and 314 and the location management server 322, and parts other than the above points are the same as with the communication system 300. Parts illustrated which are the same as or equivalent to those in the communication system 300 illustrated in FIG. 3 are denoted with the same reference numerals. The operations and functions of the parts denoted by the same reference numerals in FIG. 44 are the same as described with reference to FIG. 3, so detailed description will be omitted.

In FIG. 44, the router 4412 has an interface coupled to the communication device 304 via the LAN 308, and two interfaces coupled to the network 316. The router 4412 includes a storage device holding the locator list 332. The router 4412 is a relay device which relays packet communication between the communication device 304 and the network 316, and operates based on the above-described LISP.

Upon receiving a MAC address resolution request from a communication device belonging to the corresponding LAN 308, the router 4412 transmits a locator resolution request to the location management server 4422. The transmitted locator resolution request includes, in addition to the destination IP address included in the received MAC address resolution request, the IP address of the interface of the source of the router 4412 (source locator). The router 4412 references the locator list 332 so as to acquire information of the locator corresponding to the interface of which is the source of the locator resolution request.

After having transmitted to the locator resolution request, the router 4412 checks whether or not a locator resolution response corresponding to the locator resolution request has been received from the location management server 4422. The received locator resolution response includes a destination locator.

Upon receiving the locator resolution response from the location management server 4422, the router 4412 performs Proxy MAC address response processing as to the source communication device of the MAC address resolution request, by a MAC address resolution response including the MAC address of its own interface.

The router 4414 has an interface coupled to the communication device 306 via the LAN 310, and an interface coupled to the network 316. The router 4414 includes a storage device holding the locator list 334. The router 4414 is a relay device which relays packet communication between the communication device 306 and the network 316, and operates based on the above-described LISP.

In the same way as with the router 4412, upon receiving a locator resolution response from the location management server 4422, the router 4414 performs Proxy MAC address response processing as to the source communication device of the MAC address resolution request, by MAC address resolution response including the Mac address of its own interface.

The location management server 4422 receives locator resolution requests including source locators, in addition destination IP addresses, from the routers coupled to the network 316. The location management server 4422 searches the IP address/router ID map 326, and thereby acquires router IDs correlated with the destination IP addresses included in the received locator resolution requests (destination router IDs). Also, the location management server 4422 searches the router ID/locator map 328, thereby acquiring router IDs correlated with source locators included in the received locator resolution requests (source router IDs).

The location management server 4422 then checks whether or not the acquired destination router ID and source router ID match. In the event that the acquired destination router ID and source router ID do not match, the location management server 4422 transmits a locator resolution response including the destination IP address to the source router of the locator resolution request. On the other hand, in the event that the acquired destination router ID and source router ID match, the location management server 4422 does not transmit a locator resolution response.

### 10-2. Communication Control Method with Communication System 4400

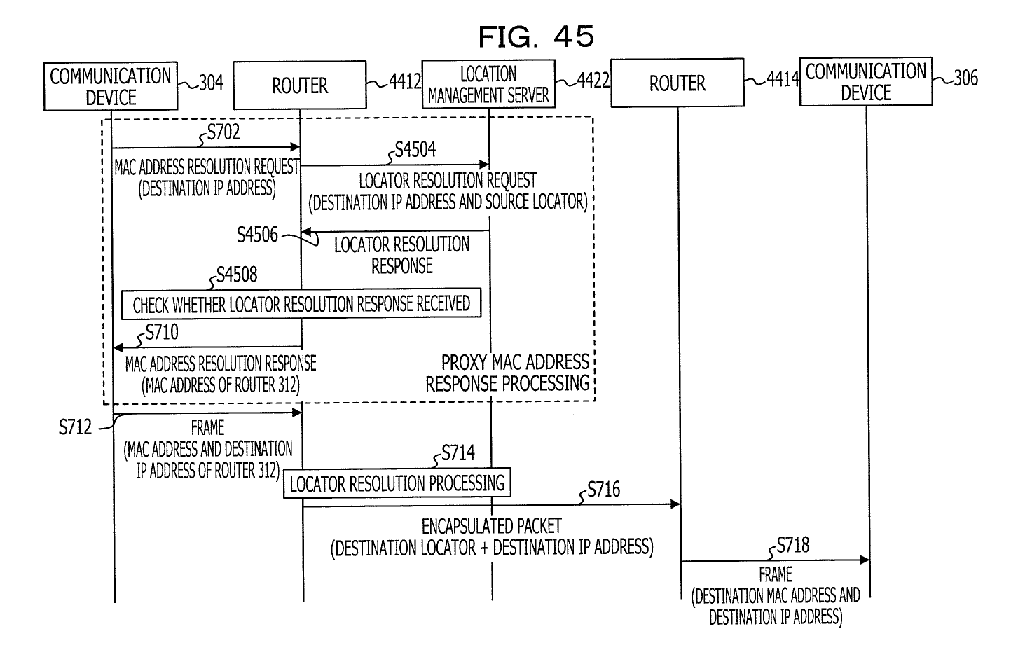

FIG. 45 is a sequence chart for describing a communication control method with the communication system 4400. Hereinafter, description will be made referencing FIG. 44 in addition to FIG. 45, regarding a communication control method with the communication system 3800 in a case of transmitting packets from the interface of the communication device 304 to the interface of the communication device 306 belonging to the same logical network.

The communication control method illustrated in FIG. 45 differs from the communication control method illustrated in FIG. 7 with regard to the point that processing of steps S4504 through S4508 are performed instead of the processing of steps S704 through S708, but processing other than these steps is the same as the communication control method illustrated in FIG. 7. Portions which are the same as or equivalent to those in the communication control method illustrated in FIG. 7 are denoted with the same reference numerals. The operations and functions of the portions denoted by the same reference numerals in FIG. 45 are the same as described with reference to FIG. 7, so detailed description will be omitted.

As illustrated in FIG. 45, in step S4504, upon having received a MAC address resolution request from the communication device 304, the router 4412 transmits the locator resolution request to the location management server 4422. The locator resolution request includes the destination IP address of the received MAC address resolution request, and the IP address of the interface of the source of the router 4412 (source locator). The router 4412 references the locator list 332 so as to acquire information of the locator corresponding with the interface which is the source of the locator resolution request. With the example illustrated in FIGS. 44 and 45, the transmitted locator resolution request includes “192.168.2.2” as the destination IP address, and includes “10.1.1.1” or “10.1.2.1” as the source locator.

Next, in step S4506, the location management server 4422 receives the locator resolution request from the router 4412. The location management server 4422 searches the IP address/router ID map 326 based on the destination IP address included in the received locator resolution request, thereby acquiring the router ID correlated with that destination IP address (destination router ID). With the example illustrated in FIGS. 44 and 45, the destination IP address is “192.168.2.2”, and according to the map illustrated in FIG. 5A the acquired destination router ID is “R2”.

The location management server 4422 searches the router ID/locator map 328 based on the source locator included in the received locator resolution request, and thereby acquires the router ID correlated with that source locator (source router ID). With the example illustrated in FIGS. 44 and 45, the source locator is “10.1.1.1” or “10.1.2.1”, and according to the map illustrated in FIG. 6 the acquired destination router ID is “R1”.

The location management server 4422 then checks whether or not the acquired destination router ID and source router ID match. In the event that the acquired destination router ID and source router ID do not match, the location management server 4422 transmits a locator resolution response including the destination IP address to the source router of the locator resolution request.

With the example illustrated in FIGS. 44 and 45, the destination router ID is “R2” and the source router ID is “R1”, so the destination router ID and source router ID do not match. Accordingly, the location management server 4422 transmits the locator resolution response including the destination IP address to the router 4412.

Next, in step S4508, after having transmitted the locator resolution request to the location management server 4422 in step S4504, the router 4412 checks whether or not a corresponding locator resolution response has been received from the location management server 4422. With the example illustrated in FIGS. 44 and 45, the router 4412 checks that the interface of the communication device 306 having the destination IP address does not belong to the LAN 308, by receiving the locator resolution response from the location management server 4422.

Next, in response to having received the locator resolution response, in step S710 the router 4412 performs Proxy MAC address response processing as to the communication device 304 which has transmitted the MAC address resolution request, by a MAC address resolution response including the MAC address of its own interface.

As described above, even in a case where packet communication is performed between communication devices belonging to different LANs with a communication system where one logical network is configured of multiple LANs, with the communication system 4400 the router 4412 to which the communication device 304 which has transmitted a MAC address resolution request is coupled executes Proxy MAC address response processing as to the communication device 304 under instruction of the location management server 4422, so packet communication may be executed in a normal manner.

Also, with the communication system 4400, the location management server 4422 determines whether or not for the router 3412 to execute Proxy MAC address response processing, using maps (location information) 326 and 328 indicating the relation between IP addresses and locators, which the location management server 4422 operating based on LISP holds, and the locator resolution response is selectively transmitted to the router 4412 when instructing execution of the Proxy MAC address response processing. Accordingly, a database relating to location of communication devices to perform communication does not have to be newly constructed, thereby avoiding location information of communication devices held in the overall network from becoming redundant, and enabling storage device resources such as memory to be effectively used.

Also, whether or not Proxy MAC address response processing is to be executed is centrally determined at the location management server 4422, so the load of processing on the servers coupled to the network 316 may be alleviated. Also, the locator resolution response is selectively transmitted to the router 4412 when instructing execution of the Proxy MAC address response processing, so the amount of communication for transmission of the locator resolution response to the router 4412 may be reduced, and the communication load on the network 316 may be alleviated.

### 10-3. Configuration of Router 4412 (4414)

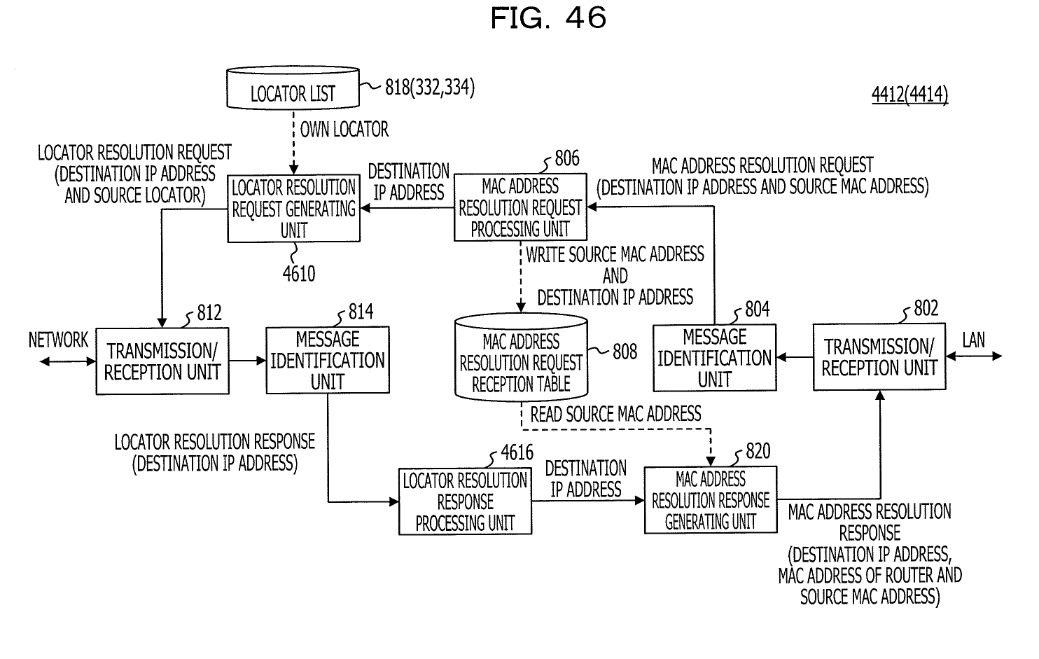

FIG. 46 is a diagram illustrating the configuration of the router 4412 (4414) according to the ninth embodiment.

The router 4412 (4414) illustrated in FIG. 46 differs from the router 312 (314) illustrated in FIG. 8 with regard to the points that a locator resolution request generating unit 4610 and a locator resolution response processing unit 4616 are provided instead of the locator resolution request generating unit 810 and locator resolution response processing unit 816, but is the same as the router 312 (314) other than the above points. Parts which are the same as or equivalent to those in the router 312 (314) illustrated in FIG. 8 are denoted with the same reference numerals. The operations and functions of the parts denoted by the same reference numerals in FIG. 46 are the same as described with reference to FIG. 8, so detailed description will be omitted.

With the functional block illustrated in FIG. 46, the portions corresponding to the functions of the router 4412 (4414) relating to the Proxy MAC address response processing described with reference to FIG. 45 are illustrated, and description of portions corresponding to other functions is omitted from the Present Specification, since arrangements according to the related art may be used. Also, while the configuration of the router 4412 will be described, the router 4412 and 4414 have mutually equivalent configurations in the communication system 4400.

The locator resolution request generating unit 4610 receives a destination IP address from the MAC address resolution request processing unit 806. Also, the locator resolution request generating unit 4610 references the locator list 818, thereby acquiring information of the IP address of the interface serving as the source of the locator resolution request (source locator). Based on the received destination IP address and acquired source locator, the locator resolution request generating unit 4610 generates a locator resolution request including this destination IP address and source locator. The locator resolution request generating unit 4610 outputs the generated locator resolution request to the transmission/reception unit 812. Note that the locator list 818 is the same as the locator list 332 (334) illustrated in FIG. 44.

After a locator resolution request generated by the locator resolution request generating unit 4610 has been transmitted from the transmission/reception unit 812, the locator resolution response processing unit 4616 monitors whether a locator resolution response including the destination IP address has been received from the message identification unit 814.

In the event of having received a locator resolution response, the locator resolution response processing unit 4616 notifies the MAC address resolution response generating unit 820 to that effect, and also outputs the destination IP address included in the received locator resolution response to the MAC address resolution response generating unit 820.

Note that the hardware configuration of the router 4412 (4414) is the same as the hardware configuration of the router 312 (314) illustrated in FIG. 9. The functions of the functional blocks of the router 4412 (4414) may be realized by the same hardware configuration as the hardware configuration of the router 312 (314) illustrated in FIG. 9. Accordingly, detailed description will be omitted.

As described above, even in a case where packet communication is performed between communication devices belonging to different LANs with a communication system where one logical network is configured of multiple LANs, the router 4412 to which the communication device 304 which has transmitted a MAC address resolution request is coupled executes Proxy MAC address response processing as to the communication device 304 based on instruction from the location management server 4422, so packet communication may be executed in a normal manner.

### 10-4. Configuration of Location Management server 4422

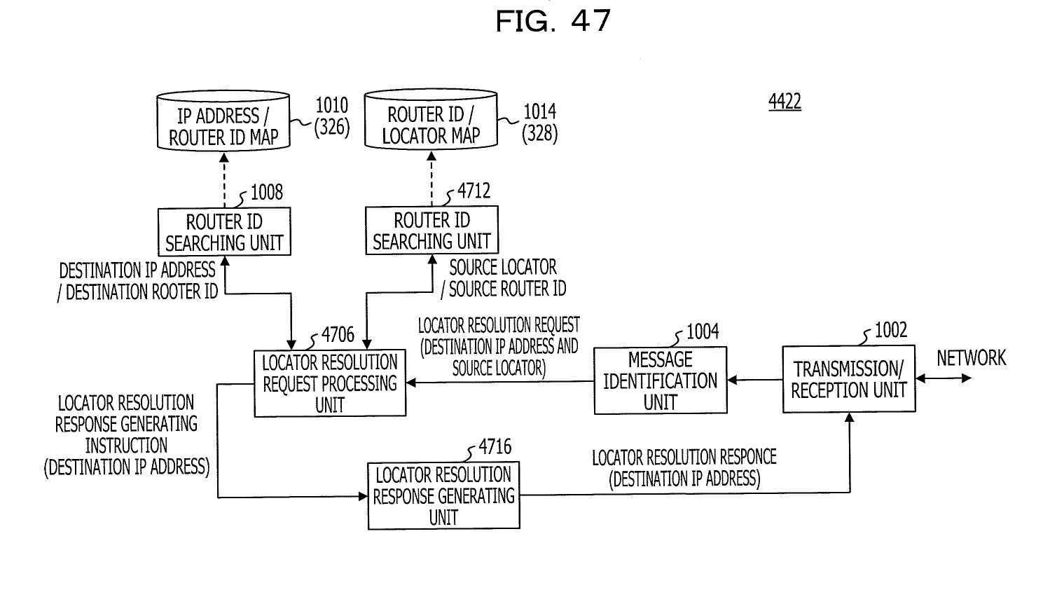

FIG. 47 is a functional block diagram illustrating the configuration of the location management server 4422 according to the ninth embodiment.

The location management server 4422 illustrated in FIG. 47 differs from the location management server 322 illustrated in FIG. 10 with regard to the point that a locator resolution request processing unit 4706, router ID searching unit 4712, and locator resolution response generating unit 4716 are provided instead of the locator resolution request processing unit 1006, locator searching unit 1012, and locator resolution response generating unit 1016, but other parts are the same. Parts which are the same as or equivalent to those in the location management server 322 illustrated in FIG. 10 are denoted with the same reference numerals. The operations and functions of the parts denoted by the same reference numerals in FIG. 47 are the same as described with reference to FIG. 10, so detailed description will be omitted.

With the functional block diagram illustrated in FIG. 47, in the same way as with the functional block diagram illustrated in FIG. 10 portions of the location management server 4422 which correspond to functions relating to the Proxy MAC address response processing and locator resolution processing described with reference to FIG. 45 are illustrated, and description of portions corresponding to other functions is omitted from the Present Specification, since arrangements according to the related art may be used.

The locator resolution request processing unit 4706 receives a locator resolution request from the message identification unit 1004. The received locator resolution request includes, in addition to the destination IP address, the IP address of the interface serving as the source of the locator resolution request (source locator).

The locator resolution request processing unit 4706 notifies information of the destination IP address included in the received locator resolution request to the router ID searching unit 1008. The router ID searching unit 1008 receives information of the destination IP address from the locator resolution request processing unit 4706, and searches the IP address/router ID map 1010 based on the received destination IP address, thereby acquiring the router ID correlated with that destination IP address (destination router ID). The router ID searching unit 1008 notifies the information of the destination router ID that has been acquired to the locator resolution request processing unit 4706. Note that the IP address/router ID map 1010 is the same as the IP address/router ID map 326 illustrated in FIG. 44.

Also, the locator resolution request processing unit 4706 notifies the information of the source locator included in the received locator resolution request to the router ID searching unit 4712. The router ID searching unit 4712 receives the information of the source locator from the locator resolution request processing unit 4706, and searches the router ID/locator map 1014 based on the received source locator, thereby acquiring the router ID correlated with that source locator (source router ID). The router ID searching unit 4712 notifies the information of the acquired source router ID to the locator resolution request processing unit 4706. Note that the router ID/locator map 1014 is the same as the router ID/locator map 328 illustrated in FIG. 44.

The locator resolution request processing unit 4706 then checks whether or not the notified destination router ID and source router ID match. In the event that the notified destination router ID and source router ID do not match, the locator resolution request processing unit 4706 decides to generate a locator resolution response, and notifies locator resolution response generating instruction information which instructs generating of a locator resolution response to the locator resolution response generating unit 4716. The locator resolution response generating instruction information includes the destination IP address. On the other hand, in the event that the destination router ID and source router ID match, the locator resolution request processing unit 4706 decides not to generate a locator resolution response, and does not notify the locator resolution response generating instruction information to the locator resolution response generating unit 4716.

Upon receiving the locator resolution response generating instruction information from the locator resolution request processing unit 4706, the locator resolution response generating unit 4716 generates a locator resolution response including the destination IP address included in the received locator resolution response generating instruction information. The locator resolution response generating unit 4716 outputs the generated locator resolution response to the transmission/reception unit 1002. On the other hand, the locator resolution response generating unit 4716 does not generate a locator resolution response unless locator resolution response generating instruction information is received from the locator resolution request processing unit 4706.

Note that the hardware configuration of the location management server 4422 is the same as the hardware configuration of the location management server 322 illustrated in FIG. 11. The functions of the functional blocks of the location management server 4422 may be realized with the same hardware configuration of the location management server 322 illustrated in FIG. 11. Accordingly, detailed description will be omitted.

As described above, with the communication system 4400, the location management server 4422 operating based on LISP decides whether or not to execute Proxy MAC address response processing, using the maps (location information) 326 and 328, indicating the relation between IP addresses and locators, which the location management server 4422 itself holds, and the locator resolution response is selectively transmitted to the router 4412 when instructing execution of the Proxy MAC address response processing. Accordingly, a database relating to location of communication devices to perform communication does not have to be newly constructed, thereby avoiding location information of communication devices held in the overall network from becoming redundant, and enabling storage device resources such as memory to be effectively used.

Also, whether or not Proxy MAC address response processing is to be executed is centrally determined at the location management server 4422, so the load of processing on the servers coupled to the network 316 may be alleviated. Also, the locator resolution response is selectively transmitted to the router 4412 when instructing execution of the Proxy MAC address response processing, so the amount of communication for transmission of the locator resolution response to the router 4412 may be reduced, and the communication load on the network 316 may be alleviated.

### 11. Other Modifications

(1) While an arrangement is made with the first embodiment (FIGS. 3 through 11) where the location management server transmits a locator resolution response to a router including a destination locator, a locator resolution response including a destination router ID may be transmitted instead.

In this case, the router which has received the locator resolution response conforms whether or not the destination router ID included in the received locator resolution response and its own router ID match, and in the event that the destination router ID and the route ID of itself do not match, executes the above-described Proxy MAC address response processing.

(2) While an arrangement is made with the third embodiment (FIGS. 15 through 20) where the location management server transmits a locator resolution response including the destination locator to the router, an arrangement may be made instead where a locator resolution response including the destination LAN ID is transmitted.

In this case, the router which has received the locator resolution response checks whether or not the destination LAN ID included in the received locator resolution response and the LAN ID of the LAN to which it is coupled match, and in the event that the destination LAN ID and the LAN ID of the LAN to which it is coupled do not match, executes the above-described Proxy MAC address response processing.

(3) While an arrangement is made with the seventh embodiment (FIGS. 34 through 37) and eighth embodiment (FIGS. 38 through 43) where the router transmits a locator resolution response including the destination IP address and source locator to the location management server, an arrangement may be made instead where a locator resolution response including the destination IP address and source router ID are transmitted.

In this case, the location management server which has received the locator resolution request acquires, based on the destination IP address included in the received locator resolution request, the destination router ID correlated with the destination IP address, and in the event that the acquired destination router ID and the source router ID included in the received locator resolution request do not match, sets a MAC address resolution response transmission flag to instruct execution of Proxy MAC address response processing.

Alternatively, the router may instead transmit a locator resolution request including the destination IP address and the IP address of the interface of the communication device which is the source of the MAC address resolution request (source IP address) to the location management server.

In this case, the location management server which has received the locator resolution request acquires, based on the destination IP address included in the received locator resolution request, the destination router ID correlated with the destination IP address, and based on the source IP address included in the received locator resolution request, acquires the router ID correlated with the source IP address. In the event that the acquired destination router ID and source router ID do not match, the location management server sets the MAC address resolution response transmission flag to instruct execution of Proxy MAC address response processing.

(4) While an arrangement is made with the eighth embodiment (FIGS. 38 through 43) where the router transmits a locator resolution request including the destination IP address and source locator to the location management server, an arrangement may be made instead where a locator resolution request including the destination IP address and source LAN ID is transmitted.

In this case, the location management server which has received the locator resolution request acquires, based on the destination IP address included in the received locator resolution request, the destination LAN ID correlated with the destination IP address, and in the event that the acquired destination LAN ID and source LAN ID included in the received locator resolution request do not match, the location management server sets the MAC address resolution response transmission flag to instruct execution of Proxy MAC address response processing.

(5) While an arrangement is made with the eighth embodiment where the location management server transmits a locator resolution response including the MAC address resolution response transmission flag to the router, so as to make whether or not to execute Proxy MAC address response processing, and arrangement may be made instead such as with the ninth embodiment (FIGS. 44 through 47) where the location management server does not transmit the locator resolution response unless instructing execution of Proxy MAC address response processing, and notifies whether or not to execute Proxy MAC address response processing by whether or not the router receives a locator resolution response after having transmitted the locator resolution request.

A communication system, communication control method, a relay device, and an information processing device, have been described as exemplary embodiments, but embodiments are not restricted to specifically disclosed embodiments, and various modifications and alterations may be made without departing from the Claims.

Also, the technology disclosed in the embodiments may be combined as suitable unless mutually contradictory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication control method of a communication system including a first communication device, a first relay device coupled to the first communication device via a first network which is a network domain where a message broadcast from the first communication device reaches and where communication based on physical addresses is performed, and a second communication device belonging to the same logical network to which the first communication device belongs, the communication control method comprising:
broadcasting, by the first communication device, a first request including a logical address assigned to the second communication device and requesting a physical address assigned to the second communication device;
transmitting, by the first relay device, in the event that the second communication device is not coupled to the first network, a first response which is a response to the first request and includes a predetermined physical address, to the first communication device.

2. The communication control method according to the claim 1, wherein
the communication system includes a managing device configured to hold first reference information indicating correlation between identification information assigned to a plurality of relay devices coupled to the first network, and logical addresses assigned to a plurality of communication devices coupled to the plurality of relay devices,
the first relay device transmits a second request, which includes a logical address assigned to the second communication device and request information indicating a relay device which is a router of the second communication device, to the managing device,
the managing device acquires identification information assigned to the relay device which is the router, based on the logical address included in the second request and the first reference information, and
in the event that the acquired identification information does not indicate the first relay device, the first relay device transmits the first response to the first communication device.

3. The communication control method according to the claim 1, wherein
the first communication device transmits a message including a logical address assigned to the second communication device and a physical address included in the first response,
the first relay device receives the message form the first communication device, and
the first relay device transmits the message to the relay device which is a router, based on the logical address assigned to the second communication device included in the message, and the identification information assigned to the relay device which is the router.

4. The communication control method according to the claim 1, wherein
the predetermined physical address is a physical address assigned to the first relay device.

5. The communication control method according to the claim 2, wherein
the managing device transmits a second response which is a response to the second request, and includes the acquired identification information, to the first relay device, and
the first relay device checks whether or not the acquired identification information included in the second response indicates the first relay device.

6. The communication control method according to the claim 2, wherein
the acquired identification information is logical addresses assigned to the interfaces of the plurality of relay devices.

7. The communication control method according to the claim 2, wherein
the managing device receives identification information assigned to the first relay device, from the first relay device, and
the managing device checks whether or not the acquired identification information indicates the first relay device, based on the received identification information.

8. The communication control method according to the claim 7, wherein
the received identification information is a logical address assigned to an interface of the first relay device.

9. The communication control method according to the claim 7, wherein
in the event that the managing device determines that the acquired identification information does not indicate the first relay device, the managing device instructs the first relay device to transmit the first response to the first communication device.

10. The communication control method according to the claim 7, wherein,
in the event that the managing device determines that the acquired identification information indicates the first relay device, the managing device does not transmit a response as to the second request to the first relay device, and
in the event that a response as to the second request is received from the first relay device after the first relay device having transmitted the first request, the first relay device transmits the first response to the first communication device.

11. The communication control method according to the claim 5, wherein
the first relay device holds second reference information indicating the relation between a logical address included in the second request and identification information included in the second response,
in the event of the first relay device having received the first request from the first communication device, the first relay device checks whether or not the second reference information includes the logical address included in the first request, and
in the event that the second reference information includes the logical address included in the first request, the first relay device acquires identification information assigned to the relay device which is the router, based on the second reference information.

12. The communication control method according to the claim 2, wherein
the managing device holds third reference information indicating the correlation between logical addresses and physical addresses assigned to the plurality of communication devices,
the first relay device holds fourth reference information indicating a physical address included in the first response transmitted to a communication device coupled to the first network,
the managing device acquires a physical address assigned to the second communication device, based on a logical address included in the second request and the third reference information,
the managing device transmits a second response which is a response to the second request and which includes the acquired identification information and physical address, to the first relay device, and
in the event that the identification information included in the second response does not indicate the first relay device, the first relay device transmits the first response including the physical address included in the second response, to the first communication device, and updates the fourth reference information based on the physical address included in the second response.

13. A relay device, which is coupled to a first communication device via a first network which is a network domain where a message broadcast from the first communication device reaches, and where communication based on physical addresses is performed, and which relays communication from the first communication device to a second communication device belonging to the same logical network as the first communication device, the relay device comprising:
receiver configured to receive, from the first communication device, a first request including a logical address assigned to the second communication device and requesting a physical address assigned to the second communication device;
a processor configured to generate, in the event that the second communication device is not coupled to the first network, a first response which is a response to the first request and includes a predetermined physical address; and
a transmitter configured to transmit the first response, to the first communication device.

14. The relay device according to the claim 13, wherein
the relay device is coupled to a managing device via a second network which differs from the first network,
the processor is further configured to generate a second request which, in response to the first request, includes a logical address assigned to the second communication device, and requests a relay device which is a router of the second communication device, and
the transmitter is further configured to transmit the second request to the managing device.

15. The relay device according to the claim 13, wherein the predetermined physical address is a physical address assigned to itself.

16. The relay device according to the claim 14, wherein
the receiver is further configured to receive a second response, which is a response to the second request, and includes identification information assigned to the relay device which is the router, that has been acquired by the managing device based on the logical address included in the second request, and
in the event the identification information included in the second response does not indicate the relay device itself, the processor generates the first response.

17. The relay device according to the claim 14, wherein,
in the event of having received a response to the second request after the first request has been transmitted, the processor generates the first response.

18. An information processing device, which is coupled via network to a first relay device which relays communication from a first communication device to a second communication device belonging to the same logical network as the first communication device, the information processing device comprising:
a memory configured to store reference information indicating the correlation between identification information assigned to a plurality of relay devices coupled to the network and logical addresses assigned to a plurality of communication devices coupled to the plurality of relay devices;
a receiver configured to receive, from the first relay device, a first request which includes identification information assigned to the first relay device and a logical address assigned to a second communication device, and which requests information indicating a relay device which is a router of the second communication device;
a processor configured
to acquire identification information assigned to the relay device which is the router, based on the logical address assigned to the second communication device and the reference information, in response to the first request and
to check whether or not the acquired identification information indicates the first relay device, based on the identification information included in the first request.

19. The information processing device according to the claim 18, further comprising:
a transmitter;
wherein
the processor is further configured to, in the event that acquired identification information does not indicate the first relay device, generate a response instruction instructing transmitting of a second response, which is a response to a second request including the logical address assigned to the second communication device and requesting the physical address assigned to the second communication device, to the first relay device,
the transmitter configured to transmit the response instruction to the relay device, and
the first relay device transmits the first request to the information processing device in response to the second request.

20. The information processing device according to the claim 19, wherein the predetermined physical address is a physical address assigned to the first relay device.
